(19) United States
(12) Patent Application Publication
(10) Pub. No.: US 2011/0200655 A1
(43) Pub. Date: Aug. 18, 2011

(54) Systems and methods that kill infectious agents (bacteria) without the use of a systemic anti-biotic

(76) Inventors: Michael Darryl Black, Palo Alto, CA (US); Anita Margarette Chambers, Goleta, CA (US)

(21) Appl. No.: 13/028,460

(22) Filed: Feb. 16, 2011

Related U.S. Application Data
(60) Provisional application No. 61/304,906, filed on Feb. 16, 2010.
(60) Provisional application No. 61/327,838, filed on Apr. 26, 2010.
(60) Provisional application No. 61/327,851, filed on Apr. 26, 2010.

(51) Int. Cl. A01N 25/34; A01N 47/12; A01N 33/12; A01N 43/36; A01N 43/16; A01N 47/44; A01N 55/10; A01P 1/00

(52) U.S. Cl. 424/404; 424/411; 424/402; 424/445; 424/447; 424/400; 424/484; 424/488; 424/487; 424/78.17; 424/78.27; 424/78.24

(57) ABSTRACT

A medical product is provided that is selected from at least one of, nasal cannulas, oxygen masks, wound dressings, bandages, band aids, catheters, endotrachial tubes, condoms, surgical and other gloves, sheaths for endoscopy probes, and medical products that physically touch the body. A coating is included with at least one of, a non-antibiotic, antimicrobial and/or antiviral substance that prevents further local, non-systemic, colonization of infections.

### CROSS-REFERENCE TO RELATED APPLICATIONS

This application claims the benefit of U.S. 61/304,906 filed Feb. 16, 2010, U.S. 61/1327,838 filed Apr. 26, 2010 and U.S. 61/327,851 filed Apr. 26, 2010, which applications are fully incorporated herein by reference.

### BACKGROUND OF THE INVENTION

1. Field of the Invention

The present invention is directed to devices and methods that kill bacteria, and more particularly, to devices and methods that kill bacteria and other infectious organisms, including but not limited to, prions and viruses by rupturing, interrupting or disturbing cells without requiring systemic or locally applied antibiotics.

2. Description of the Related Art

In many conventional medical procedures, invasive medical apparatus are used to provide access to internal organs, body cavities, and vasculature. Invasive medical apparatus are commonly used to provide routes for the administration of medications or fluids, to provide urinary bladder drainage, to provide for drainage from a fluid filled cavity, to provide ventilation through a tracheostomy site, to provide drainage from pustules and abscesses, to provide monitoring access for measuring renal, cardiac, and other physiological parameters. Invasive medical apparatus commonly penetrate the epidermis by means of existing orifices such as the urethral meatus or nares, and by insertion through the epidermis by puncture or surgically created apertures.

Since invasive medical apparatus entrance sites constitute a breach in the body's epidermal defense barrier, a finite risk of infection exists at a penetration site. The use of catheters and other invasive apparatus is the largest source of infections acquired in hospitals and nursing homes. Such nosocomial, iatrogenic, or induced infections occur much more frequently when invasive medical apparatus are left in place more than a few days. This is so because, after a few days, the pumping or sliding movement of the invasive medical apparatus with respect to the penetration site carries microorganisms through the epidermal barrier to cause infections.

There is a direct relation between the length of time an invasive medical apparatus must remain in place and the likelihood of an infection progressing. One of the reasons for this increase in the incidence of infection is the phenomenon of microbial infiltration along the outside surface of an invasive medical apparatus through the epidermis at the puncture point. This is accomplished by the inexorable deposition and advancement of bacteria within a polysaccharide biofilm in the absence of antiseptic, antibiotic, or antimicrobial substances directly at the skin penetration site.

Various methods and devices for preventing microbial infiltration and the concomitant infection focus upon attempting to immobilize an invasive medical apparatus at its penetration site and/or the application of antiseptic or antibiotic substances to the penetration site.

The problem of infections associated with invasive medical devices is well recognized. Two examples of publications in the field of urinary infection and sepsis can be found in the work of Gillespie, W. A., Lennon, G. G., Linton, K. B., and Slade, N. “Prevention of Urinary Infection in Gynecology,” British Medical Journal, August 1964, Volume 2, pages 423-425 (“Gillespie”), and Viant, A. C., Linton, K. B., Gillespie, W. A., Midwinter, A., “Improved Method for Preventing Movement of Indwelling Catheters in Female Patients,” The Lancet, April, 1971, at pages 736-737 (“Viant”).

A review of ineffective or attempted solutions to catheter infection and sepsis that depict the state of the art of urinary sepsis and infection, can be found in the work of Kunin, C. M., “Henitourinary Infections in the Patent at Rick: Extrinsic Risk Factors,” The American Journal of Medicine, May 15, 1984, at pages 131-138 (“Kunin”). Kunin recognizes that an effective solution for preventing catheter-associated infections and sepsis is not yet available. Bacterial biofilm can provide microorganisms with a certain amount of immunity to antiseptic and/or antimicrobial substances. This has been recognized by Nickel, J. C., Downey, J. A. and Costerton, J. W. in “Ultrastructural Study of Microbiologic colonization of Urinary Catheters,” Urology, vol. 34, pg. 284 (1989). Thus, even providing an antiseptic or antimicrobial substance to a medical apparatus penetration site often does not result in an effective zone of aseptic. However, the mechanical occlusion of bacteria from a wound or epidermal opening can prevent bacterial migration via deposition of a biofilm layer. An occlusive wound dressing may prevent the initial formation of a biofilm, layer in close proximity to a wound site or epidermal entry site of an invasive medical apparatus.

Systemic and local penetration site infections from invasive medical apparatus use are believed to result from one of two general causes: (1) intraluminal or intrinsic infections arising from bacteria that migrate internally through the lumen of the invasive medical apparatus to a situs of infection at the internal end of the invasive medical apparatus, and (2) extrinsic infections arise via the migration of bacteria along the external surface of the invasive medical apparatus.

The first means of infection does not apply to the use of solid invasive medical apparatus that do not permit intraluminal transmission. The latter means of infection is thought to be increased by the bacterial secretion of a thin film of mucopolysaccharide material known as “biofilm” along the external surface of an invasive medical apparatus. Bacteria multiplying within a biofilm layer traverse this surface. When such an organic exudate layer exists, the occurrence of infections is further increased by in-and-out motion of the invasive medical apparatus at the site of penetration.

MRSA (Methicillin-associated Staphylococcus Aureus) is often known as “the healthcare infection” because although many may enter a hospital, nursing home, or long-term care facility without it, there is a significant likelihood that they will leave with it. A survey performed by the Association for Professionals in Infection Control and Epidemiology (APIC) demonstrated that the prevalence of MRSA (Methicillin-associated Staphylococcus Aureus) is as much as 10 times greater than health officials had previously estimated and it's threat cannot be underestimated. According to the CDC, in 1972, MRSA accounted for only 2% of hospital-acquired Staphylococcus Aureus infections, now it accounts for more than 60% in U.S. hospitals.

New regulations now require many hospitals around the world to perform a nares (nasal) culture for MRSA on all ICU (Intensive Care Unit) patients. However, there has been no uniform treatment identified for those patients found to be colonized with MRSA partly because the infection is highly antibiotic resistant.

By way of illustration, implantable heart stimulator pocket infection is a severe complication which often ends up in explanation of the stimulator. The reason therefore is that conventional treatment with antibiotics cannot eradicate the infection. This seems to depend on the circumstance that the bacteria live in a biofilm formed around the exterior surfaces of the implanted stimulator, which film blocks antibiotics. The bacteria may also live passively on a very low metabolism and can therefore not be treated successfully by antibiotics.

A method of enhancing the effect of antibiotics by applying an electrical field across the biofilm is described in U.S. Pat. No. 5,312,813. This method is based on findings by J. W. Costerton et. al. Their studies have shown that the infection can be completely cured and no explanation has to take place by applying an electric field or a small current across the biofilm during antibiotic treatment, cf. also ASAIO Journal 1992, p.M-174 M178, Khoury et. al, “Prevention and Control of Bacterial Infections Associated with Medical Devices”, and Antimicrobial Agents and Chemotherapy, Vol. 38, No. 12, December 1994, p. 2803-2809, Costerton et. al., “Mechanism of Electrical Enhancement of Efficacy of Antibiotics in Killing Biofilm Bacteria” In these studies, generally, a low electric current of the order of 15-400 .mu.A/cm² is applied onto the infected surface while immersed in a buffer with antibiotics. In the most successful studies a total killing of microorganisms was reported after only 8 hours of current and antibiotic treatment—tobramycin 2.5 mg/l, 15-400 .mu.A/cm² during 8 h. This effect has been termed “the bioelectric effect”.

These studies suggest that the electric field needs to be applied in close proximity to the infected implant. A passive electric field will not be effective, but a current should be conducted between electrodes in the biofluid surrounding the implanted device. A possible explanation to the observed effect is that electrochemically generated products are needed for the bioelectric effect to occur. At the titanium surface, titanium being normally used in heart stimulator housings, the following electrochemical processes take place.

### SUMMARY OF THE INVENTION

Accordingly, an object of the present invention is to provide a medical device and its methods that uses non-antibiotics for killing bacteria.

Another object of the present invention is to provide medical devices and their methods of use that utilize a non-antibiotic to prevent or reduce the colonization of MRSA thereby significantly reducing the prevalence of the Staphylococcus infection.

Yet another object of the present invention is to provide medical devices and their methods of use that have a non-antibiotic, antimicrobial and/or antiviral substance for the purpose of preventing further local (non-systemic) colonization of infections including but not limited to Methacillin-Resistant Staphylococcus Auereus (MRSA)).

A further object of the present invention is to provide medical devices such as nasal cannulas, oxygen masks, wound dressings, skin tapes, bandages, band aids, catheters, endotrachial tubes, condoms, surgical and other gloves, sheaths for endoscopy probes, and other medical products that physically touch the body and the like that utilize a non-antibiotic to prevent, reduce and/or treat bacteria.

Yet a further object of the present invention is to provide medical devices and their methods of use that include a multitude of polymeric chains bearing quaternary ammonium groups.

Another object of the present invention is to provide medical devices and their methods of use that include polymeric chains composed of non-hydrolyzable carbon-carbon bonds that are bonded quaternary materials.

These and other objects of the present invention are achieved in a medical product selected from at least one of, nasal cannulas, oxygen masks, wound dressings, bandages, band aids, catheters, endotrachial tubes, condoms, surgical and other gloves, sheaths for endoscopy probes, and medical products that physically touch the body, and a coating that includes at least one of, a non-antibiotic, antimicrobial and/or antiviral substance that prevents further local, non-systemic, colonization of infections.

In another embodiment of the present invention, a medical product is provided that is selected from the group of, nasal cannulas, oxygen masks, wound dressings, bandages, band aids, catheters, endotrachial tubes, condoms, surgical and other gloves, sheaths for endoscopy probes, and medical products that physically touch the body. A coating is provided. The coating includes a polymer having the formula R(LE)ₓ wherein R is a polymeric core having a number average molecular weight of from 5000 to 7,000,000 daltons and having x endgroups, x being an integer .gtoreq.1, E is an endgroup covalently linked to polymeric core R by linkage L, L is a divalent oligomeric chain, having at least 5 identical repeat units, capable of self-assembly with L chains on adjacent molecules of the polymer, and the moieties (LE)ₓ in the polymer may be the same as or different from one another, wherein E is at least one of a non-antibiotic, antimicrobial and/or antiviral agent.

In another embodiment of the present invention, a medical product selected from at least one of, nasal cannulas, oxygen masks, wound dressings, bandages, band aids, catheters, endotrachial tubes, condoms, surgical and other gloves, sheaths for endoscopy probes, and medical products that physically touch the body is provided. A material is coupled to the medical product. The material includes one or more non-hydrolyzable, non-leachable polymer chains covalently bonded by non-siloxane bonds to the substrate. The non-hydrolyzable, non-leachable polymer chains comprise a multitude of antimicrobial groups attached to the non-hydrolyzable, non-leachable polymer chains by covalent bonds. A sufficient number of the non-hydrolyzable, non-leachable polymer chains are covalently bonded to sites of the substrate to render the material antimicrobial, or receptive to avid binding of negatively charged dye molecules, when exposed to aqueous fluids, menses, bodily fluids, skin, cosmetic compositions, or wound exudates. The material has associated therewith a plurality of anionically charged biologically or chemically active compounds.

In another embodiment of the present invention, a medical product is provided that is selected from at least one of, nasal cannulas, oxygen masks, wound dressings, bandages, band aids, catheters, endotrachial tubes, condoms, surgical and other gloves, sheaths for endoscopy probes, and medical products that physically touch the body. A superabsorbent material is provided for absorbing biological fluids coupled to the medical product. The superabsorbent material includes one or more non-hydrolyzable, non-leachable polymer chains covalently bonded by non-siloxane bonds to the substrate. The non-hydrolyzable, non-leachable polymer chains comprise a multitude of antimicrobial groups attached to the non-hydrolyzable, non-leachable polymer chains by covalent bonds; and wherein a sufficient number of the non-hydrolyzable, non-leachable polymer chains are covalently bonded to sites of the flexible substrate to render the material antimicrobial when exposed to aqueous fluids, menses, bodily fluids, or wound exudates. The superabsorbent material is capable of absorbing about 30 or more times its own weight of water or other fluids in a single instance; and wherein the absorbing capacity is the result of branching or crosslinking of the non-hydrolyzable, non-leachable polymer chains, wherein the material has associated therewith a plurality of anionically charged biologically or chemically active compounds.

In another embodiment of the present invention, a medical product is provided that is selected from the group of, nasal cannulas, oxygen masks, wound dressings, bandages, band aids, catheters, endotrachial tubes, condoms, surgical and other gloves, sheaths for endoscopy probes, and medical products that physically touch the body. An antimicrobial-coated composition is coupled to the medical product and includes an effective amount of polymeric molecules having a multiplicity of quaternary ammonium groups. The polymeric molecules are non-leachably and covalently bonded to surface sites of the substrate. The polymers do not form using siloxane bonds. The coating is absorbent of aqueous liquids, and c. associated anionic biologically active or chemically active compound. The multiplicity of quaternary ammonium groups act to destroy microbes coming in contact with the groups as well as to bind and release the anionic biologically active or chemically active compound.

### BRIEF DESCRIPTION OF THE DRAWINGS

FIG. 1 illustrates one embodiment of the present invention with a nasal cannula that uses non-antibiotics for killing bacteria.

FIG. 2 illustrates an embodiment of the present invention with a nasal cannula used with a human.

FIG. 3 illustrates a nasal cannula prong in one embodiment of the present invention.

FIG. 4 illustrates surgical gloves in one embodiment of the present invention.

FIG. 5 illustrates an embodiment of the invention with sports gloves that use non-antibiotics for killing bacteria.

FIG. 6 illustrates an embodiment of the present invention that uses wound/surgical closure strips.

FIG. 7 illustrates a bicycle seat that can be utilized in one embodiment of present invention.

FIG. 8 illustrates a medical chest drainage tube that can be utilized in one embodiment of the present invention.

FIG. 9 illustrates a tracheostomy tube that can be utilized in one embodiment of the present invention.

FIG. 10 illustrates indwelling catheters that can be utilized in one embodiment of the present invention.

FIG. 11 illustrates a Swan-Ganz catheter that can be utilized in one embodiment of the present invention.

FIG. 12 illustrates an intravenous catheter that can be utilized in one embodiment of the present invention.

FIG. 13 illustrates a nasogastric tube that can be utilized in one embodiment of the present invention.

FIG. 14 illustrates a nasal trumpet that can be utilized in one embodiment of the present invention.

FIG. 15 illustrates a Jackson-Pratt tube that can be utilized in one embodiment of the present invention.

FIG. 16 illustrates a contact lens that can be utilized in one embodiment of the present invention.

FIG. 17 illustrates eyeglass nose pads that can be utilized in one embodiment of the present invention.

FIG. 18 illustrates a hearing aid that can be utilized in one embodiment of the present invention.

FIG. 19 illustrates a myringotomy tube that can be utilized in one embodiment of the present invention.

FIG. 20 illustrates a bicycle handlebar tape that can be utilized in one embodiment of the present invention.

FIG. 21 illustrates a dressing bandage and an eye pad that can be utilized in one embodiment of the present invention.

FIG. 22 illustrates a condom that can be utilized in one embodiment of the present invention.

FIG. 23 illustrates sexual toys that can be utilized in one embodiment of the present invention.

FIG. 24 illustrates mattress and pillow covers that can be utilized in one embodiment of the present invention.

FIG. 25 illustrates toilet seat covers that can be utilized in one embodiment of the present invention.

FIG. 26 illustrates a trocar that can be utilized in one embodiment of the present invention.

### DETAILED DESCRIPTION OF THE PREFERRED EMBODIMENTS

### Definitions

For the purposes of this disclosure, certain definitions are provided. By “non-hydrolyzable” is meant a bond that does not hydrolyze under standard conditions to which a bond is expected to be exposed under normal usage of the material or surface having such bond. For instance, in a wound dressing according to the present invention that has “non-hydrolyzable” bonds, such “non-hydrolyzable” bonds do not hydrolyze (e.g., undergo a hydrolysis-type reaction that results in the fission of such bond) under normal storage conditions of such dressing; exposure to would exudates and/or body fluids when in use (e.g., under exposure to an expected range of pH, osmolality, exposure to microbes and their enzymes, and so forth, and added antiseptic salves, creams, ointments, etc.). The ranges of such standard conditions are known to those of ordinary skill in the art, and/or can be determined by routine testing.

By “non-leaching” is meant that sections of the polymer of the present invention do not appreciably separate from the material and enter a wound or otherwise become non-integral with the material under standard uses. By “not appreciably separate” is meant that no more than an insubstantial amount of material separates, for example less than one percent, preferably less than 0.1 percent, more preferably less than 0.01 percent, and even more preferably less than 0.001 percent of the total quantity of polymer. Alternately, depending on the application, “not appreciably separate” may mean that no adverse effect on wound healing or the health of an adjacent tissue of interest is measurable.

In regard to the above, it is noted that “non-leachable” refers to the bond between the polymer chain and the substrate. In certain embodiments of the present invention, a bond between the polymer backbone and one or more type of antimicrobial group may be intentionally made to be more susceptible to release, and therefore more leachable. This may provide a benefit where it is desirable for a percentage of the antimicrobial groups to be selectively released under certain conditions. However, it is noted that the typical bond between the polymer chain and antimicrobial groups envisioned and enabled herein are covalent bonds that do not leach under standard exposure conditions.

Polymers according to the present invention have the capacity to absorb aqueous liquids such as biological fluids (which are defined to include a liquid having living or dead biologically formed matter, and to include bodily fluids such as blood, urine, menses, etc.). The capacity to absorb an aqueous liquid can be measured by the grams of water uptake per gram of absorbent material in a single instance. One general definition for a superabsorbent polymer is that such polymer generally would be capable of absorbing, in a single instance, about 30 to 60 grams of water per gram of polymer. A broader definition could include polymers that absorb less than 30 grams of water per gram of polymer, but that nonetheless have enhanced capacity to absorb water compared to similar materials without such enhanced capacity. Alternately, an “absorbent” as opposed to a “superabsorbent” polymer may be defined as a polymer that has a capacity to absorb aqueous liquids, but which normally will not absorb over 30 times its weight in such liquids.

By “degree of polymerization” is meant the number of monomers that are joined in a single polymer chain. For example, in a preferred embodiment of the invention, the average degree of polymerization is in the range of about 5 to 1,000. In another embodiment, the preferred average degree of polymerization is in the range of about 10 to 500, and in yet another embodiment, the preferred average degree of polymerization is in the range of about 10 to 100.

A substrate is defined as a woven or nonwoven, solid, or flexible mass of material upon which the polymers of the invention can be applied and with which such polymers can form covalent bonds. Cellulose products, such as the gauze and other absorbent dressings described in the following paragraphs, are preferred materials to be used as water-insoluble bases when a wound dressing is prepared. The term “substrate” can also include the surfaces of large objects, such as cutting boards, food preparation tables and equipment, surgical room equipment, floor mats, blood transfer storage containers, cast liners, splints, air filters for autos, planes or HVAC systems, military protective garments, face masks, devices for protection against biohazards and biological warfare agents, lumber, meat packaging material, paper currency, powders, including but not limited to mica for cosmetic, antifungal or other applications, and other surfaces in need of a non-leaching antimicrobial property, and the like, onto which is applied the antimicrobial polymeric coating in accordance with the present invention. Apart from cellulose, any material (ceramic, metal, or polymer) with hydroxyl groups or reactive carbon atoms on its surface can be used as a substrate for the cerium (IV) or other free radical, redox or otherwise catalyzed grafting reaction described in the following paragraphs. The extent of grafting will be dependent on the concentration of surface hydroxyl groups and the concentration of available reactive carbons. Even materials which do not normally contain sufficient surface hydroxyl groups may be used as substrates, as many methods are available for introducing surface hydroxyl groups. These methods generally include hydrolysis or oxidation effected by methods such as heat, plasma-discharge, e-beam, UV, or gamma irradiation, peroxides, acids, ozonolysis, or other methods. It should be noted that methods other than cerium initiated grafting may also be used in the practice of this invention. Thus, for example, not meant to be limiting, a free radical initiator may be used to initiate monomer polymerization. So-called “Azo” initiators, such as VA-057, V-50 and the like, available from Wako Pure Chemical Industries, may be utilized. Other initiators, including but not limited to hydrogen peroxide, sodium persulfate (“SPS”), and the like may also be utilized to advantage according to this invention to initiate polymerization.

In one embodiment, the present invention provides non-antibiotic systems and methods for killing bacteria such as Gram Positive and Gram Negative including but not limited to, Staphylococcus Aureus and Escherichia Coli and/or Pseudomonas Aeruginosa, respectively.

A non-limiting example includes activating the surface of polyurethanes, a family of polymers widely used in medicine. In addition to or instead of incorporating only surface substrates or coatings, this invention utilizes a technology that applies the technique of self-assembly to the polymer surfaces. This technology attaches functional groups with desired biological properties to the ends of long polyurethane molecules. The functional groups found in small concentrations within the bulk substrate, migrate to the surface of the bulk material forming a biologically active surface monolayer. A non-limiting example of design(s), a self-assemble into a monolayer such that the functional end groups assemble on the surface. Unlike a coating which can be permanently damaged, in this embodiment, there is continued functional group migration to the surface of the material, as the exposed surface wears or is compromised. That is, the self-assembly of molecules are capable of performing repeated self-assembly to replenish the material surface monolayer keeping it active even under use and wear and tear. Because of this capability, the functionality that is chosen for the material surface monolayer (polymer end groups) becomes an intrinsic property of the polymer itself. In a non-limiting example, this technology can be applied to a biologically active surface-modifying end group(s). This embodiment will include functional end groups that can confer for example, either short-term topical or long-term biostatic, biocidal and hemocompatible properties to the polymer. Utilizing this technology one can create short-term surface patches and barriers that will inhibit colonization on living organisms, i.e. humans or pets or inanimate objects such as sanitary devices, medical devices, table trays, art supplies or sporting equipment. Long-term possibly permanent surface(s) or casing(s) can be manufactured for implantable devices such as those coming in contact with soft tissue, blood, muscle, organs, bone, tendons, nerves, other body fluids, and all other types of biological tissues. As a non-limiting example, the present invention provides a non-antibiotic method of preventing or reducing the colonization of MRSA thereby significantly reducing the prevalence of the Staphylococcus infection.

MRSA is drug resistant bacteria found on the surfaces of the body. Colonization is not synonymous with infection. The MRSA can be often found in the most areas of the body for example and not limited to the nose, groin or underarms. Once there is a wound or skin break (i.e. a violation in the natural barriers) infection may proceed within minutes. A colonized individual may carry the bacteria for years or even decades without overt infection or septicemia. The initial colonization and/or transfer of the MRSA may occur via something as simple as sharing a towel. People who contract MRSA in the hospital setting, i.e. noscomial, may have had the bacteria transferred into their wound via medical staff or surgical procedures. MRSA may also be airborne and may be part of the dust or dead skin/hair residues, and the moisture discharged during a sneeze.

As a non-limiting example, the present invention provides medical and non-medical products coated or having a surface that includes a non-antibiotic, antimicrobial and/or antiviral substance for the purpose of preventing further local (non-systemic) colonization of infections including but not limited to Gram positive organisms such as, Methacillin-Resistant Staphylococcus Auereus (MRSA) or Gram negative such as but not limited to Escherichia Coli and/or Pseudomonas Aeruginosa).

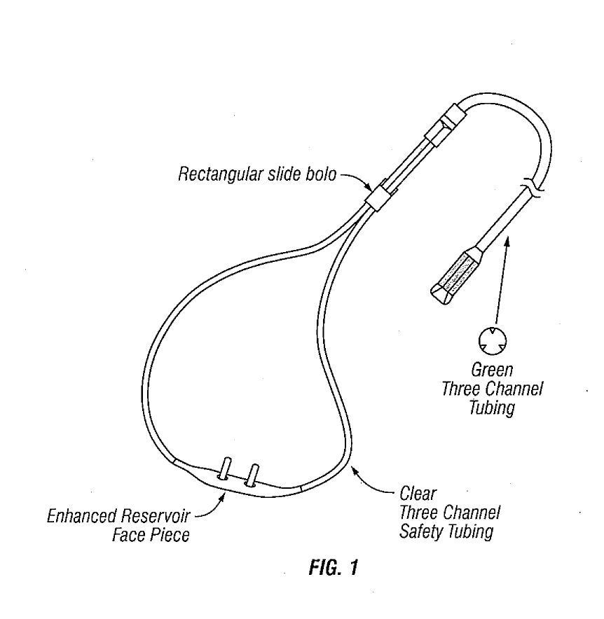

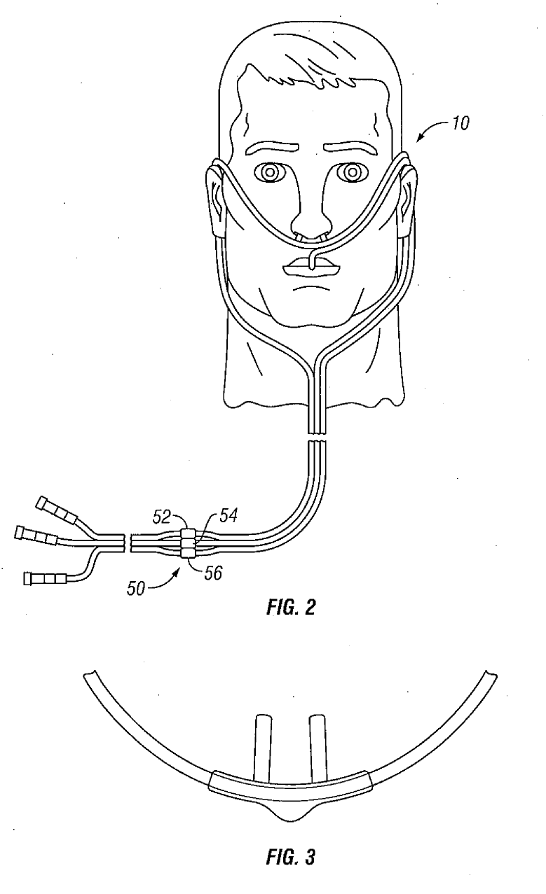

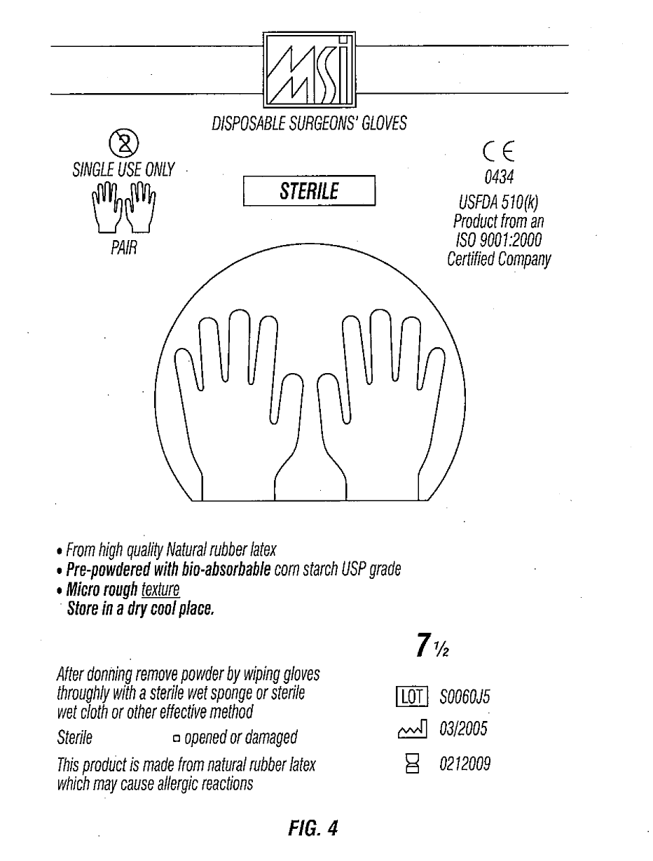

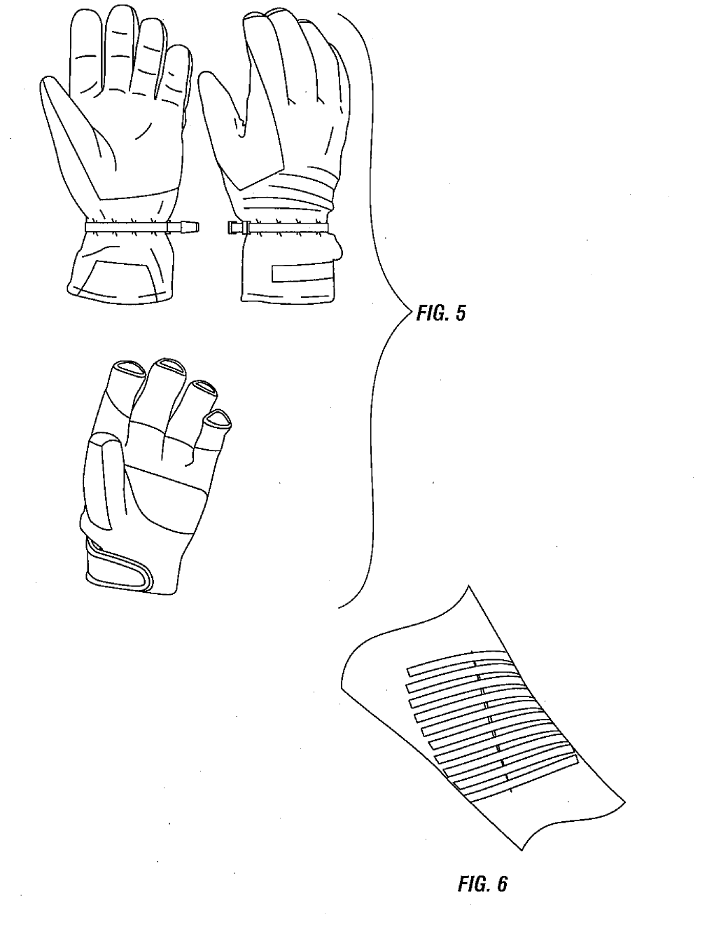

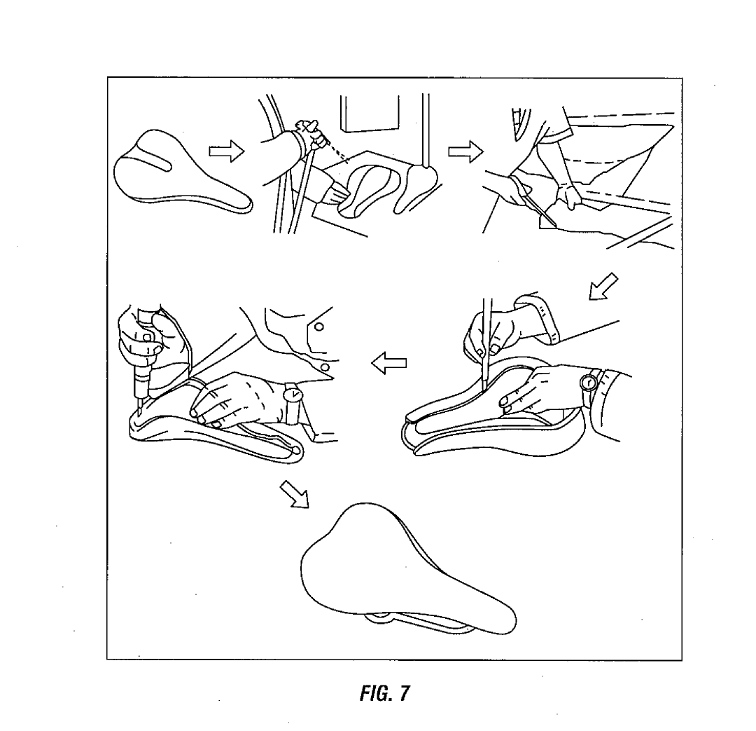

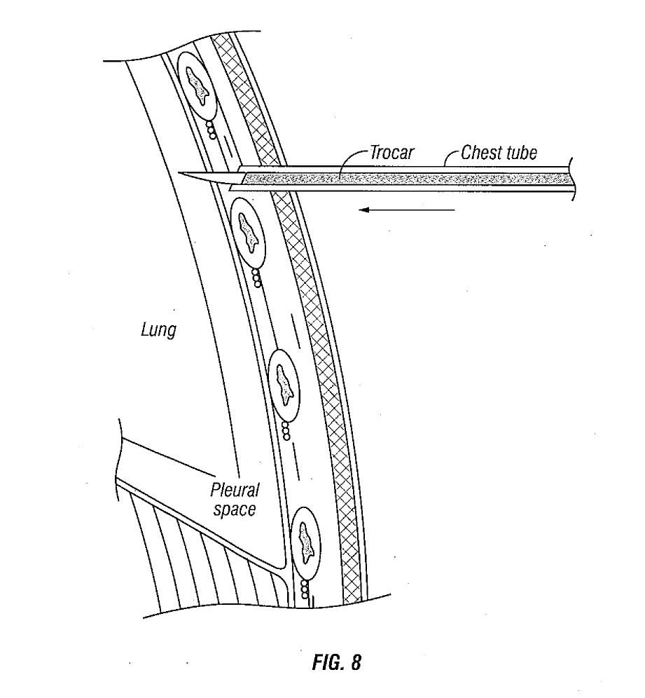

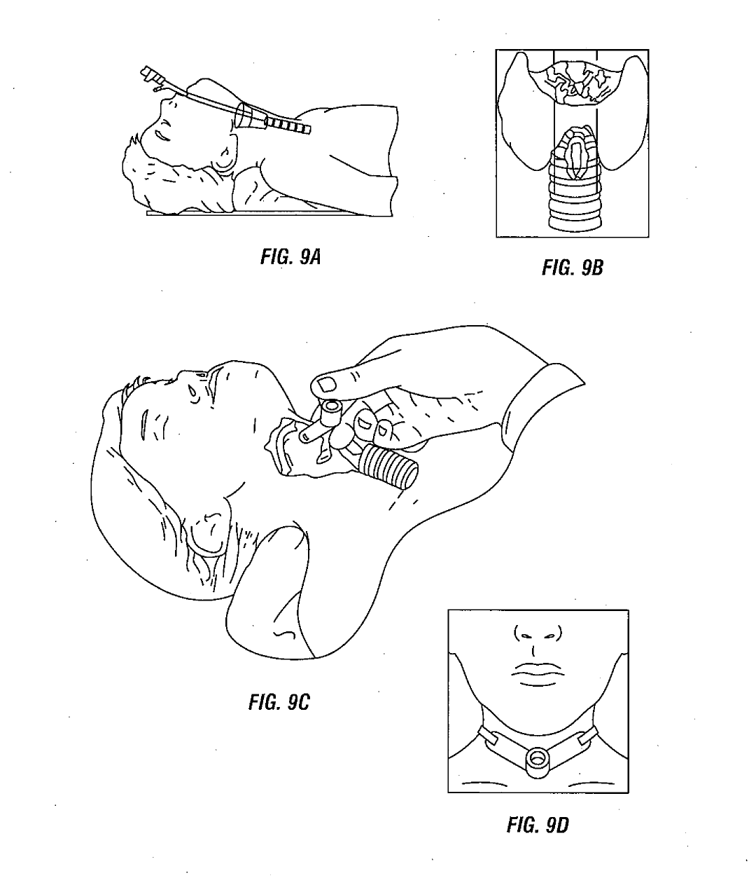

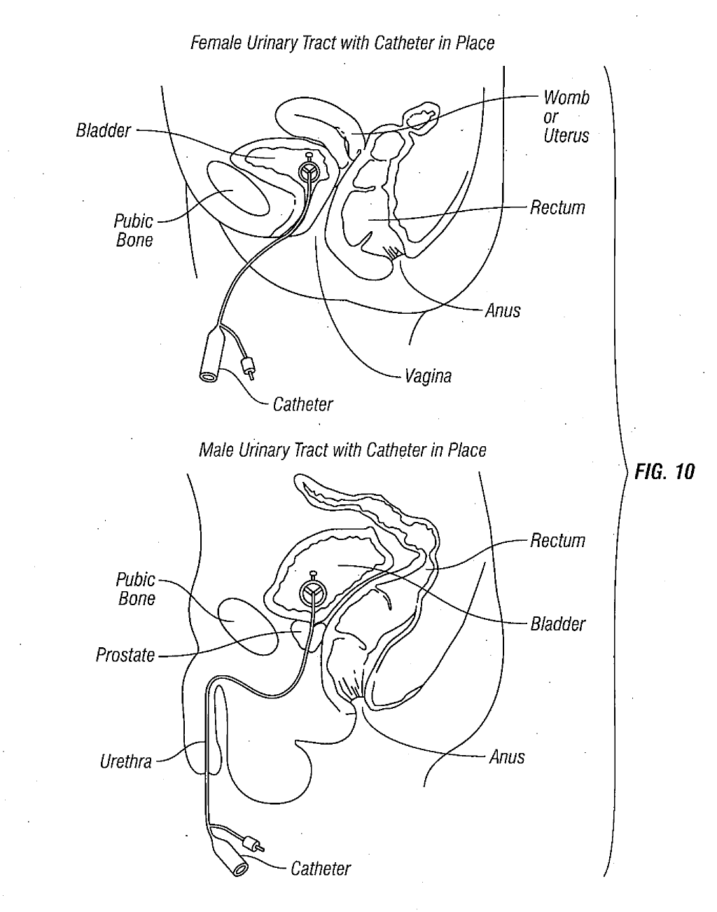

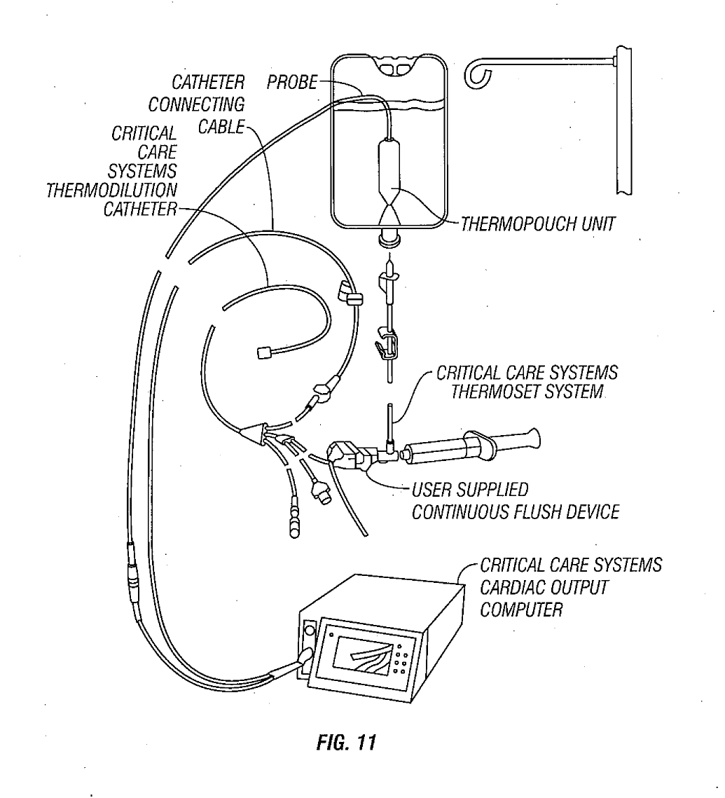

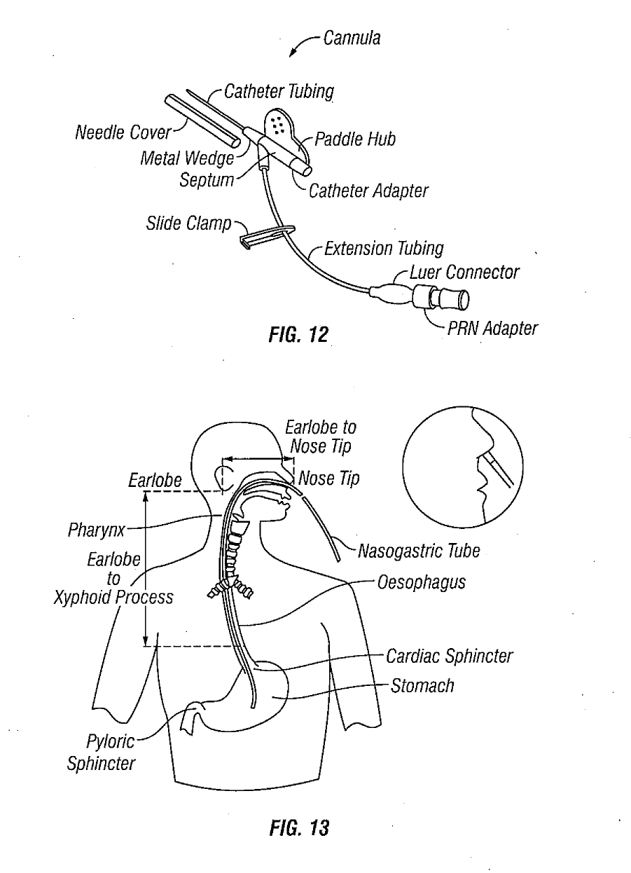

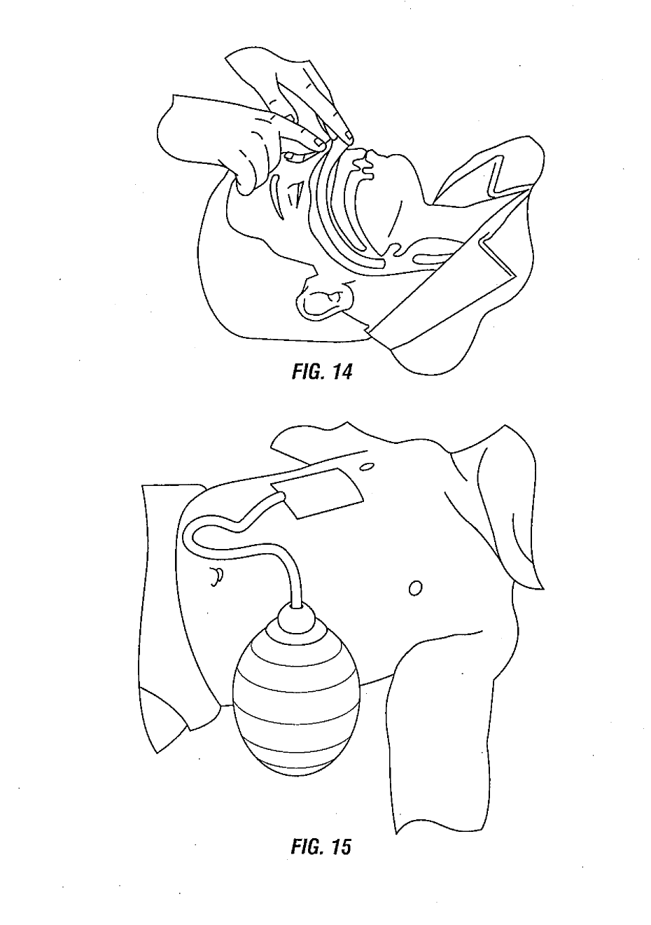

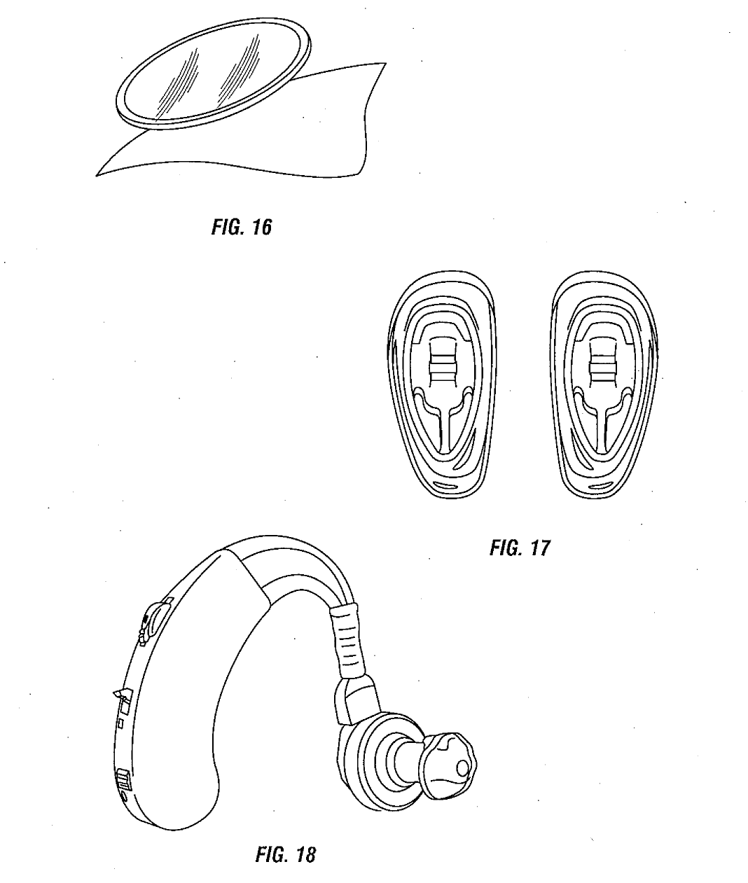

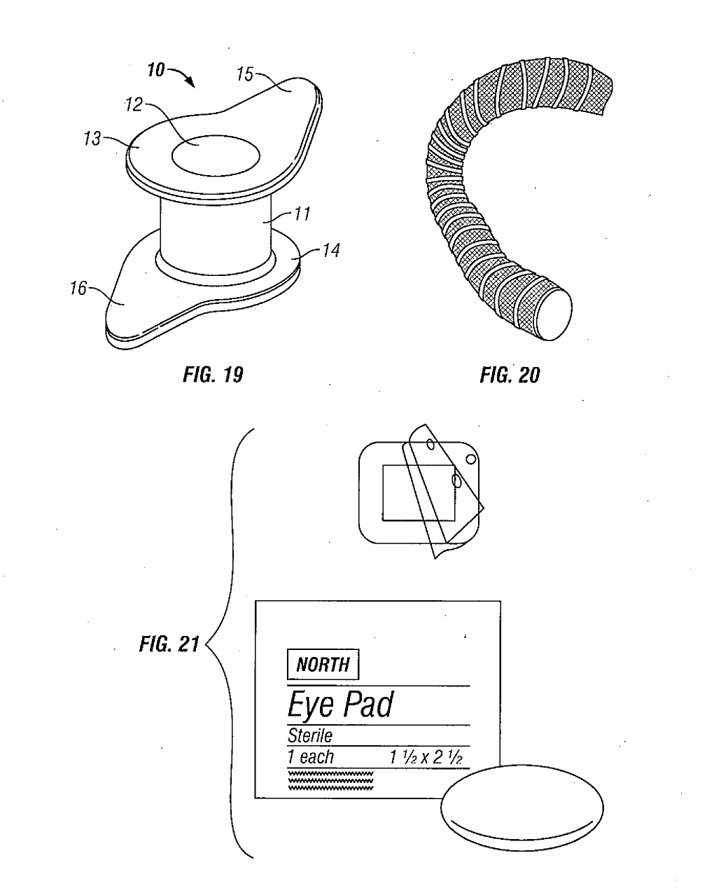

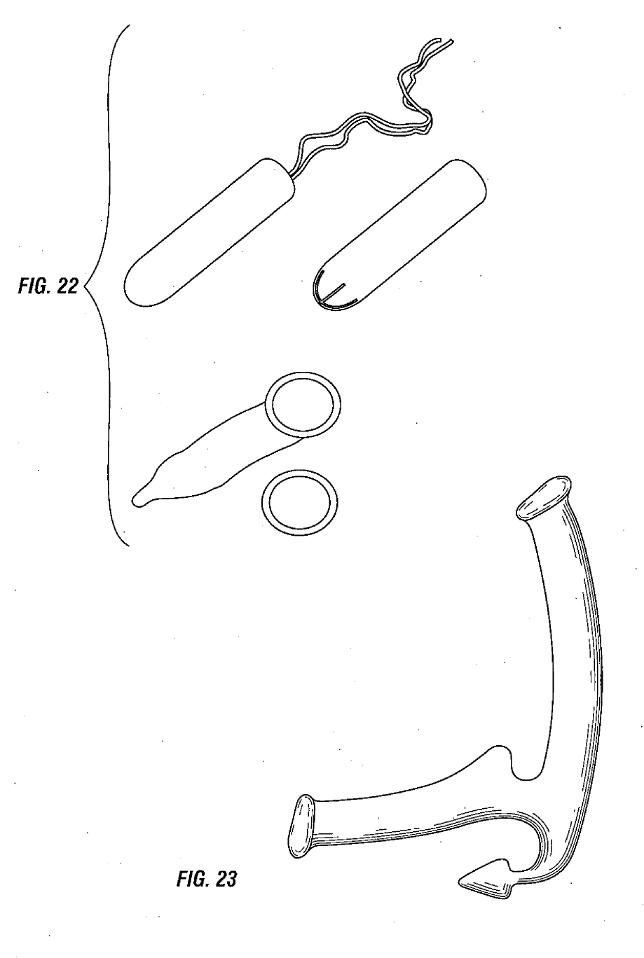

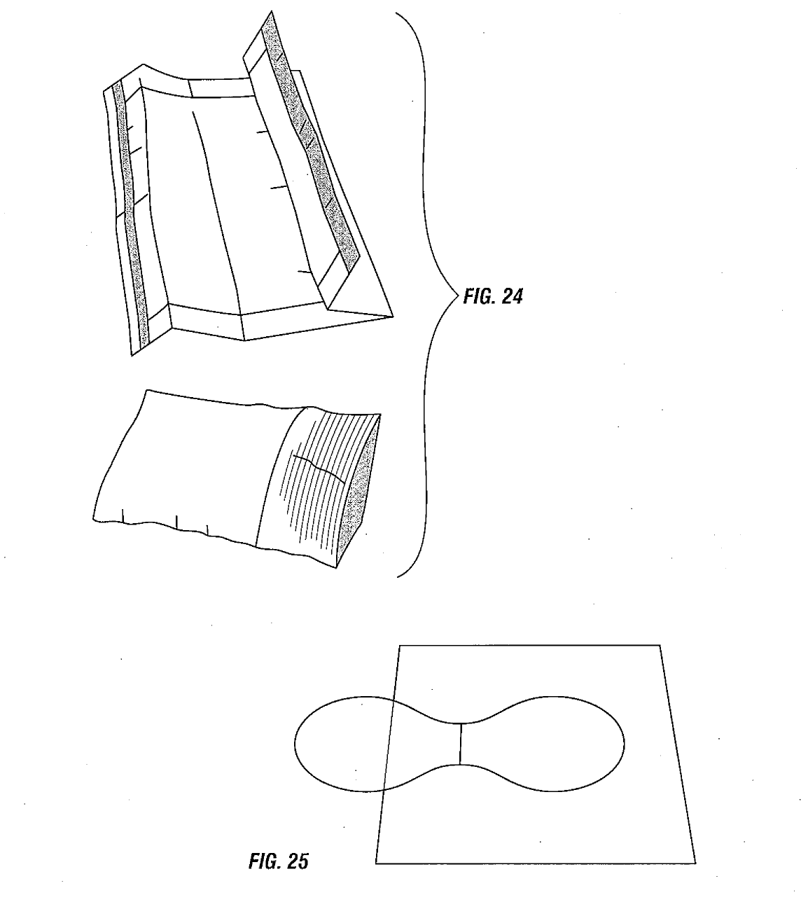

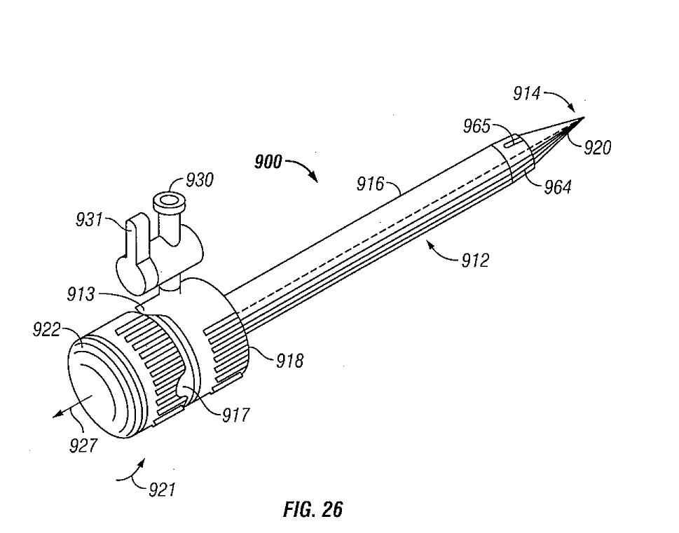

A variety of different medical products can be utilized with the present invention, including but not limited to, nasal cannulas, oxygen masks, wound dressings, skin tapes, bandages, band aids, catheters, endotrachial tubes, condoms, surgical and other gloves, sheaths for endoscopy probes, and other medical products that physically touch the body and the like, as illustrated in FIGS. 1-26. Included in the medical products are barriers to entry into the body via a natural external orifice such as the external ear canal, the nares, the oropharynx, the vagina and the anus. All of these inventions are formed from the polymer with biologically passive or active surfaces via a self-assembling monolayer end group. At such entry natural entry points the present invention would circumferentially have contact with the surrounding tissue. Additional uses would include un-natural orifices created intentionally i.e. a gastrostomy tube site, a tracheostomy site or an intestinal ostomy) or unintentionally i.e. by trauma. Other applications can include surgical ports such as those used for thoracostomy or laparotomy port sites. The device would act as a natural or un-natural orifice port barrier to infectious agents. The invention could be porous allowing for the inward or external movement of fluids, drugs or gases; expandable, either with fluids or gases (inert or containing biological active compounds); non-porous; surface sealed, and non-surface sealed. There could be more than one or more ports through the device allowing for instance the placement of a rectal tube, a tracheostomy tube, and an endrotracheal tube. Simultaneous with the insertion of the primary apparatus separate ports could allow the addition of suction catheters, or irrigation catheters. The antibacterial or anti-agent systems can be placed on the surface of the device in direct contact with the tissue or embedded throughout the material. The antibacterial or anti-agent systems can be manufactured to be an effluent. An effluent anti-bacterial or anti-agent systems can thus have an increased zone of organism eradication.

In various embodiments, the present invention can also be in the form of non-medical products including but not limited to, gloves, cycle handlebar tape, bandages, band aids, nasal inserts, nose plugs, ear inserts, earplugs, anal inserts, anal plugs, vaginal inserts, vaginal plugs, skin tape, sports wrapping tape, socks and foot coverings, compression sleeves, compression stockings, clothing, and other non-medical products that physically touch the body and the like.

With the present invention, substantially any antimicrobial agent can be utilized, such as drugs, chemicals, or other substances that either kill or slow the growth of microbes. Historically Silver additives in devices have been up to 10 wt %, but biologically active surface monolayers are measured in atom lengths of 100 Carbon atoms, ie. 9-carbon containing sulfonate-alkynol and 12-carbon containing sulfonate-alkynol. Suitable antimicrobial agents can be one or more of, antibacterial drugs, antiviral agents, antifungal agents, antiparisitic drugs and the like. See Robert Ward, “New Frontiers in Polymer Surface Modification”, Medical Device and Diagnostic Industry, November 2007, and R. S. Ward, “New Horizons for Biomedical Polymers”, Medical Device Technology, September 2008, both of which are fully incorporated herein by reference.

A non-limiting example includes activating the surface of polyurethanes, a family of polymers widely used in medicine. In addition to or instead of incorporating only surface substrates or coatings, this invention utilizes a technology that applies the technique of self-assembly to the polymer surfaces. This technology attaches functional groups with desired biological properties to the ends of long polyurethane molecules. The functional groups found in small concentrations within the bulk substrate, migrate to the surface of the bulk material forming a biologically active surface monolayer. A non-limiting example of design(s), a self-assemble into a monolayer such that the functional end groups assemble on the surface. Unlike a coating which can be permanently damaged, in this embodiment, there is continued functional group migration to the surface of the material, as the exposed surface wears or is compromised. That is, the self-assembly of molecules are capable of performing repeated self-assembly to replenish the material surface monolayer keeping it active even under use and wear and tear. Because of this capability, the functionality that is chosen for the material surface monolayer (polymer end groups) becomes an intrinsic property of the polymer itself. In a non-limiting example, this technology can be applied to a biologically active surface-modifying end group(s). This embodiment will include functional end groups that can confer for example, either short-term topical or long-term biostatic, biocidal and hemocompatible properties to the polymer. Utilizing this technology one can create short-term surface patches and barriers that will inhibit colonization on living organisms, i.e. humans or pets or inanimate objects such as sanitary devices, medical devices, table trays, art supplies or sporting equipment. Long-term possibly permanent surface(s) or casing(s) can be manufactured for implantable devices such as those coming in contact with soft tissue, blood, muscle, organs, bone, tendons, nerves, other body fluids, and all other types of biological tissues.

In one embodiment, the antimicrobial agent can be a polymer matrix having quaternary ammonium groups tethered to its surface through non-siloxane bonds. The surface area of the polymer matrix is enhanced, for instance, by electrostatically spinning a fiber-forming synthetic polymer to form a frayed fiber or filament. Alternatively, the polymer solution can be wet- or dry-spun to create a roughened fiber surface by controlling the choice of solvent and the polymer solution temperature. Additional surface area enhancement is provided by tethering molecular chains of quaternary ammonium pendent groups to the surface of the polymer matrix. Tethering may be accomplished by known techniques such as grafting and selective adsorption.

In an alternate embodiment of the invention, non-ionic bactericidal molecules are coupled to the surface of the polymer matrix, in lieu of ionically-charged molecules. Ionically-charged molecules are prone to being neutralized upon encountering oppositely-charged molecules. For instance, positively-charged quaternary ammonium groups may be neutralized by negatively-charged chloride ions present in physiological fluids. In instances were such neutralization is significant enough to reduce the bactericidal properties of the dressing below an acceptable level, non-ionic surface groups may be preferable.

The antibacterial polymer composition can be fabricated to have an enhanced surface area and superabsorbent capacity for biological fluids, including urine, blood, and wound exudate.

The composition used with the present invention can include a polymer matrix having quaternary ammonium compounds attached to the surface of the polymer matrix. The polymer matrix is comprised of a plurality of hydrophilic fibers or filaments which can be fabricated in any suitable manner. For example, suitable fibers or filaments can be fabricated by wet- or dry-spinning a fiber-forming synthetic polymer from a spinning solvent. The resulting polymer has superabsorbent capacity. Generally, polymers capable of absorbing from about thirty to sixty grams of water per gram of polymer are considered to be superabsorbent. Examples of superabsorbent polymers which can be fabricated in this manner include polyacrylic acids, polyethylene oxides and polyvinyl alcohols. For example, methods for spinning polyethylene oxide using acetone solvent are well known.

Significantly, the polymer matrix is fabricated to have an enhanced surface area. Enhancing the surface area of the polymer matrix results in improved absorption of biological fluids, and increases the availability of sites for attachment of the antimicrobial quaternary ammonium compounds. A corresponding increase in the quantity and density of antimicrobial sites, in turn, enhances the efficacy of the composition in killing organisms such as bacteria and viruses.

A variety of methods are available for accomplishing surface area modification. Preferably, surface area enhancement is accomplished by a modified spinning or casting method. For instance, electrostatic spinning is a modified spinning technique which results in fraying of the fiber as it exits the spinerette. Alternatively, a polymer solution can be wet- or dry-spun to create a roughened fiber surface by controlling the solvent type and the polymer solution temperature. This technology is well known and has been applied, for example, in the manufacture of asymmetric membranes having roughened pores for dialysis. The size of the roughened pores is primarily controlled by the speed of precipitation which, in turn, is controlled by solvent interaction parameters, temperature, etc.

The surface area of the polymer composition is further enhanced by tethering chains of antimicrobial groups to the outer surface of the individual polymer fibers. Preferably, molecular chains of quaternary ammonium pendent groups are fabricated to have at least one end adapted for attachment to a fiber surface. For instance, surface grafting may be accomplished by creating surface free radicals as initiation sites from peroxide generation (ozone or microwave). Alternatively, surface attachment of an interpenetrating network may be achieved using a monomer which swells the substrate polymer. The incorporation of tethered antimicrobial chains has the further benefit of enhancing the functionality of the composition. In particular, the tethered antimicrobial chains extend into the particular biological solution to bind to harmful bacterial and viral organisms. In contrast to known dressing compositions in which a monolayer (or near monolayer) of bactericidal compound is directly attached to a fiber surface, the chain structures of the present invention, which function like arms extending outwardly from the fiber surface, more effectively bind the antimicrobial sites to harmful organisms. Preferably, tethering is accomplished by grafting the antimicrobial chains directly to the matrix surface, or by selective adsorption of a copolymer to the matrix surface.

Grafting techniques are well known in the art. For example, quaternary ammonium compound grafting using the monomer trimethylammonium ethyl methacrylate to graft polymerize to a modified polyethylene surface is described by Yahaioui (Master's Thesis, University of Florida, 1986). Yahioui describes a grafting technique in which a plasma discharge is used to create free radicals which initiate polymerization of appropriate monomers. Selective adsorption of appropriate block copolymers can also be used.

In contrast to known compositions in which an antimicrobial structure is achieved by covalently bonding silane groups to the surface of the base polymer, the present invention incorporates a chemical structure which is based on polymerization (i.e., surface grafting) of monomers containing all carbon-carbon, carbon-oxygen and carbon-nitrogen main bonds, such as the dialkly, diallyl, quaternary ammonium compounds. Consequently, the composition of the present invention results in a structure which is less prone to reacting with acids and bases produced by bacterial growth. As previously mentioned, such reactions can degrade the attachment between the matrix and antimicrobial groups. In instances where the composition is applied to a wound dressing, such degradation could result in antimicrobial agents detaching from the polymer matrix and entering a wound site. In some cases, this can have the deleterious effect of retarding wound healing.

In an alternate embodiment of the present invention, anionic antibactericidal groups are immobilized on the surface of a superabsorbant dressing to improve the antibactericidal efficacy of the dressing. The positive charge associated with quaternary ammonium groups, for example, can be neutralized by negative ions, such as chloride ions present in physiological fluids such as urine and plasma. For applications where the degree of neutralization will significantly reduce the effectiveness of the antibactericidal agent, anionic surface groups can be substituted for quaternary ammonium groups. Examples of chemical compounds that can be used to produce immobilized anionic surface groups include Triton-100, Tween 20 and deoxycholate. For instance, Triton-100 contains a free hydroxyl group which can be derivatized into a good leaving group, such as tosyl or chloride, and subsequently reacted with a base-treated polymer, such as methyl cellulose, to yield a surface immobilized non-ionic surfactant.

Dimethyldiallyl ammonium chloride is one example of a suitable monomer which may be used with the present invention. This monomer, commonly referred to as DMDAC or DADMAC, is used in the fabrication of commercial flocculating polymers. Modifications of trialkyl(p-vinylbenzyl) ammonium chloride or the p-trialkylaminoethyl styrene monomers are also suitable. One such example is trimethyl(p-vinyl benzyl) ammonium chloride; the methyl groups of this monomer can be replaced by other alkyl groups to impart desired properties. Alternatively, methacrylate-based monomers may be used; however, they may suffer from hydrolytic instability under acidic and basic conditions in a fashion similar to the silane-based treatments of the prior art. Consequently, methacrylate-based monomers are not preferred.

In one embodiment, a class of polymers is used % having the general formula

R(LE)ₓ

in which R is a polymeric core having x endgroups, E is an endgroup covalently linked to polymeric core R by linkage L, and L is a divalent oligomeric chain capable of self-assembly with L chains on adjacent molecules of the polymer.

The polymeric composition of matter illustrated below, wherein R is a polydimethylsiloxane base polymer having a MW of 500,000 daltons, L is —Si(CH₃)₂—(CH₂)₁₂—O—C(CH₃)₂—, E is 2000 dalton MW polyvinylpyrrolidone, and x is 2.

The polymeric composition of matter illustrated below, wherein R is a polyetherurethane base polymer having a MW of 250,000 daltons, L is —NH—C(.dbd.O)—O—(CH₂)₁₀O—O—C(CH₃)₂—, E is 1000 dalton MW polyvinylpyrrolidone, and x is 2.

The polymeric composition of matter illustrated below, wherein R is a polycarbonate urethane polymer having a MW of 500,000 daltons, L is —NH—C(.dbd.O)—O—(CH₂)_{g}—, E is PDAMA, and x is 2.

The polymeric composition of matter illustrated below, wherein R is a polyurethane-polyurea copolymer having a MW of 250,000 daltons, L is —NH—C(.dbd.O)—NH—(CH₂)₁₆—NH—CH₂—, E is heparin, and x is 2.

The polymeric composition of matter illustrated below, wherein R is a polyetheretherketone base polymer having a MW of 300,000 daltons, L is —O—[Si(CH₃)₂O]₁₆—CH₂—CH₂—O—C(CH₃)₂—, E is 2000 dalton MW polyvinylpyrrolidone, and x is 2.

The polymeric composition of matter illustrated below, wherein R is a polymethylmethacrylate base polymer having a MW of 500,000 daltons, L is —C(.dbd.O)O—(CH₂)₁₁—O—, E is PhC, and x is 1.

The polymeric composition of matter illustrated below, wherein R is a polyurethane-polyurea copolymer having a MW of 300,000 daltons, L is —NH—C(.dbd.O)—NH—(CH₂)₁₂—, E is a RGD peptide, and x is 2.

The polymeric composition of matter illustrated below, wherein R is a polyetherurethane base polymer having a MW of 250,000 daltons, L is —NH—C(.dbd.O)—[O—(CH₂)₂—O]₄—0—C(CH₃)₂—, E is 1000 dalton MW polyvinylpyrrolidone, and x is 2.

The polymeric composition of matter illustrated below, wherein R is a polydimethylsiloxane base polymer having a MW of 400,000 daltons, L is —O—CH₂—CH₂—O0C(CH₃)₂—PVP with n=10 repeat units, E is a methacrylate reactive group, and x is 2.

The polymeric composition of matter illustrated below, wherein R is a polyetherurethane base polymer having a MW of 300,000 daltons, L is —NH—C(.dbd.O)—O—(CH₂)₃[Si(CH₃)₂O]₁₀—(CH.₂)₃—0—C(.dbd.O)—NH—(CH₂)₆—NH—C(.dbd.O)—, E is isethionic acid (HOCH₂CH₂SO₃H), and x is 2.

The polymeric composition of matter illustrated below, wherein R is a polyetherurethane base polymer having a MW of 300,000 daltons, L is —NH—C(.dbd.O)—O—(CH₂)₃[Si(CH₃)₂O]₁₀—(CH₂)₃—O—C(.dbd.O)—NH—(CH₂)₆—NH—C(.dbd.O)—, E is isethionic acid sodium salt (HOCH₂CH₂SO₃Na), and x is 2.

The polymeric composition of matter illustrated below, wherein R is a polyurethane polydimethylsiloxane copolymer having a MW of 200,000 daltons, L is —NH—C(.dbd.O)—NH—(CH₂)₈—, E is —NH₂, and x is 2.

The polymeric composition of matter illustrated below, wherein R is a polystyrene base polymer having a MW of 400,000 daltons, L is —[Si(CH₃)₂O]₁₀—Si(CH₃)₂—CH₂—CH₂—C—H₂—O—CH₂—, E is oxirane (epoxide) reactive group, and x is 1.

The polymeric composition of matter illustrated below, wherein R is a n-butylpolydimethylsiloxane having a MW of 1,000 daltons, L is —PVP—CH₂CH₂— with n=10 repeat units, E is a reactive methacrylate, and x is 1.

The polymeric composition of matter illustrated below, wherein R is a polyetherurethane base polymer having a MW of 200,000 daltons, L is a polybutadiene crosslinkable spacer, —NH—C(.dbd.O)—O—(CH₂—CH.dbd.CH—CH₂)₁₂—O—, E is CH₃ group and x is 2.

The polymeric composition of matter illustrated below, wherein R is a polyurethane-polyurea copolymer having a MW of 250,000 daltons, L is —NH—C(.dbd.O)—NH—(CH₂)₁₂—NH—C(.dbd.O)—, E is L-DOPA (3,4-dihydroxy-L-phenylalanine), and x is 2.

The polymeric composition of matter illustrated below, wherein R is a polyetherurethane base polymer having a MW of 200,000 daltons, L is —NH—C(.dbd.O)—O—(CH₂)₁₂—(OCH₂CH₂)₄—O—C(.dbd.O)—, E is L-DOPA (3,4-dihydroxy-L-phenylalanine), and x is 2.

The polymeric composition of matter illustrated below, wherein R is a “branched” polyetherurethane base polymer having a MW of 200,000 daltons, L is —NH—C(.dbd.O)—NH—(CH₂)₈—, E is an amine (NH₂) group, and x is 4. The branched polymer is obtained by making use of pentaerythritol C(CH₂OH)₄ for the synthesis with structure illustrated below.

U.S. Pat. No. 5,589,563 (Robert S. Ward and Kathleen A. White) describes the use of surface modifying endgroups (SMEs) to tailor polymer surface properties. The '563 patent is entitled “SURFACE-MODIFYING ENDGROUPS FOR BIOMEDICAL POLYMERS”. The entire contents of U.S. Pat. No. 5,589,563 are hereby expressly incorporated by reference. As documented in the '563 patent, a variety of simple hydrophobic and hydrophilic endgroups has been demonstrated to enable the achievement of useful changes in surface properties of polymers. Such surface properties include biostability, protein adsorption, abrasion resistance, bacterial adhesion and proliferation, fibroblast adhesion, and coefficient of friction. SME polymers have also been used in low bulk concentration as surface modifying additives (SMAs) to SME-free base polymers. Polymers of the types disclosed in U.S. Pat. No. 5,589,563 may be used as base polymers for carrying the covalently bonded Self-Assembling Monolayer endgroups. US 2005/0282977 A1 (Robert S. Ward, Keith R. McCrea, Yuan Tian, and Jaines P. Parakka) also discloses polymers that may be used as base polymers. The entire contents of US 2005/0282997 A1 are hereby expressly incorporated by reference.

A “self-assembling moiety”-containing polymer molecule endgroup is defined as an endgroup that spontaneously rearranges its positioning in a polymer body to position the moiety on the surface of the body, which positioning effects a reduction in interfacial energy. The endgroup structure may comprise one or more chemical groups, chains, or oligomers that spontaneously assemble in the outermost monolayer of the surface of the polymer body, or may comprise one or more chemical groups, chains, or oligomers that spontaneously assemble within the bulk of the polymer body. The polymer bulk is defined as the region within the polymer body that is at least one monolayer away from the outermost monolayer of the polymer body surface.

In one embodiment, the polymer body surface is contacted with a separate medium to form an interface under conditions that facilitate the delivery of endgroup molecular moieties to the polymer body surface and maximize the resulting concentration of head groups in the outermost surface. This delivery is, in part, due to the interaction of chemical groups, chains, or oligomers in the endgroup moieties. The endgroup molecular moieties are covalently or ionically bonded to a polymer in the body and include one or more chemical groups, chains, or oligomers that spontaneously assemble in the outermost monolayer of the surface of the polymer body or one or more chemical groups, chains, or oligomers that spontaneously assemble within that portion of the polymer body that is at least one monolayer away from the outermost monolayer of the polymer body surface. The endgroups can be bonded to the polymers through a divalent oligomeric chain, having at least 5 repeat units, that is capable of self-assembly with corresponding chains on adjacent molecules of the polymeric composition. Suitable structures for the spacer chains can be found in the SAM and silane literature. In general, self-assembling spacer chains suitable for polymer endgroups will be those that self assemble when present in self-assembling thiol or silane SAMs. Accordingly persons skilled in the art of conventional SAM monomers, e.g., on gold or silicon substrates, can readily determine suitable spacer chains for use in making the self-assembling monomers which can be employed.

In this method, the surface-modifying endgroup moieties may be delivered to the polymer body surface by their spontaneous diffusion to the surface region of the polymer body or by their rearrangement or repacking in the surface layer of the polymer body.

The polymer comprising the surface-modifying endgroup moieties in the polymer body makes up the entirety, or a major portion, of the body and has a weight average molecular weight in the range 5000-5,000,000 daltons, preferably in the range 50,000-1,000,000 daltons. Optionally, delivery of surface-modifying endgroups to the polymer body surface can be accomplished by adding a Surface-Modifying Additive (SMA) to the polymer just described, with the additive comprising a second polymer that is covalently or ionically bonded to the surface-modifying endgroup moieties.

When delivery of the surface-modifying endgroup moiety to the polymer surface is accomplished by adding an SMA to the polymer to be modified, the useful molecular weight range of the polymer used as an SMA may be lower: 1000-5,000,000 daltons and preferably in the range 5000 to 200,000 daltons. This is because the SMA is typically used in low bulk concentrations, e.g. less than 15 weight-%, and preferably about 1 to 5 weight-%, so that the physical-mechanical properties of the base polymer/SMA blend will be largely determined by the base polymer being modified. However, very low SMA molecular weight may cause the SMA to be fugitive from the polymer being modified, e.g. by leaching or even volatilizing from the surface of the base polymer in use, particularly when there is exposure to fluids, vacuum, and/or high temperatures in use. Candidate SMA polymers with molecular weight less than 5000 are generally unsuitable and must be tested for their permanence in the base polymer before use in applications.

Alternatively, delivery of surface-modifying endgroup moieties to the polymer body surface or other substrate to be modified may be accomplished by coating, plasma treatment, painting, or otherwise topically treating the surface of a pre-formed body with a material comprising a second polymer covalently or ionically bonded to the surface-modifying endgroup moieties.

A method can be provided of immobilizing enzymes, proteins, peptides, polysaccharides, or other biologically active or biomimetic moieties at an interfacial surface of a polymer body. This method comprises the sequential steps of (a) contacting the polymer body with a medium that facilitates delivery of endgroup molecular moieties to the surface which molecular moieties are capable of self assembling and are bonded to chemically-reactive groups capable of binding biologically-active entities to the surface of the polymer body, and (b) binding the enzymes, proteins, peptides, polysaccharides, or other biologically active or biomimetic moieties to the reactive groups in a suitable medium such as aqueous solution. The endgroup molecular moieties are covalently or ionically bonded to a polymer in the body and comprise one or more chemical groups, chains, or oligomers that spontaneously assemble in the outermost monolayer of the surface of the polymer body.

### Sum Frequency Generation Analysis

Surface-Modifying Endgroups are designed to migrate to an article's surface and to self assemble in that surface. The analysis required to investigate the chemical composition and orientation of a surface monolayer provided in this way, as well as surface monolayers on conventional SAMs, will ideally probe only that monolayer in order to obtain an accurate representation of the surface. Various spectroscopic techniques—including reflection infrared spectroscopy, attenuated total reflection infrared spectroscopy, and Raman spectroscopy—have been used to characterize polymer surfaces. These methods, however, lack surface specificity and the resulting spectra are often obscured by the response from the bulk. Surface-sensitive techniques such as contact angle measurement, neutron reflection, and X-ray photoelectron spectroscopy often do not provide structural information, and/or do not allow for in situ measurement. More recently, a surface-specific analytical technique with monolayer sensitivity has successfully been applied it to various kinds of surfaces and interfaces. Through IR and visible sum-frequency generation spectroscopy (SFG), a powerful and versatile in situ surface probe has been created that not only permits identification of surface molecular species, but also provides information about orientation of functional groups at the surface. SFG has the common advantages of laser techniques. That is, it is nondestructive, highly sensitive, and has good spatial, temporal, and spectral resolution.

During an SFG experiment, two laser beams are overlapped both in time and space on a polymer surface. The first laser is a fixed visible green beam with a wavelength of 532 nm (.omega.ᵥᵢₛ). The second laser is a tunable infrared beam (.omega._{IR}), e.g., in the wavelength range between 2 and 10 .mu.m (1000-4000 cm⁻¹). The visible and IR beams mix on the surface to drive an oscillating dipole which then emits a coherent beam of photons at the sum of the visible and IR frequencies (.omega._{SFG}=.omega.ᵥᵢₛ+.omega._{IR}). A photo multiplier tube easily detects this generated beam to record a vibrational spectrum. Under the electric dipole approximation, the intensity of the sum frequency signal is proportional to the square of the second-order nonlinear surface susceptibility (I.varies.|.chi.⁽²⁾|²).

The susceptibility is described by the equation

.chi.(2)=A_{NR}RA_{R}.omega.−.omega.₀−.gamma.)

where A_{NR} is the non-resonant contribution, .gamma. is the line width, .omega.₀ is the resonant vibrational frequency, and .omega._{IR} is the IR frequency. The resonant strength, A_{R}, is proportional to the concentration and orientation of molecules on the surface and the infrared and Raman transition moments. As observed in this equation, when .omega._{IR} is equal to .omega.₀, .chi.⁽²⁾ is maximized and so a surface vibrational spectrum can be obtained by scanning .omega._{IR} through a frequency range of interest. Since A_{R} is proportional to the IR and Raman transition moments, the selection rules for both IR and Raman spectroscopy must be obeyed. Hence, a media must be both IR-active and Raman-active. From group theory, it can be shown that only media that lack inversion symmetry will satisfy this requirement. Usually, bulk materials are centrosymmetric and therefore do not generate SFG. Isotropic gasses and liquids also do not generate SFG. Only at surfaces or interfaces where the centrosymmetry of the bulk material is broken can SFG occur, therefore, SFG is extremely surface specific.

SFG is surface specific for many polymers because the bulk is amorphous; there is no net orientation of the polymer chains. Because of this random orientation, .chi.⁽²⁾ vanishes, and SFG is not allowed. A polymer surface, however, can have a net orientation of backbone atoms or functional groups at its surface, which leads to polar ordering. chi.⁽²⁾ is then non-zero for a polymer surface, and is therefore SFG allowed. The orientation of molecules at the surface can also be determined by SFG. As described earlier, .chi.⁽²⁾ is proportional to the orientation of surface molecules. chi.⁽²⁾ is a third rank tensor and the net orientation of surface molecules can be deduced by probing the surface with different polarizations of light. By changing the polarization of the input and output beams, different components of the tensor are accessed.

Because SFG is surface specific, the technique can be used to probe any interface as long as the media the laser beams must pass through do not interfere with the light. Examples of the interfaces accessible by SFG include but are not limited to the polymer/gas interface and the polymer/liquid interface

The SFG apparatus is a complex laser system based on a high-power picosecond Nd:YAG laser and an optical parametric generator/amplifier (OPG/OPA). The fundamental output (1064 nm) of the Nd:YAG laser is frequency doubled to produce the 532 nm visible beam and is used to drive an OPO/OPA. The tunable (e.g., 1000 to 4000 cm⁻¹) IR beam is generated from a series of non-linear crystals through OPG/OPA and difference frequency mixing. The sum-frequency (SF) spectra are obtained by overlapping the visible and IR beams on the polymer surface at incident angles of 55.degree. and 60.degree., respectively. The SF signal from the polymer surface is filtered by a monochromator, collected by a photomultiplier tube (PMT), and processed using gated integrator. Surface vibrational spectra are obtained by measuring the SF signal as a function of the input IR frequency.

### EXAMPLES

Relative to backbone chains, polymer endgroups are more mobile allowing them to diffuse from the bulk, and assemble at the polymer interface relative to their bulk concentration. This produces major changes in surface composition that occurs spontaneously if the presence of the endgroups in the surface reduces system interfacial energy. Simple hydrophobic endgroups diffuse to an air interface, while purely hydrophilic endgroups enrich a polymer surface exposed to aqueous body fluids. These and more complex surface-modifying endgroups (SMEs) can be specifically tailored to affect the biologic response of polymers used in medical devices. For instance, in air, methoxy-terminated polyethylene oxide SMEs on a polyether-urethane polymers present a surface that is rich in hydrophobic methyl groups, but that surface is devoid of methyl groups in water. This is due to an endgroup conformation in which hydrated PEO ‘arches’ project from the surface, and terminal methyl groups are buried below the outermost surface layer accessible by Sum Frequency Generation (SFG). Other placements of hydrophobic groups and optional reactive groups on hydrophilic endgroups can produce more complex surface nanostructures useful in applications, including the delivery or permanent binding of biologically-active molecules.

### Example 1

Self-Assembling Monoloayer (SAM) of this Example prepared from octadecanethiol by adsorption from ethanol solution onto a sold substrate. The ‘SAM-containing polymer’ with an aromatic polycarbonate-urethane (PCU) backbone is synthesized by continuous step growth polymerization on a twin screw extruder using a mono-functional SME analogue of the SAM monomer (octadecanol) as a chain stopper. That is, a reactive hydroxyl group ‘replaces’ the thiol group on octadecanethiol. During bulk polymer synthesis the SME is coupled to the ends of the polymer backbone by urethane linkages formed by reaction between hydroxyl groups on the octadecanol and isocyanate groups on the PCU polymer being modified. The monofunctionality of the octadecanol assures that it chain stops the polymer, forming an endgroup. A film of the fully-reacted SME polymer is cast from solution on a continuous web coater. Both surfaces are characterized by SFG in air as described below.

The SME-PCU-SME polymer formed as described above is extremely tough. Tensile Strength is, for example, 62 Mpa. Ultimate Elongation is, for example, 400%. The methyl symmetric and Fermi resonance peaks of octadecane are observed at 2875 and 2935 cm⁻¹, respectively. Although the bulk octadecane SME concentration in the PCU is only 0.6 wt %, the methyl peaks dominate the BIONATE SFG spectra, with only a small peak contributed by the methylenes present in the polycarbonate PCU backbone. In both plots the ordinate is SFG Intensity [a.u], the abscissa is Frequency [cm⁻¹]. Note: Destructive interference between the non-resonant gold signal and resonant SAM vibrational signal creates negative peaks associated with SAM vibrational modes.

Initial SAM development on gold is often characterized by rapid formation of gold-thiol bonds and planar conformation of the alkane chains, followed by slower filling in of the final monolayer, attainment of the characteristic angle of the alkanes relative to the surface, and close packing of (e.g., methyl) head groups. In SME polymers the diffusion of endgroups from the bulk ‘replaces’ the SAM adsorption step, but it appears that the remaining steps toward surface equilibrium are similar. That is, upon arriving at the air interface from the bulk, the SAM-like SME may initially assume a planar conformation to maximize both the coverage by hydrophobic methylene groups, and the resulting interfacial energy reduction. As more SMEs arrive the alkanes begin to pack more closely in the surface and subsequently allow a tighter packing of very hydrophobic methyl groups, for an additional decrease in air/polymer interfacial energy. Polarized SFG measurements indicate that the equilibrium structure of the outermost, air-facing surface is composed of close-packed methyl head groups.

The concentration of the SAM-like SMEs at the surface depends on diffusion kinetics which is dependent on temperature. If a formed article is kept at room temperature, it may take several days for the surface diffusion of SMEs to be complete. At time 0, only a small peak attributed to the terminal methyl group is observed at 2875 cm⁻¹. As the sample is allowed evolve over time, the 2875 cm⁻¹ peak increases indicating an increase of octadecane at the surface.

Alkane thiol SAMs are assembled in various solvents to enhance assembly. Solvents also affect the assembly of SAM-like SMEs. Ethanol is a polar solvent often used in SAM assembly. Octadecane SME containing articles were soaked for 24 hours at RT in each in ethanol. The 2875/2855 ratio gives the concentration of SME relative to BIONATE functional groups at the surface. The surface concentration of SME, relative to BIONATE groups, actually decreases if the film is exposed to ethanol. This shows that polar solvents can suppress assembly of non-polar SMEs (octadecane) just as polar solvents can enhance assembly of hydrophilic SMEs.

A hydrophobic solvent (hexane) was also used to treat an octadecane SME containing article. Because octadecane is hydrophobic, hexane will enhance the assembly of the SMEs at the surface as indicated by the 2875/2850 ratio increase. In addition, the ratio of the 2875 to 2960 peak gives us information about the orientation of the methyl groups. As the ratio increases, the methyl group becomes more perpendicular to the surface. This ratio is considerably larger for the hexane soaked sample as compared to the as received or ethanol soaked samples. Soaking hydrophobic SAM-like SME containing articles in polar solvents increases the rate of diffusion and packing of the SMEs at the surface. Non-polar solvents suppress assembly of hydrophilic SMEs.

Thermal annealing SAM-like SME containing articles also enhances assembly of the SME at the surface. Annealing the untreated, ethanol treated, and hexane treated articles show enhancement in the assembly of the octadecane SME at the surface.

### Example 2

Synthesis of a SAM-containing polymer with an aromatic polycarbonate-urethane (PCU) backbone by step growth polymerization using mono-functional heparin binding compounds of the type (PDAMA) depicted below. The resulting polymer is populated with heparin binding sites on the surface as a result of self assembly of the polyalkylene chain. This Example generates PCU that bind to heparin via non-covalent interactions

### Example 3

Synthesis of a SAM-containing polymer with an aromatic polycarbonate-urethane (PCU) backbone by step growth polymerization and subsequent reaction with a compound bearing a Butyloxycarbonyl (BOC) protected amino group as shown below. De-protection under acidic conditions using organic acids (for e.g. trifluoracetic acid-CH₂Cl₂ mixture) or mineral acids (for e.g. dilute HCl) affords amino terminated PCU. Reaction of the said amino functionalized polymer with heparin aldehyde to form a Schiff base and subsequent reduction generates a covalently bonded heparinized polymer with end-point attachment of the heparin.

### Example 4

The synthesis of a ‘SAM-containing polymer with an aromatic polycarbonate-urethane (PCU) backbone by step growth polymerization using mono-functional heparin binding compounds of the zwitterionic phosphoryl choline (PhC) type depicted below. The resulting polymer is populated with heparin binding sites on the surface as a result of self assembly of the polyalkylene chain. This example generates PCU that bind to heparin via ionic interactions. In addition, the quaternary amine group is a suitable endgroup that provides antimicrobial properties.

### Example 5

A thermoplastic polyurethane bearing antimicrobial functionality is described in the following formula, wherein PCU is polycarbonate urethane bulk chain, R₁, R₂, and R₃ are radicals of straight, branched, or cyclic alkyl groups having one to eighteen carbon atoms or aryl groups that are substituted or unsubstituted. R₄ is an amino, hydroxyl, isocynate, vinyl, carboxyl, or other reactive group terminated alkyl chain that react with polyurethane chemistry.

Illustrative of such suitable quaternary ammonium germicides is one prepared from N,N-trimethylamine and 2-chloroethyloxyethyloxyethanol to form a quaternary salt. This quaternary is used as a surface modifying endgroup (SME) in preparing thermoplastic polyurethanes (B) in bulk or in solution. Self assembly of this SME occurs at the surface through the intramolecular interaction of the glyme groups.

### Example 6

Thermoplastic polyurethanes bearing lubricious surface properties are described below. Hydroxyl terminated polyvinyl pyrrolidone (C) is prepared by the radical polymerization of vinyl pyrrolidone in the presence of a hydroxyl containing radical transfer agent. This prepared hydroxyl terminated PVP is used as surface modifying endgroup (SME) in preparing thermoplastic polyurethanes (D) in bulk or in solution. Self assembly at the surface occurs through the intramolecular forces between the C12 alkane chain.

### Applications

Unconfigured SAM-containing may be converted to formed articles by conventional thermoplastic methods used to process polymers, including methods such as extrusion, injection molding, compression molding, calendering, and thermoforming under pressure or vacuum and stereo lithography. Multilayer processing such as co-extrusion or over-molding can be used on top of the base polymers to be economically viable and afford the surface properties from the SAM-containing polymer. SAM polymers may also be processed by solution-based techniques, such as air brush or airless spraying, ink jet printing, stereo lithography, elecrostatic spraying, brushing, dipping, casting, and coating. Water-based SAM polymer emulsions can be fabricated by methods similar to those used for solvent-based methods. In both cases, the evaporation of a volatile liquid (e.g., organic solvent or water) leaves behind a film of the SAM polymer. Liquid or solid polymers can be used with self assembling endgroups, optionally including or capable of binding biologically active or biomimetic species, in computer-controlled stereolithography—also know as three dimensional printing. This method is of particular use in the fabrication of dense or porous structures for use in applications, or as prototypes, for tissue engineering scaffolds, prostheses, medical devices, artificial organs, and other medical, consumer, and industrial end uses.

Optionally, the polymer melt or liquid system may include reinforcing particulate fillers or pore formers that may be solid, liquid, or gaseous. Solid and liquid pore formers may be removed after component fabrication by well-known methods including water, solvent, or super-critical fluid extraction, gaseous diffusion, evaporation etc., to create porous structures in which the surface-modified pores may be isolated, interconnected, or reticulated, depending on the initial loading and size of the incorporated pore formers. Such porous structures are useful as tissue engineering substrates, filters, prostheses, membranes, weight-reduced structures, and many other well-known uses of porous media. The above, and other, fabrication considerations are discussed in U.S. Pat. No. 5,589,563, the contents of which are hereby expressly incorporated by reference.

Often, surface-modifying endgroup moieties have little or no negative effect on processability. In fact, certain SAM-containing endgroups actually enhance processability of certain polymers that incorporate them by favorably impacting wetting and spreading by the base polymer on incorporated fillers, and on mandrels or polymeric, metallic, or nonmetallic substrates to be coated. SAM-containing polymers may also provide improved mold release properties, internal lubricity among adjacent polymer chains, increased smoothness of extrudates, and lower viscosity of polymers during thermoplastic, solution, and water-based processing. Out-gassing and surface finish during solvent casting, coalescence of water-based emulsions, adhesion to substrates, and so on may also be improved in SAM-containing polymers, as compared to their unmodified analogues.

In one embodiment, polymers are used that generally have tensile strengths of from about 100 to about 10,000 psi and elongations at break of from about 50 to about 1500%. Porous or non-porous films can be used in the form of flexible sheets or in the form of hollow membranes or fibers made by melt blowing, spinning, electrostatic spraying, or dipping, for example. Typically, such flexible sheets are prepared as long rollable sheets of about 10 to 15 inches in width and 1 to hundreds of feet in length. The thicknesses of these sheets may range from about 5 to about 100 microns. Thicknesses of from about 19 to 25 microns are particularly useful when the article to be manufactured is to be used without support or reinforcement.

When membranes can be fabricated from the polymers by knife-over-roll casting onto release paper, web, or a liner, for instance, a 24-foot-long 15-inch-wide continuous web coater equipped with forced-air ovens may be utilized. The coater may be modified for clean operation by fitting the air inlet ducts with High Efficiency Particulate Air filters. A nitrogen-purged coater box may be used to hold and dispense filtered polymer solutions or reactive prepolymer liquids. All but trace amounts of casting solvent (e.g., dimethylformamide) may be removed by the coaters hot air ovens fitted with HEPA filters. After membrane casting or another solvent-based fabrication method, the membrane and/or substrate may be further dried and/or extracted to reduce residual solvent content to less than about 100 ppm, for example. No significant loss of surface modifying moieties occurs during these post-fabrication purifications of SAM-containing polymers, because these moieties are covalently or ionically bonded to virtually every SAM-containing polymer molecule.

Polymer membranes may have any shape resulting from a process utilizing a liquid which is subsequently converted to a solid during or after fabrication, e.g., solutions, dispersion, 100% solids prepolymer liquids, polymer melts, etc. Converted shapes may also be further modified using methods such as die cutting, heat sealing, solvent or adhesive bonding, or any of a variety of other conventional fabrication methods.

In the case of thermoplastic surface-modifying endgroup moiety-containing polymers, thermoplastic fabrication methods may also be employed. Membrane polymers made by bulk or solvent-free polymerization method may be cast into, e.g., a Teflon-lined pan during the polymerization reaction. As the reaction proceeds and the polymerizing liquid becomes a rubbery solid, the pan may be post-cured in an oven, e.g. at 100-120.degree. C. for about an hour. Upon cooling, the solid mass may be chopped into granules and dried in a dehumidifying hopper dryer for, e.g., about 16 hours. The dry granules may then be compression molded, e.g., at about 175.degree. C., to form a fiat membrane which, when cool, will have a thickness of about 50 mm. Extrusion, injection molding, calendering, and other conversion methods that are well-known in the art may also be employed to form membranes, films, and coatings of the polymers configured into solid fibers, tubing, medical devices, and prostheses. As those skilled in the art will appreciate, these conversion methods may also be used for manufacturing components for non-medical product applications.

In one embodiment, the polymer bodies can include dense, microporous, or macroporous membrane components in implantable medical devices or prostheses or in non-implantable disposable or extracorporeal medical devices or diagnostic products. For example, in one embodiment, the polymer body may comprises a membrane component or coating containing immuno-reactants in a diagnostic device.

In one embodiment, the active agent may be complexed to the SAM endgroups and released through diffusion, or it may be complexed or bonded to SAM endgroups which are chosen to slowly degrade and release the drug over time. The surface endgroups of the polymers include surface-modifying endgroup moieties, provided that at least some of said covalently bonded surface-modifying endgroup moieties are other than alkylene ether-terminated poly(alkylene oxides). These latter medical devices or prostheses are excluded from the present invention to the extent that they are disclosed in U.S. Pat. No. 5,589,563.

In another embodiment a polymer body is provided, wherein the polymer body comprises a plurality of polymer molecules located internally within the body, at least some of which internal polymer molecules have endgroups that comprise a surface of the body. In this embodiment, the surface endgroups include at least one surface-modifying endgroup moiety, provided that at least some of said covalently bonded surface-modifying endgroup moieties are other than alkylene ether-terminated poly(alkylene oxides). In accordance with this embodiment, the surface of the polymer body has enhanced antimicrobial properties, reduced aerodynamic or hydrodynamic drag, enhanced resistance to encrustation by marine organisms, and/or enhanced ability to release marine organisms when moving through water (e.g., ship's coatings), stealth properties, enhanced resistance to attachment of ice and/or enhanced ability to release ice when moving through air or water (e.g., ship or aircraft coatings), enhanced resistance to oxidation, corrosion, damage by sunlight, water, or other environmental degradation of the underlying substrate (e.g., exterior or interior paints, treatments, and protective coatings), reduced or enhanced coefficient of friction, enhanced surface lubricity, enhanced surface adhesion or tack, enhanced ease of donning, enhanced wear properties, enhanced abrasive properties, enhanced or reduced static dissipation, enhanced or reduced energy absorption and/or energy conversion (e.g., in photovoltaic applications), or enhanced or reduced responsiveness to temperature, pH, electricity, or other stimuli.

The polymer can include a plurality of endgroups each comprising a chain capable of self assembling, and also contains one or more head groups that ultimately reside in the outermost monolayer of the polymer's surface are that are optionally used in a coupling reaction to bind other moieties. In this and other embodiments, branched, star, dendritic, columnar, tubular, and/or other multi-armed polymer structures are optional features of the polymer to be modified.

The self-assembling chains and/or the head groups of the endgroups include reactive sites for crosslinking the self-assembling chains to each other or to the base polymer, to minimize the ability of the modified-surface to restructure upon a change of environment, or when overcoated by an adsorbent. The latter is exemplified by, but not limited to, the use of an oleyl spacer chain between the polymer and the head group. This chain will self assemble in the surface in air and can subsequently be crosslinked by ultraviolet radiation, heat, or other means capable of inducing and/or catalyzing the reaction of double bonds. Once crosslinked, it is constrained from reorganizing, e.g., when immersed in an aqueous environment. Crosslinking, which may optionally include one or more additional reactants, initiators, inhibitors, or catalysts, immobilizes the self-assembled chains by joining them together with covalent chemical bonds or ionic bonds.

Before or after crosslinking the self-assembling spacer chains, the attached reactive head groups may be coupled to other optionally biologically-active moieties. A preferred approach for producing well-defined structures of this type is to use a different chemical reaction to crosslink the self-assembling spacer chains than the reaction used to couple active moieties to the head groups. A free radical or ionic reaction could, for instance, crosslink the spacer, preceding, following, or contemporaneously with a condensation reaction that couples an active moiety to the head group.

If the performance of the final surface in the intended application does not require a high level of coverage by the head groups, a mixture of head groups can be utilized in which some or all of the head groups take part in crosslinking reactions after self assembly of the spacer chains. For example, active hydrogen head groups could be reacted with appropriate polyfunctional crosslinkers. In another non-limiting example, acryloxy or methyacryloxy head groups may be linked together via free radical reactions, e.g., induced by heat or radiation (from UV or visible light, electron beam, gamma sources, etc.) in the presence of optional co-reactants. In still another examples, condensation reactions may be employed to crosslink the surface layer, for example by including silanes that give off a condensation by-products such as water, acid, or alcohol during or prior to the formation of crosslinks. Such reactions may be externally catalyzed or self-catalyzed. For instance, self catalysis may occur when the condensation by-product is acetic acid. In certain cases, including free radial crosslinking of endgroups, inert environments may be needed to facilitate the crosslinking reaction. For example, shielding the surface reactions from oxygen via an inert gas blanket may be required during free radical reactions, whereas exposure to water may be required to initiate certain condensation crosslinking reactions involving silanes with multiple acyloxy groups used as reactive head groups. In addition to these examples, other suitable crosslinking reactions and reaction conditions can be chosen from the technical literature.

These include a wide variety of well-known reactions commonly used for crosslinking polymer chains within the bulk of a formed article.

Crosslinking reactions may also be applied to the bulk polymer to be modified by the SAM-like SMEs. Crosslinking may be performed before, during, or after self assembly of the surface, to provide enhanced physical-mechanical properties, resistance to swelling, or any of the bulk property improvements associated with crosslinking that are well known to those skilled in the art. When the bulk polymer is t be crosslinked, it may be desirable to utilize spacer chains in the SME that do not crosslink, or which crosslink by a different mechanism. In this way, the bulk may be crosslinked before or after the surface spacer chains, without affecting the alignment or self-assembled structure of the spacer chains in the surface.

In one embodiment, the antimicrobial agent can be a polymer matrix having quaternary ammonium groups tethered to its surface through non-siloxane bonds. The surface area of the polymer matrix is enhanced, for instance, by electrostatically spinning a fiber-forming synthetic polymer to form a frayed fiber or filament. Alternatively, the polymer solution can be wet- or dry-spun to create a roughened fiber surface by controlling the choice of solvent and the polymer solution temperature. Additional surface area enhancement is provided by tethering molecular chains of quaternary ammonium pendent groups to the surface of the polymer matrix. Tethering may be accomplished by known techniques such as grafting and selective adsorption.

In an alternate embodiment of the invention, non-ionic bactericidal molecules are coupled to the surface of the polymer matrix, in lieu of ionically-charged molecules. Ionically-charged molecules are prone to being neutralized upon encountering oppositely-charged molecules. For instance, positively-charged quaternary ammonium groups may be neutralized by negatively-charged chloride ions present in physiological fluids. In instances were such neutralization is significant enough to reduce the bactericidal properties of the dressing below an acceptable level, non-ionic surface groups may be preferable.

The antibacterial polymer composition can be fabricated to have an enhanced surface area and superabsorbent capacity for biological fluids, including urine, blood, and wound exudate.

The composition used with the present invention can include a polymer matrix having quaternary ammonium compounds attached to the surface of the polymer matrix. The polymer matrix is comprised of a plurality of hydrophilic fibers or filaments which can be fabricated in any suitable manner. For example, suitable fibers or filaments can be fabricated by wet- or dry-spinning a fiber-forming synthetic polymer from a spinning solvent. The resulting polymer has superabsorbent capacity. Generally, polymers capable of absorbing from about thirty to sixty grams of water per gram of polymer are considered to be superabsorbent. Examples of superabsorbent polymers which can be fabricated in this manner include polyacrylic acids, polyethylene oxides and polyvinyl alcohols. For example, methods for spinning polyethylene oxide using acetone solvent are well known.

Significantly, the polymer matrix is fabricated to have an enhanced surface area. Enhancing the surface area of the polymer matrix results in improved absorption of biological fluids, and increases the availability of sites for attachment of the antimicrobial quaternary ammonium compounds. A corresponding increase in the quantity and density of antimicrobial sites, in turn, enhances the efficacy of the composition in killing organisms such as bacteria and viruses.

A variety of methods are available for accomplishing surface area modification. Preferably, surface area enhancement is accomplished by a modified spinning or casting method. For instance, electrostatic spinning is a modified spinning technique which results in fraying of the fiber as it exits the spinerette. Alternatively, a polymer solution can be wet- or dry-spun to create a roughened fiber surface by controlling the solvent type and the polymer solution temperature. This technology is well known and has been applied, for example, in the manufacture of asymmetric membranes having roughened pores for dialysis. The size of the roughened pores is primarily controlled by the speed of precipitation which, in turn, is controlled by solvent interaction parameters, temperature, etc.

The surface area of the polymer composition is further enhanced by tethering chains of antimicrobial groups to the outer surface of the individual polymer fibers. Preferably, molecular chains of quaternary ammonium pendent groups are fabricated to have at least one end adapted for attachment to a fiber surface. For instance, surface grafting may be accomplished by creating surface free radicals as initiation sites from peroxide generation (ozone or microwave). Alternatively, surface attachment of an interpenetrating network may be achieved using a monomer which swells the substrate polymer. The incorporation of tethered antimicrobial chains has the further benefit of enhancing the functionality of the composition. In particular, the tethered antimicrobial chains extend into the particular biological solution to bind to harmful bacterial and viral organisms. In contrast to known dressing compositions in which a monolayer (or near monolayer) of bactericidal compound is directly attached to a fiber surface, the chain structures of the present invention, which function like arms extending outwardly from the fiber surface, more effectively bind the antimicrobial sites to harmful organisms. Preferably, tethering is accomplished by grafting the antimicrobial chains directly to the matrix surface, or by selective adsorption of a copolymer to the matrix surface.

Grafting techniques are well known in the art. For example, quaternary ammonium compound grafting using the monomer trimethylammonium ethyl methacrylate to graft polymerize to a modified polyethylene surface is described by Yahaioui (Master's Thesis, University of Florida, 1986). Yahioui describes a grafting technique in which a plasma discharge is used to create free radicals which initiate polymerization of appropriate monomers. Selective adsorption of appropriate block copolymers can also be used.

In contrast to known compositions in which an antimicrobial structure is achieved by covalently bonding silane groups to the surface of the base polymer, the present invention incorporates a chemical structure which is based on polymerization (i.e., surface grafting) of monomers containing all carbon-carbon, carbon-oxygen and carbon-nitrogen main bonds, such as the dialkly, diallyl, quaternary ammonium compounds. Consequently, the composition of the present invention results in a structure which is less prone to reacting with acids and bases produced by bacterial growth. As previously mentioned, such reactions can degrade the attachment between the matrix and antimicrobial groups. In instances where the composition is applied to a wound dressing, such degradation could result in antimicrobial agents detaching from the polymer matrix and entering a wound site. In some cases, this can have the deleterious effect of retarding wound healing.

In an alternate embodiment of the present invention, anionic antibactericidal groups are immobilized on the surface of a superabsorbant dressing to improve the antibactericidal efficacy of the dressing. The positive charge associated with quaternary ammonium groups, for example, can be neutralized by negative ions, such as chloride ions present in physiological fluids such as urine and plasma. For applications where the degree of neutralization will significantly reduce the effectiveness of the antibactericidal agent, anionic surface groups can be substituted for quaternary ammonium groups. Examples of chemical compounds that can be used to produce immobilized anionic surface groups include Triton-100, Tween 20 and deoxycholate. For instance, Triton-100 contains a free hydroxyl group which can be derivatized into a good leaving group, such as tosyl or chloride, and subsequently reacted with a base-treated polymer, such as methyl cellulose, to yield a surface immobilized non-ionic surfactant.

Dimethyldiallyl ammonium chloride is one example of a suitable monomer which may be used with the present invention. This monomer, commonly referred to as DMDAC or DADMAC, is used in the fabrication of commercial flocculating polymers. Modifications of trialkyl(p-vinylbenzyl) ammonium chloride or the p-trialkylaminoethyl styrene monomers are also suitable. One such example is trimethyl(p-vinyl benzyl) ammonium chloride; the methyl groups of this monomer can be replaced by other alkyl groups to impart desired properties. Alternatively, methacrylate-based monomers may be used; however, they may suffer from hydrolytic instability under acidic and basic conditions in a fashion similar to the silane-based treatments of the prior art. Consequently, methacrylate-based monomers are not preferred.

In one embodiment, a class of polymers is used % having the general formula

R(LE)ₓ

in which R is a polymeric core having x endgroups, E is an endgroup covalently linked to polymeric core R by linkage L, and L is a divalent oligomeric chain capable of self-assembly with L chains on adjacent molecules of the polymer.

The polymeric composition of matter illustrated below, wherein R is a polydimethylsiloxane base polymer having a MW of 500,000 daltons, L is —Si(CH₃)₂—(CH₂)₁₂—O—C(CH₃)₂—, E is 2000 dalton MW polyvinylpyrrolidone, and x is 2.

The polymeric composition of matter illustrated below, wherein R is a polyetherurethane base polymer having a MW of 250,000 daltons, L is —NH—C(.dbd.O)—O—(CH₂)₁₀O—O—C(CH₃)₂—, E is 1000 dalton MW polyvinylpyrrolidone, and x is 2.

The polymeric composition of matter illustrated below, wherein R is a polycarbonate urethane polymer having a MW of 500,000 daltons, L is —NH—C(.dbd.O)—O—(CH₂)_{g}—, E is PDAMA, and x is 2.

The polymeric composition of matter illustrated below, wherein R is a polyurethane-polyurea copolymer having a MW of 250,000 daltons, L is —NH—C(.dbd.O)—NH—(CH₂)₁₆—NH—CH₂—, E is heparin, and x is 2.

The polymeric composition of matter illustrated below, wherein R is a polyetheretherketone base polymer having a MW of 300,000 daltons, L is —O—[Si(CH₃)₂O]₁₆—CH₂—CH₂—O—C(CH₃).₂—, E is 2000 dalton MW polyvinylpyrrolidone, and x is 2.

The polymeric composition of matter illustrated below, wherein R is a polymethylmethacrylate base polymer having a MW of 500,000 daltons, L is —C(.dbd.O)O—(CH₂)₁₁—O—, E is PhC, and x is 1.

The polymeric composition of matter illustrated below, wherein R is a polyurethane-polyurea copolymer having a MW of 300,000 daltons, L is —NH—C(.dbd.O)—NH—(CH₂)₁₂—NH—C(.dbd.O)—, E is a RGD peptide, and x is 2.

The polymeric composition of matter illustrated below, wherein R is a polyetherurethane base polymer having a MW of 250,000 daltons, L is —NH—C(.dbd.O)—[O—(CH₂)₂—O]₄—O—C(CH₃)₂—, E is 1000 dalton MW polyvinylpyrrolidone, and x is 2.

The polymeric composition of matter illustrated below, wherein R is a polydimethylsiloxane base polymer having a MW of 400,000 daltons, L is —O—CH₂—CH₂—O0C(CH₃)₂—PVP with n=10 repeat units, E is a methacrylate reactive group, and x is 2.

The polymeric composition of matter illustrated below, wherein R is a polyetherurethane base polymer having a MW of 300,000 daltons, L is —NH—C(.dbd.O)—O—(CH₂)₃[Si(CH₃)₂O]₁₀—(CH.₂)₃—O—C(.dbd.O)—NH—(CH₂)₆—NH—C(.dbd.O)—, E is isethionic acid (HOCH₂CH₂SO₃H), and x is 2.

The polymeric composition of matter illustrated below, wherein R is a polyetherurethane base polymer having a MW of 300,000 daltons, L is —NH—C(.dbd.O)—O—(CH₂)₃[Si(CH₃)₂O]₁₀—(CH.₂)₃—O—C(.dbd.O)—NH—(CH₂)₆—NH—C(.dbd.O)—, E is isethionic acid sodium salt (HOCH₂CH₂SO₃Na), and x is 2.

The polymeric composition of matter illustrated below, wherein R is a polyurethane polydimethylsiloxane copolymer having a MW of 200,000 daltons, L is —NH—C(.dbd.O)—NH—(CH₂)₈—, E is —NH₂, and x is 2.

The polymeric composition of matter illustrated below, wherein R is a polystyrene base polymer having a MW of 400,000 daltons, L is —[Si(CH₃)₂O]₁₀—Si(CH₃)₂—CH₂—CH₂—C—H₂—O—CH₂—, E is oxirane (epoxide) reactive group, and x is 1.

The polymeric composition of matter illustrated below, wherein R is a n-butylpolydimethylsiloxane having a MW of 1,000 daltons, L is —PVP—CH₂CH₂— with n=10 repeat units, E is a reactive methacrylate, and x is 1.

The polymeric composition of matter illustrated below, wherein R is a polyetherurethane base polymer having a MW of 200,000 daltons, L is a polybutadiene crosslinkable spacer, —NH—C(.dbd.O)—O—(CH₂—CH.dbd.CH—CH₂)₁₂—O—, E is CH₃ group and x is 2.

The polymeric composition of matter illustrated below, wherein R is a polyurethane-polyurea copolymer having a MW of 250,000 daltons, L is —NH—C(.dbd.O)—NH—(CH₂)₁₂—NH—C(.dbd.O)—, E is L-DOPA (3,4-dihydroxy-L-phenylalanine), and x is 2.

The polymeric composition of matter illustrated below, wherein R is a polyetherurethane base polymer having a MW of 200,000 daltons, L is —NH—C(.dbd.O)—O—(CH₂)₁₂—(OCH₂CH₂)₄—O—C(.d-bd.O)—, E is L-DOPA (3,4-dihydroxy-L-phenylalanine), and x is 2.

The polymeric composition of matter illustrated below, wherein R is a “branched” polyetherurethane base polymer having a MW of 200,000 daltons, L is —NH—C(.dbd.O)—NH—(CH₂)₈—, E is an amine (NH₂) group, and x is 4. The branched polymer is obtained by making use of pentaerythritol C(CH₂OH)₄ for the synthesis with structure illustrated below.

U.S. Pat. No. 5,589,563 (Robert S. Ward and Kathleen A. White) describes the use of surface modifying endgroups (SMEs) to tailor polymer surface properties. The '563 patent is entitled “SURFACE-MODIFYING ENDGROUPS FOR BIOMEDICAL POLYMERS”. The entire contents of U.S. Pat. No. 5,589,563 are hereby expressly incorporated by reference. As documented in the '563 patent, a variety of simple hydrophobic and hydrophilic endgroups has been demonstrated to enable the achievement of useful changes in surface properties of polymers. Such surface properties include biostability, protein adsorption, abrasion resistance, bacterial adhesion and proliferation, fibroblast adhesion, and coefficient of friction. SME polymers have also been used in low bulk concentration as surface modifying additives (SMAs) to SME-free base polymers. Polymers of the types disclosed in U.S. Pat. No. 5,589,563 may be used as base polymers for carrying the covalently bonded Self-Assembling Monolayer endgroups. US 2005/0282977 A1 (Robert S. Ward, Keith R. McCrea, Yuan Tian, and Jaines P. Parakka) also discloses polymers that may be used as base polymers. The entire contents of US 2005/0282997 A1 are hereby expressly incorporated by reference.

A “self-assembling moiety”-containing polymer molecule endgroup is defined as an endgroup that spontaneously rearranges its positioning in a polymer body to position the moiety on the surface of the body, which positioning effects a reduction in interfacial energy. The endgroup structure may comprise one or more chemical groups, chains, or oligomers that spontaneously assemble in the outermost monolayer of the surface of the polymer body, or may comprise one or more chemical groups, chains, or oligomers that spontaneously assemble within the bulk of the polymer body. The polymer bulk is defined as the region within the polymer body that is at least one monolayer away from the outermost monolayer of the polymer body surface.

In one embodiment, the polymer body surface is contacted with a separate medium to form an interface under conditions that facilitate the delivery of endgroup molecular moieties to the polymer body surface and maximize the resulting concentration of head groups in the outermost surface. This delivery is, in part, due to the interaction of chemical groups, chains, or oligomers in the endgroup moieties. The endgroup molecular moieties are covalently or ionically bonded to a polymer in the body and include one or more chemical groups, chains, or oligomers that spontaneously assemble in the outermost monolayer of the surface of the polymer body or one or more chemical groups, chains, or oligomers that spontaneously assemble within that portion of the polymer body that is at least one monolayer away from the outermost monolayer of the polymer body surface. The endgroups can be bonded to the polymers through a divalent oligomeric chain, having at least 5 repeat units, that is capable of self-assembly with corresponding chains on adjacent molecules of the polymeric composition. Suitable structures for the spacer chains can be found in the SAM and silane literature. In general, self-assembling spacer chains suitable for polymer endgroups will be those that self assemble when present in self-assembling thiol or silane SAMs. Accordingly persons skilled in the art of conventional SAM monomers, e.g., on gold or silicon substrates, can readily determine suitable spacer chains for use in making the self-assembling monomers which can be employed.

In this method, the surface-modifying endgroup moieties may be delivered to the polymer body surface by their spontaneous diffusion to the surface region of the polymer body or by their rearrangement or repacking in the surface layer of the polymer body.

The polymer comprising the surface-modifying endgroup moieties in the polymer body makes up the entirety, or a major portion, of the body and has a weight average molecular weight in the range 5000-5,000,000 daltons, preferably in the range 50,000-1,000,000 daltons. Optionally, delivery of surface-modifying endgroups to the polymer body surface can be accomplished by adding a Surface-Modifying Additive (SMA) to the polymer just described, with the additive comprising a second polymer that is covalently or ionically bonded to the surface-modifying endgroup moieties.

When delivery of the surface-modifying endgroup moiety to the polymer surface is accomplished by adding an SMA to the polymer to be modified, the useful molecular weight range of the polymer used as an SMA may be lower: 1000-5,000,000 daltons and preferably in the range 5000 to 200,000 daltons. This is because the SMA is typically used in low bulk concentrations, e.g. less than 15 weight-%, and preferably about 1 to 5 weight-%, so that the physical-mechanical properties of the base polymer/SMA blend will be largely determined by the base polymer being modified. However, very low SMA molecular weight may cause the SMA to be fugitive from the polymer being modified, e.g. by leaching or even volatilizing from the surface of the base polymer in use, particularly when there is exposure to fluids, vacuum, and/or high temperatures in use. Candidate SMA polymers with molecular weight less than 5000 are generally unsuitable and must be tested for their permanence in the base polymer before use in applications.

Alternatively, delivery of surface-modifying endgroup moieties to the polymer body surface or other substrate to be modified may be accomplished by coating, plasma treatment, painting, or otherwise topically treating the surface of a pre-formed body with a material comprising a second polymer covalently or ionically bonded to the surface-modifying endgroup moieties.

A method can be provided of immobilizing enzymes, proteins, peptides, polysaccharides, or other biologically active or biomimetic moieties at an interfacial surface of a polymer body. This method comprises the sequential steps of (a) contacting the polymer body with a medium that facilitates delivery of endgroup molecular moieties to the surface which molecular moieties are capable of self assembling and are bonded to chemically-reactive groups capable of binding biologically-active entities to the surface of the polymer body, and (b) binding the enzymes, proteins, peptides, polysaccharides, or other biologically active or biomimetic moieties to the reactive groups in a suitable medium such as aqueous solution. The endgroup molecular moieties are covalently or ionically bonded to a polymer in the body and comprise one or more chemical groups, chains, or oligomers that spontaneously assemble in the outermost monolayer of the surface of the polymer body.

### Sum Frequency Generation Analysis

Surface-Modifying Endgroups are designed to migrate to an article's surface and to self assemble in that surface. The analysis required to investigate the chemical composition and orientation of a surface monolayer provided in this way, as well as surface monolayers on conventional SAMs, will ideally probe only that monolayer in order to obtain an accurate representation of the surface. Various spectroscopic techniques—including reflection infrared spectroscopy, attenuated total reflection infrared spectroscopy, and Raman spectroscopy—have been used to characterize polymer surfaces. These methods, however, lack surface specificity and the resulting spectra are often obscured by the response from the bulk. Surface-sensitive techniques such as contact angle measurement, neutron reflection, and X-ray photoelectron spectroscopy often do not provide structural information, and/or do not allow for in situ measurement. More recently, a surface-specific analytical technique with monolayer sensitivity has successfully been applied it to various kinds of surfaces and interfaces. Through IR and visible sum-frequency generation spectroscopy (SFG), a powerful and versatile in situ surface probe has been created that not only permits identification of surface molecular species, but also provides information about orientation of functional groups at the surface. SFG has the common advantages of laser techniques. That is, it is nondestructive, highly sensitive, and has good spatial, temporal, and spectral resolution.

During an SFG experiment, two laser beams are overlapped both in time and space on a polymer surface. The first laser is a fixed visible green beam with a wavelength of 532 nm (.omega.ᵥᵢₛ). The second laser is a tunable infrared beam (.omega._{IR}), e.g., in the wavelength range between 2 and 10 .mu.m (1000-4000 cm⁻¹). The visible and IR beams mix on the surface to drive an oscillating dipole which then emits a coherent beam of photons at the sum of the visible and IR frequencies (.omega._{SFG}=.omega.ᵥᵢₛ+.omega._{IR}). A photo multiplier tube easily detects this generated beam to record a vibrational spectrum. Under the electric dipole approximation, the intensity of the sum frequency signal is proportional to the square of the second-order nonlinear surface susceptibility (I.varies.|.chi.⁽²⁾|²).

The susceptibility is described by the equation

.chi.(2)=A_{NR}RA_{R}(.omega._{IR}−.omega.₀−.gamma.)

where A_{NR} is the non-resonant contribution, .gamma. is the line width, .omega.₀ is the resonant vibrational frequency, and .omega._{IR} is the IR frequency.

The resonant strength, A_{R}, is proportional to the concentration and orientation of molecules on the surface and the infrared and Raman transition moments. As observed in this equation, when .omega._{IR} is equal to .omega.₀, .chi.⁽²⁾ is maximized and so a surface vibrational spectrum can be obtained by scanning .omega._{IR} through a frequency range of interest. Since A_{R} is proportional to the IR and Raman transition moments, the selection rules for both IR and Raman spectroscopy must be obeyed. Hence, a media must be both IR-active and Raman-active. From group theory, it can be shown that only media that lack inversion symmetry will satisfy this requirement. Usually, bulk materials are centrosymmetric and therefore do not generate SFG. Isotropic gasses and liquids also do not generate SFG. Only at surfaces or interfaces where the centrosymmetry of the bulk material is broken can SFG occur, therefore, SFG is extremely surface specific.

SFG is surface specific for many polymers because the bulk is amorphous; there is no net orientation of the polymer chains. Because of this random orientation, .chi.⁽²⁾ vanishes, and SFG is not allowed. A polymer surface, however, can have a net orientation of backbone atoms or functional groups at its surface, which leads to polar ordering. .chi.⁽²⁾ is then non-zero for a polymer surface, and is therefore SFG allowed. The orientation of molecules at the surface can also be determined by SFG. As described earlier, .chi.⁽²⁾ is proportional to the orientation of surface molecules. .chi.⁽²⁾ is a third rank tensor and the net orientation of surface molecules can be deduced by probing the surface with different polarizations of light. By changing the polarization of the input and output beams, different components of the tensor are accessed.

Because SFG is surface specific, the technique can be used to probe any interface as long as the media the laser beams must pass through do not interfere with the light. Examples of the interfaces accessible by SFG include but are not limited to the polymer/gas interface and the polymer/liquid interface

The SFG apparatus is a complex laser system based on a high-power picosecond Nd:YAG laser and an optical parametric generator/amplifier (OPG/OPA). The fundamental output (1064 nm) of the Nd:YAG laser is frequency doubled to produce the 532 nm visible beam and is used to drive an OPO/OPA. The tunable (e.g., 1000 to 4000 cm⁻¹) IR beam is generated from a series of non-linear crystals through OPG/OPA and difference frequency mixing. The sum-frequency (SF) spectra are obtained by overlapping the visible and IR beams on the polymer surface at incident angles of 55.degree. and 60.degree., respectively. The SF signal from the polymer surface is filtered by a monochromator, collected by a photomultiplier tube (PMT), and processed using gated integrator. Surface vibrational spectra are obtained by measuring the SF signal as a function of the input IR frequency.

### EXAMPLES

Relative to backbone chains, polymer endgroups are more mobile allowing them to diffuse from the bulk, and assemble at the polymer interface relative to their bulk concentration. This produces major changes in surface composition that occurs spontaneously if the presence of the endgroups in the surface reduces system interfacial energy. Simple hydrophobic endgroups diffuse to an air interface, while purely hydrophilic endgroups enrich a polymer surface exposed to aqueous body fluids. These and more complex surface-modifying endgroups (SMEs) can be specifically tailored to affect the biologic response of polymers used in medical devices. For instance, in air, methoxy-terminated polyethylene oxide SMEs on a polyether-urethane polymers present a surface that is rich in hydrophobic methyl groups, but that surface is devoid of methyl groups in water. This is due to an endgroup conformation in which hydrated PEO ‘arches’ project from the surface, and terminal methyl groups are buried below the outermost surface layer accessible by Sum Frequency Generation (SFG). Other placements of hydrophobic groups and optional reactive groups on hydrophilic endgroups can produce more complex surface nanostructures useful in applications, including the delivery or permanent binding of biologically-active molecules.

### Example 1

Self-Assembling Monoloayer (SAM) of this Example prepared from octadecanethiol by adsorption from ethanol solution onto a sold substrate. The ‘SAM-containing polymer’ with an aromatic polycarbonate-urethane (PCU) backbone is synthesized by continuous step growth polymerization on a twin screw extruder using a mono-functional SME analogue of the SAM monomer (octadecanol) as a chain stopper. That is, a reactive hydroxyl group ‘replaces’ the thiol group on octadecanethiol. During bulk polymer synthesis the SME is coupled to the ends of the polymer backbone by urethane linkages formed by reaction between hydroxyl groups on the octadecanol and isocyanate groups on the PCU polymer being modified. The monofunctionality of the octadecanol assures that it chain stops the polymer, forming an endgroup. A film of the fully-reacted SME polymer is cast from solution on a continuous web coater. Both surfaces are characterized by SFG in air as described below.

The SME-PCU-SME polymer formed as described above is extremely tough. Tensile Strength is, for example, 62 Mpa. Ultimate Elongation is, for example, 400%. The methyl symmetric and Fermi resonance peaks of octadecane are observed at 2875 and 2935 cm⁻¹, respectively. Although the bulk octadecane SME concentration in the PCU is only 0.6 wt %, the methyl peaks dominate the BIONATE SFG spectra, with only a small peak contributed by the methylenes present in the polycarbonate PCU backbone. In both plots the ordinate is SFG Intensity [a.u.], the abscissa is Frequency [cm⁻¹]. Note: Destructive interference between the non-resonant gold signal and resonant SAM vibrational signal creates negative peaks associated with SAM vibrational modes.

Initial SAM development on gold is often characterized by rapid formation of gold-thiol bonds and planar conformation of the alkane chains, followed by slower filling in of the final monolayer, attainment of the characteristic angle of the alkanes relative to the surface, and close packing of (e.g., methyl) head groups. In SME polymers the diffusion of endgroups from the bulk ‘replaces’ the SAM adsorption step, but it appears that the remaining steps toward surface equilibrium are similar. That is, upon arriving at the air interface from the bulk, the SAM-like SME may initially assume a planar conformation to maximize both the coverage by hydrophobic methylene groups, and the resulting interfacial energy reduction. As more SMEs arrive the alkanes begin to pack more closely in the surface and subsequently allow a tighter packing of very hydrophobic methyl groups, for an additional decrease in air/polymer interfacial energy. Polarized SFG measurements indicate that the equilibrium structure of the outermost, air-facing surface is composed of close-packed methyl head groups.

The concentration of the SAM-like SMEs at the surface depends on diffusion kinetics which is dependent on temperature. If a formed article is kept at room temperature, it may take several days for the surface diffusion of SMEs to be complete. At time 0, only a small peak attributed to the terminal methyl group is observed at 2875 cm⁻¹. As the sample is allowed evolve over time, the 2875 cm⁻¹ peak increases indicating an increase of octadecane at the surface.

Alkane thiol SAMs are assembled in various solvents to enhance assembly. Solvents also affect the assembly of SAM-like SMEs. Ethanol is a polar solvent often used in SAM assembly. Octadecane SME containing articles were soaked for 24 hours at RT in each in ethanol. The 2875/2855 ratio gives the concentration of SME relative to BIONATE functional groups at the surface. The surface concentration of SME, relative to BIONATE groups, actually decreases if the film is exposed to ethanol. This shows that polar solvents can suppress assembly of non-polar SMEs (octadecane) just as polar solvents can enhance assembly of hydrophilic SMEs.

A hydrophobic solvent (hexane) was also used to treat an octadecane SME containing article. Because octadecane is hydrophobic, hexane will enhance the assembly of the SMEs at the surface as indicated by the 2875/2850 ratio increase. In addition, the ratio of the 2875 to 2960 peak gives us information about the orientation of the methyl groups. As the ratio increases, the methyl group becomes more perpendicular to the surface. This ratio is considerably larger for the hexane soaked sample as compared to the as received or ethanol soaked samples. Soaking hydrophobic SAM-like SME containing articles in polar solvents increases the rate of diffusion and packing of the SMEs at the surface. Non-polar solvents suppress assembly of hydrophilic SMEs.

Thermal annealing SAM-like SME containing articles also enhances assembly of the SME at the surface. Annealing the untreated, ethanol treated, and hexane treated articles show enhancement in the assembly of the octadecane SME at the surface.

### Example 2

Synthesis of a SAM-containing polymer with an aromatic polycarbonate-urethane (PCU) backbone by step growth polymerization using mono-functional heparin binding compounds of the type (PDAMA) depicted below. The resulting polymer is populated with heparin binding sites on the surface as a result of self assembly of the polyalkylene chain. This Example generates PCU that bind to heparin via non-covalent interactions

### Example 3

Synthesis of a SAM-containing polymer with an aromatic polycarbonate-urethane (PCU) backbone by step growth polymerization and subsequent reaction with a compound bearing a Butyloxycarbonyl (BOC) protected amino group as shown below. De-protection under acidic conditions using organic acids (for e.g. trifluoracetic acid—CH₂Cl₂ mixture) or mineral acids (for e.g. dilute HCl) affords amino terminated PCU. Reaction of the said amino functionalized polymer with heparin aldehyde to form a Schiff base and subsequent reduction generates a covalently bonded heparinized polymer with end-point attachment of the heparin.

### Example 4

The synthesis of a ‘SAM-containing polymer with an aromatic polycarbonate-urethane (PCU) backbone by step growth polymerization using mono-functional heparin binding compounds of the zwitterionic phosphoryl choline (PhC) type depicted below. The resulting polymer is populated with heparin binding sites on the surface as a result of self assembly of the polyalkylene chain. This example generates PCU that bind to heparin via ionic interactions. In addition, the quaternary amine group is a suitable endgroup that provides antimicrobial properties.

### Example 5

A thermoplastic polyurethane bearing antimicrobial functionality is described in the following formula, wherein PCU is polycarbonate urethane bulk chain, R₁, R₂, and R₃ are radicals of straight, branched, or cyclic alkyl groups having one to eighteen carbon atoms or aryl groups that are substituted or unsubstituted. R₄ is an amino, hydroxyl, isocynate, vinyl, carboxyl, or other reactive group terminated alkyl chain that react with polyurethane chemistry.

Illustrative of such suitable quaternary ammonium germicides is one prepared from N,N-trimethylamine and 2-chloroethyloxyethyloxyethanol to form a quaternary salt. This quaternary is used as a surface modifying endgroup (SME) in preparing thermoplastic polyurethanes (B) in bulk or in solution. Self assembly of this SME occurs at the surface through the intramolecular interaction of the glyme groups.

### Example 6

Thermoplastic polyurethanes bearing lubricious surface properties are described below. Hydroxyl terminated polyvinyl pyrrolidone (C) is prepared by the radical polymerization of vinyl pyrrolidone in the presence of a hydroxyl containing radical transfer agent. This prepared hydroxyl terminated PVP is used as surface modifying endgroup (SME) in preparing thermoplastic polyurethanes (D) in bulk or in solution. Self assembly at the surface occurs through the intramolecular forces between the C12 alkane chain.

### Applications

Unconfigured SAM-containing may be converted to formed articles by conventional thermoplastic methods used to process polymers, including methods such as extrusion, injection molding, compression molding, calendering, and thermoforming under pressure or vacuum and stereo lithography. Multilayer processing such as co-extrusion or over-molding can be used on top of the base polymers to be economically viable and afford the surface properties from the SAM-containing polymer. SAM polymers may also be processed by solution-based techniques, such as air brush or airless spraying, ink jet printing, stereo lithography, elecrostatic spraying, brushing, dipping, casting, and coating. Water-based SAM polymer emulsions can be fabricated by methods similar to those used for solvent-based methods. In both cases, the evaporation of a volatile liquid (e.g., organic solvent or water) leaves behind a film of the SAM polymer. Liquid or solid polymers can be used with self assembling endgroups, optionally including or capable of binding biologically active or biomimetic species, in computer-controlled stereolithography—also know as three dimensional printing. This method is of particular use in the fabrication of dense or porous structures for use in applications, or as prototypes, for tissue engineering scaffolds, prostheses, medical devices, artificial organs, and other medical, consumer, and industrial end uses.

Optionally, the polymer melt or liquid system may include reinforcing particulate fillers or pore formers that may be solid, liquid, or gaseous. Solid and liquid pore formers may be removed after component fabrication by well-known methods including water, solvent, or super-critical fluid extraction, gaseous diffusion, evaporation etc., to create porous structures in which the surface-modified pores may be isolated, interconnected, or reticulated, depending on the initial loading and size of the incorporated pore formers. Such porous structures are useful as tissue engineering substrates, filters, prostheses, membranes, weight-reduced structures, and many other well-known uses of porous media. The above, and other, fabrication considerations are discussed in U.S. Pat. No. 5,589,563, the contents of which are hereby expressly incorporated by reference.

Often, surface-modifying endgroup moieties have little or no negative effect on processability. In fact, certain SAM-containing endgroups actually enhance processability of certain polymers that incorporate them by favorably impacting wetting and spreading by the base polymer on incorporated fillers, and on mandrels or polymeric, metallic, or nonmetallic substrates to be coated. SAM-containing polymers may also provide improved mold release properties, internal lubricity among adjacent polymer chains, increased smoothness of extrudates, and lower viscosity of polymers during thermoplastic, solution, and water-based processing. Out-gassing and surface finish during solvent casting, coalescence of water-based emulsions, adhesion to substrates, and so on may also be improved in SAM-containing polymers, as compared to their unmodified analogues.

In one embodiment, polymers are used that generally have tensile strengths of from about 100 to about 10,000 psi and elongations at break of from about 50 to about 1500%. Porous or non-porous films can be used in the form of flexible sheets or in the form of hollow membranes or fibers made by melt blowing, spinning, electrostatic spraying, or dipping, for example. Typically, such flexible sheets are prepared as long rollable sheets of about 10 to 15 inches in width and 1 to hundreds of feet in length. The thicknesses of these sheets may range from about 5 to about 100 microns. Thicknesses of from about 19 to 25 microns are particularly useful when the article to be manufactured is to be used without support or reinforcement.

When membranes can be fabricated from the polymers by knife-over-roll casting onto release paper, web, or a liner, for instance, a 24-foot-long 15-inch-wide continuous web coater equipped with forced-air ovens may be utilized. The coater may be modified for clean operation by fitting the air inlet ducts with High Efficiency Particulate Air filters. A nitrogen-purged coater box may be used to hold and dispense filtered polymer solutions or reactive prepolymer liquids. All but trace amounts of casting solvent (e.g., dimethylformamide) may be removed by the coater's hot air ovens fitted with NEPA filters. After membrane casting or another solvent-based fabrication method, the membrane and/or substrate may be further dried and/or extracted to reduce residual solvent content to less than about 100 ppm, for example. No significant loss of surface modifying moieties occurs during these post-fabrication purifications of SAM-containing polymers, because these moieties are covalently or ionically bonded to virtually every SAM-containing polymer molecule.

Polymer membranes may have any shape resulting from a process utilizing a liquid which is subsequently converted to a solid during or after fabrication, e.g., solutions, dispersion, 100% solids prepolymer liquids, polymer melts, etc. Converted shapes may also be further modified using methods such as die cutting, heat sealing, solvent or adhesive bonding, or any of a variety of other conventional fabrication methods.

In the case of thermoplastic surface-modifying endgroup moiety-containing polymers, thermoplastic fabrication methods may also be employed. Membrane polymers made by bulk or solvent-free polymerization method may be cast into, e.g., a Teflon-lined pan during the polymerization reaction. As the reaction proceeds and the polymerizing liquid becomes a rubbery solid, the pan may be post-cured in an oven, e.g. at 100-120.degree. C. for about an hour. Upon cooling, the solid mass may be chopped into granules and dried in a dehumidifying hopper dryer for, e.g., about 16 hours. The dry granules may then be compression molded, e.g., at about 175.degree. C., to form a fiat membrane which, when cool, will have a thickness of about 50 mm. Extrusion, injection molding, calendering, and other conversion methods that are well-known in the art may also be employed to form membranes, films, and coatings of the polymers configured into solid fibers, tubing, medical devices, and prostheses. As those skilled in the art will appreciate, these conversion methods may also be used for manufacturing components for non-medical product applications.

In one embodiment, the polymer bodies can include dense, microporous, or macroporous membrane components in implantable medical devices or prostheses or in non-implantable disposable or extracorporeal medical devices or diagnostic products. For example, in one embodiment, the polymer body may comprises a membrane component or coating containing immuno-reactants in a diagnostic device.

In one embodiment, the active agent may be complexed to the SAM endgroups and released through diffusion, or it may be complexed or bonded to SAM endgroups which are chosen to slowly degrade and release the drug over time. The surface endgroups of the polymers include surface-modifying endgroup moieties, provided that at least some of said covalently bonded surface-modifying endgroup moieties are other than alkylene ether-terminated poly(alkylene oxides). These latter medical devices or prostheses are excluded from the present invention to the extent that they are disclosed in U.S. Pat. No. 5,589,563.

In another embodiment a polymer body is provided, wherein the polymer body comprises a plurality of polymer molecules located internally within the body, at least some of which internal polymer molecules have endgroups that comprise a surface of the body. In this embodiment, the surface endgroups include at least one surface-modifying endgroup moiety, provided that at least some of said covalently bonded surface-modifying endgroup moieties are other than alkylene ether-terminated poly(alkylene oxides). In accordance with this embodiment, the surface of the polymer body has enhanced antimicrobial properties, reduced aerodynamic or hydrodynamic drag, enhanced resistance to encrustation by marine organisms, and/or enhanced ability to release marine organisms when moving through water (e.g., ship's coatings), stealth properties, enhanced resistance to attachment of ice and/or enhanced ability to release ice when moving through air or water (e.g., ship or aircraft coatings), enhanced resistance to oxidation, corrosion, damage by sunlight, water, or other environmental degradation of the underlying substrate (e.g., exterior or interior paints, treatments, and protective coatings), reduced or enhanced coefficient of friction, enhanced surface lubricity, enhanced surface adhesion or tack, enhanced ease of donning, enhanced wear properties, enhanced abrasive properties, enhanced or reduced static dissipation, enhanced or reduced energy absorption and/or energy conversion (e.g., in photovoltaic applications), or enhanced or reduced responsiveness to temperature, pH, electricity, or other stimuli.

The polymer can include a plurality of endgroups each comprising a chain capable of self assembling, and also contains one or more head groups that ultimately reside in the outermost monolayer of the polymer's surface are that are optionally used in a coupling reaction to bind other moieties. In this and other embodiments, branched, star, dendritic, columnar, tubular, and/or other multi-armed polymer structures are optional features of the polymer to be modified.

The self-assembling chains and/or the head groups of the endgroups include reactive sites for crosslinking the self-assembling chains to each other or to the base polymer, to minimize the ability of the modified-surface to restructure upon a change of environment, or when overcoated by an adsorbent. The latter is exemplified by, but not limited to, the use of an oleyl spacer chain between the polymer and the head group. This chain will self assemble in the surface in air and can subsequently be crosslinked by ultraviolet radiation, heat, or other means capable of inducing and/or catalyzing the reaction of double bonds. Once crosslinked, it is constrained from reorganizing, e.g., when immersed in an aqueous environment. Crosslinking, which may optionally include one or more additional reactants, initiators, inhibitors, or catalysts, immobilizes the self-assembled chains by joining them together with covalent chemical bonds or ionic bonds.

Before or after crosslinking the self-assembling spacer chains, the attached reactive head groups may be coupled to other optionally biologically-active moieties. A preferred approach for producing well-defined structures of this type is to use a different chemical reaction to crosslink the self-assembling spacer chains than the reaction used to couple active moieties to the head groups. A free radical or ionic reaction could, for instance, crosslink the spacer, preceding, following, or contemporaneously with a condensation reaction that couples an active moiety to the head group.

If the performance of the final surface in the intended application does not require a high level of coverage by the head groups, a mixture of head groups can be utilized in which some or all of the head groups take part in crosslinking reactions after self assembly of the spacer chains. For example, active hydrogen head groups could be reacted with appropriate polyfunctional crosslinkers. In another non-limiting example, acryloxy or methyacryloxy head groups may be linked together via free radical reactions, e.g., induced by heat or radiation (from UV or visible light, electron beam, gamma sources, etc.) in the presence of optional co-reactants. In still another examples, condensation reactions may be employed to crosslink the surface layer, for example by including silanes that give off a condensation by-products such as water, acid, or alcohol during or prior to the formation of crosslinks. Such reactions may be externally catalyzed or self-catalyzed. For instance, self catalysis may occur when the condensation by-product is acetic acid. In certain cases, including free radial crosslinking of endgroups, inert environments may be needed to facilitate the crosslinking reaction. For example, shielding the surface reactions from oxygen via an inert gas blanket may be required during free radical reactions, whereas exposure to water may be required to initiate certain condensation crosslinking reactions involving silanes with multiple acyloxy groups used as reactive head groups. In addition to these examples, other suitable crosslinking reactions and reaction conditions can be chosen from the technical literature.

These include a wide variety of well-known reactions commonly used for crosslinking polymer chains within the bulk of a formed article.

Crosslinking reactions may also be applied to the bulk polymer to be modified by the SAM-like SMEs. Crosslinking may be performed before, during, or after self assembly of the surface, to provide enhanced physical-mechanical properties, resistance to swelling, or any of the bulk property improvements associated with crosslinking that are well known to those skilled in the art. When the bulk polymer is t be crosslinked, it may be desirable to utilize spacer chains in the SME that do not crosslink, or which crosslink by a different mechanism. In this way, the bulk may be crosslinked before or after the surface spacer chains, without affecting the alignment or self-assembled structure of the spacer chains in the surface.

In another embodiment of the present invention, compositions for antimicrobial and/or antibacterial composition include, a substrate over which a non-leaching polymeric coating is covalently bonded. The polymeric coating contains a multitude of quaternary ammonium groups which exert activity against microbes, and also is absorptive of aqueous solutions.

In one embodiment of the present invention, a wound dressing is provided that includes an absorbent, non-leaching antimicrobial surface over a suitable dressing substrate. As a non-limiting example, the substrate can be cellulose, rayon, or other fibrous mesh, such as a gauze pad. In one embodiment, the wound dressing is non-leaching.

Various materials were investigated as substrates for the preparation of absorbent dressings containing covalently-bonded, polymeric quaternary ammonium biocidal agent. Among these materials were several commercially-available gauze and surgical sponge products, including several materials manufactured by Johnson & Johnson Company (J&J). J&J's, “NU GAUZE”, General use sponge (referred to in this application as “sub#1”), J&J's “STERILE GAUZE Mirasorb sponge” (herein referred to as “sub#4”), and J&J's “SOFT WICK” dressing sponge (herein referred to as “sub#5”) were all used to prepare working prototypes. All three materials are rayon/cellulose (sub #4 also contains polyester) sheets with non-woven mesh-like structures, and a fiber surface area much greater than traditional woven cotton-fiber gauze. Sub#1 and sub#4 are a single 8″.times.8″ sheet which is folded into a 4-layer sheet measuring 4″.times.4′, and both weigh approximately 1.45 to 1.50 grams per sheet. Sub#5 has a denser structure, and is made from a single 12″.times.8″ sheet folded into a 6-layer sheet measuring 4″.times.4′, weighing approximately 2.5 grams.

In addition, several types of fabric materials were also used as substrates, including: “Fruit of the Loom” 100% cotton knitted tee-shirt material, “Gerber” 100% cotton bird's-eye weave cloth diaper material, “Cannon” 100% cotton terry wash-cloth material, “Magna” yellow, non-woven wiping cloth (75% rayon, 25% polyester), and “Whirl” cellulose kitchen sponge”; referred to herein as: “subTS”, “subDIA”, “subWC”, “subMag”, and “subCKS” respectively. The scope of this invention is not limited to the use of materials mentioned herein as substrates.

Modification of these substrates to prepare absorbent materials with antimicrobial properties was achieved by immersing the substrates into aqueous solutions of vinyl monomers containing quaternary ammonium groups. Reaction of these monomers with the substrate materials to form graft polymers was catalyzed by ceric ion (Ce⁺⁴), Azo initiators, SPS, or peroxide. A typical modification procedure is detailed in Example 1. Other samples were prepared according to the same basic procedure; however, different substrates, monomers, reaction conditions, washing/drying procedures were used.

Additionally, another aspect of the present invention is the inclusion in a dressing of a hemostatic agent. Hemostatic compounds such as are known to those skilled in the art may be applied to the dressing, either by bonding or preferably added as a separate component that dissolves in blood or wound exudates, and acts to reduce or stop bleeding. In addition, the high positive charge density conferred on substrates due to the application of quaternary amine polymers according to this invention itself provides a surface which facilitates the coagulation cascade.

Finally, a substrate is defined as a woven or nonwoven, solid, or flexible mass of material upon which the polymers of the invention can be applied and with which such polymers can form covalent bonds. Cellulose products, such as the gauze and other flexible absorbent dressings described in the following paragraphs, are preferred materials to be used as flexible substrates when a wound dressing is prepared. The term “substrate” can also include the surfaces of large, generally non-flexible objects, such as cutting boards, food preparation tables and equipment, and surgical room equipment, and other large flexible or generally non-flexible objects such as a floor mats, a blood transfer storage containers, cast liners, splints, air filters for autos, planes or HVAC systems, military protective garments, face masks, devices for protection against biohazards and biological warfare agents, lumber, meat packaging materials, paper currency, powders including but not limited to mica, and other surfaces in need of a non-leaching antimicrobial property, and the like, onto which is applied the antimicrobial polymeric coating in accordance with the present invention. Apart from cellulose, any material (ceramic, metal, or polymer) with hydroxyl groups or available reactive carbons on its surface can be used as a substrate for the cerium (IV) and other initiator catalyzed grafting reactions described in the following paragraphs. The extent of grafting will be dependent on the surface hydroxyl concentration and the concentration of susceptible carbon atoms. Even materials which do not normally contain sufficient surface hydroxyl groups may be used as substrates, as many methods are available for introducing surface hydroxyl groups. These methods generally include hydrolysis or oxidation effected by methods such as heat, plasma-discharge, e-beam, UV, or gamma irradiation, peroxides, acids, ozonolysis, or other methods. It should be noted that methods other than cerium initiated grafting may also be used in the practice of the present invention.

Furthermore, in some embodiments of the present invention, antimicrobial applications of surface treated mica have wide applicability to cosmetics, in which mica is an almost universally included component, with or without titanium dioxide treatment. Inclusion of mica treated according the present disclosure provides a solution, for example, to the situation where a mascara applicator is used, returned to a reservoir bearing adherent microbes which, in the absence of the antimicrobial mica, proliferate in the reservoir. Such proliferation has given rise to increasing levels of concern in the industry and this invention provides a novel, significant and unexpected solution to this long felt need. In addition, the increased dye-binding affinity of substrates, including mica, treated according to the present invention, has applicability to the fabric and cosmetic arts.

The use of cerium(IV) salts as graft polymerization initiators is described above. These salts function by a redox mechanism involving complex formation between the metal ion and the hydroxyl groups on the cellulose substrate. It is known that other metal ions such as V(V), Cr(VI), and Mn(III) function in a similar manner (see P. Nayak and S. Lenka, “Redox Polymerization by Metal Ions”, J. Macromolecular Science, Reviews in Macromolecular Chemistry, C19(1), p 83-134 (1980).

Persulfate ion is a water-soluble initiator for vinyl polymerizations, but is not widely recognized as a catalyst for graft polymerizations. In one embodiment of the present invention, sodium persulfate (SPS) functions as a grafting catalyst much in the same manner as the cerium salts used in the parent application (see Examples 3-8, below). There is an advantage for materials prepared from this new catalyst vs. materials prepared using cerium salts, in that the finished materials prepared using SPS show zero discoloration. Samples prepared using cerium catalysts may show a slight off-white, or yellowish discoloration under certain conditions. For most consumer applications it is desirable to have a pure white product. It is possible that materials prepared using the cerium catalyst can contain a small amount of residual cerium, which might be undesirable in the finished product. This is not the case for the SPS system. The by-products of the SPS catalyst are simply sodium ion and sulfate ion, which are completely safe and nontoxic. In general, it is not desirable to have any heavy metal residues in finished medical devices, since some of the heavy metal catalysts described in the above paragraph are rather toxic (chromium, for instance), and could pose hazards for personnel involved in manufacturing, as well as pollution and environmental concerns. An additional benefit of the SPS catalyst is that polymerization may be carried out at room temperature, if desired (see example #4). The grafting reaction using SPS also appears to be quicker than the cerium salt catalyzed reaction. Significant grafting can be achieved in 30 minutes at 60.degree. C. (see example #5), and presumably even quicker at higher temperatures.

The use of peroxydiphosphate and peroxydisulfate as initiators for the graft polymerization of vinyl monomers (but not quaternary monomers) onto silk and wool fibers has been described (see M. Mishra, Graft Copolymerization of Vinyl Monomers onto Silk Fibers, J. Macromolecular Science, Reviews in Macromolecular Chemistry C19(2), p 193-220 (1980). These systems often rely on redox pairs formed by the oxidants (peroxydisulfate or peroxydiphosphate) with reductants such as lithium bromide, or silver nitrate, or are done in the presence of acids such as H₂SO₄. Again, the use of metals such as silver and lithium may lead to undesirable residues in the final products. The use of strong acids is unsuitable for the grafting of cellulose substrates due to severe substrate damage.

In one embodiment, microfibrillated oxycellulose is suitable for use as a carrier in agricultural, cosmetic, and topical and transdermal drug products, and as a binder and disintegrant in the making of tablets, prepared by the oxidation of cellulosic materials with persulfate salts in water, with or without the presence of an aqueous inorganic acid, or in glacial or aqueous acetic acid.

In one embodiment, other compounds are also capable of catalyzing the grafting of quaternary vinyl monomers onto cellulose. Hydrogen peroxide (HP) is an effective catalyst for this reaction (see Example 9). It is surprising that HP functions in this manner. Although peroxides are generally known to be capable of initiating vinyl polymerizations, it is also well known that oxygen interferes with these processes. Reaction of HP with organic materials liberates elemental oxygen, but this apparently did not prevent grafting. HP is rather useful in that it may be the cleanest catalyst available for preparing these types of graft copolymers. The by-products of HP-catalyzed copolymerization are simply water and oxygen.

The by-product of SPS-catalyzed copolymerization is sulfate ion. Sulfate ion is not toxic; however, it is conceivable that its presence in some systems may be undesirable. The HP-catalyzed materials are also very white, with zero discoloration.

Azo compounds such as AIBN (2,2′-azobisisobutyronitrile) are commonly used as initiators for vinyl polymerizations, but are not generally thought of as catalysts for preparation of graft copolymers. In one embodiment of the present invention, a water-soluble derivative of AlBN (2,2′-Azobis[N-(2-carboxyethyl)-2-methylpropionamidine]tetrahydrate, or VA-057, available from Wako Specialty Chemicals) is a suitable initiator for the graft polymerization of quaternary vinyl monomers onto cellulose (see Example 10). AIBN, which is one of the most commonly used polymerization initiators, is not soluble in water; and thus cannot be used directly in aqueous solutions, as can the various compounds described above. AIBN is soluble in alcohols, however, and thus can possibly be used as an initiator for the graft polymerization of quaternary monomers onto cellulose since the monomers are also soluble in alcohols. It is also likely that AIBN could be used in an emulsion system in order to achieve similar results. Other potentially useful Azo initiators include: (2,2′-Azobis[2-(5-methyl-2-imidazolin-2-yl)propane]di-hydrochloride, or VA-041; 2,2′-Azobis{2-methyl-N-[1,1-bis(hydroxymethyl)-2-hydroxyethyl]propionamide, or VA-080; 2,2′-Azobis(2-methylpropionamide)di-hydrochloride, or V-50; 2,2′-Azobis(N-cyclohexyl-2-methylpropionamide), or Vam-111; 1,1′-Azobis(cyclohexane-1-carbonitrile); all available from Wako Specialty Chemicals, Inc.; and numerous other similar compounds).

Organic peroxides such as benzoyl peroxide (BPO) are also widely used as polymerization initiators. Just as in the case of AIBN (above), BPO is not water soluble, but it can possibly be used in alcoholic solution in order to graft quaternary vinyl monomers onto cellulose. Other potentially useful peroxide initiators include: (dicumyl peroxide, t-butyl peroxide, methylethylketone peroxide, and a variety of other peroxides, peroxyketals, peroxydicarbonates, and hydroperoxides). These and numerous other potentially useful catalysts are available from a variety of suppliers such as Lucidol-Penwalt, and Akzo.

Combinations of two or more of the initiators described above are also effective (see Example 11). These catalysts can also be used to form crosslinked cellulose-quaternary grafted materials (see Example 12).

It should also be noted that the mechanism of action of quaternary compounds is directed towards the cell membrane of the target organism. This process has been described as a mechanical “stabbing” (on a molecular level) which causes rupture of the cell membrane. Thus, it is not possible for pathogenic organisms to develop resistance as observed for most antibiotics.

In another embodiment of the present invention, a wound dressing material is provided that is capable of controlled or sustained release of a drug, including but not limited to an antibiotic. It will be appreciated that the present invention is not limited to antimicrobials. A variety of other agents, including, for example, matrix metalloproteinase inhibitors, MMPI's, such as Ilomostat and its ionic derivatives, may be associated with and released from select polyionic substrates according to this disclosure. Likewise for vitamins, dyes, or other active chemicals such as fragrances. Accordingly, applications of this aspect of the invention are not limited to wound dressings, and include a wide range of applications as specified herein. It should further be noted that the controlled release function of substrates according to this aspect of the invention is in addition to the good antimicrobial properties of polyquaternary amine functionalized substrates as disclosed herein.

In another embodiment of the present invention, an appropriately polyionically derivatized substrate is provided as a device, and loaded with a drug, fragrance, or any of a wide variety of different ionic compounds at the point of sale or use by qualified personnel.

Many drugs are negatively charged (such as penicillin or vitamin C, as sodium ascorbate). These negatively charged drugs form an ionic bond with a polyquaternary amine derivatized substrate, and prevent them from being washed out quickly from the thus derivatized substrate following ionic interaction between the drug and the polycationic substrate. In comparison, simply coating or infusing a normal untreated substrate (such as cotton or rayon) with drug allows it to be more quickly leached or washed out from the substrate. Complexes formed between the polycationic substrate of this invention and different compounds will have different binding constants, and thus the rate of release will be different. This can be controlled by adjusting the amount of positive charge (graft level), by adjusting the level of drug loading, or by controlling other factors such as surface area or pH. The concept can be extended to positively charged drugs simply by using a negatively charged, i.e. polyanionically derivatized substrate. This is done by grafting acrylic acid monomer onto cellulose, for instance.

In addition to biologically active compounds which are classically considered to be “drugs”, compositions and methods according to an embodiment of the present invention can also bind and release more simple ionic compounds including but not limited to metal ions (calcium, zinc, silver, rubidium, etc.). Some of these ions are known to be important in wound healing (see, for example, U.S. Pat. No. 6,149,947, incorporated herein by reference. Alternatively, for example, hypochlorite ion may be associated with the derivatized substrate of in an embodiment of the present invention, and released as an antimicrobial, both for medical or non-medical applications. In yet other embodiments of the present invention, sodium pyrithione is used as a drug to treat fungal skin infections (athlete's foot and dandruff), thereby yielding clothing applications (e.g. socks, undershirts, underwear, derivatized with a polyquaternary ammonium loaded with antifungally effective amounts of sodium pyrithione), foot powder (powder, e.g. “talc” treated with the polyquaternary ammonium polymer according to this invention, and loaded with an antifungally effective amount of sodium pyrithione or another appropriate antifungal).

Ilomostat, other MMPIs, and other wound care agents may likewise be associated with and released from the polyionic substrate according to this invention. Both GM1489 molecule (which has a carboxylic acid rather than the hydroxamic acid at the N-terminus of Ilomastat), and the C-terminal carboxylic acid form of Ilomastat (rather than the N-methyl amide in Ilomastat) have a negative charge at physiological pH. Thus, both MMP inhibitors are expected to reversibly bind to a microbicidal utility substrate, much as do indicator dye molecules and negatively charged antibiotic molecules, as exemplified herein below. In one embodiment of the present invention, wound dressings provide sustained release of these potent MMPI molecules. GM1489 has Ki values for MMPs that are almost as good as Ilomastat, and while the Ki values for the C-terminal carboxylic form of Ilomastat are lower, it is still a very acceptable and potent MMPI.

In another embodiment, polycationic substrate provides sustained release of “PHI or polyhydrated ionogen” active ingredient in Greystone Medical's DerMax dressing. Likewise for proteins such as serine protease inhibitor, alpha-1 protease inhibitor and gelatin (denatured collagen) since these proteins exhibit negative charges at pH 7. Accordingly, per this disclosure, a substrate according to this invention charged with these biologically active compounds provides a dressing with the ability to inhibit MMPs and serine proteases, as is the case for Promogran dressing, except that such a dressing according to this invention would be expected to have better performance for ulcers and bed sores and other wounds caused or exacerbated by matrix metalloproteinases and serine proteinases, because it binds and releases over time inhibitors for both classes of proteases.

In another embodiment of the present invention, a gel, hydrogel, or SAP is utilized as a component of this aspect of the invention. As a non-limiting example SAP-polyquaternary ammonium derivatized substrate can be used. Grafted polyquaternary amine derivatized substrates are provided in one embodiment of the present invention, and can be simply coated, or otherwise immobilized polyquaternary amine treated substrates are likewise anticipated to operate according to the principles disclosed herein for grafted substrates.

In another embodiment of the present invention, interpenetrating networks (IPNs), or IPNs combined with covalent bonding, are utilized. Coatings are made from polyquat copolymers. As a non-limiting example, a copolymer of TMMC and MMA, soluble in alcohol, but insoluble in water, is permeable or swellable in water. Such a composition is applied from alcohol solution, and does not wash off in water even though it is not covalently bonded. Such a substrate is then charged with polyanionic compounds with desired chemical or biological activities for binding to and then sustained release from the substrate.

### Example 1

### Production of Absorbent Anti-Microbial Compounds

A commercially available surgical sponge rayon/cellulose gauze material (sub#4) was unfolded from its as-received state to give a single layer sheet measuring approximately 8″ by 8″. The sample was then refolded “accordion-style” to give a 6-layer sample measuring approximately 1.33″ by 8″. This was then folded in the same manner to give a 24-layer sample measuring approximately 1.33″ by 2″. This refolding was done so as to provide uniform and maximum surface contact between the substrate and reaction medium, in a small reaction vessel.

A solution was prepared by mixing 0.4 grams of ammonium cerium (IV) nitrate (CAN) (Acros Chemical Co. cat #201441000), 25.0 mL [2-(methacryloyloxy)ethyl]trimethylammonium chloride (TMMC) (Aldrich Chemical Company, cat#40, 810-7), and 55 mL of distilled water. This solution was placed into a 250 mL wide-mouth glass container equipped with a screw-cap lid, and argon gas was bubbled vigorously through the solution for 60 seconds. The folded gauze substrate was placed into the solution, and the solution was again sparged with argon for 30 seconds.

The container was capped while being flushed with a stream of argon gas. The container was placed into an oven set at 75.degree. C., and gently agitated by hand every 30 minutes for the first two hours, then every hour for the next 4 hours. After a total of 18 hours, the jar was removed from the oven and allowed to cool to room temperature. The sample was removed from the jar, unfolded, and thoroughly washed three times with water, being allowed to soak in water for at least 30 minutes between washings. These sequential washings, also termed rinsings, remove effectively all of the non-polymerized monomer molecules, non-stabilized polymer molecules, and catalyst, such that the final composition is found to not leach its antimicrobial molecules, by routine detection means known and used by those of ordinary skill in the art. By non-stabilized polymer molecules is meant any polymer molecule that has neither formed a covalent bond directly with a binding site of the substrate, nor formed at least one covalent bond with a polymer chain that is covalently bonded (directly or via other polymer chain(s)) to the substrate.

After these rinsings, excess water was removed from the sample by gently squeezing. Further dewatering was accomplished by soaking the sample in 70% isopropanol for 30 minutes. Excess alcohol was removed by gently squeezing the sample, which was then allowed to dry overnight on a paper towel in open air. The sample was then dried in vacuum at room temperature for 18 hours. The sample was allowed to stand in air for 15 minutes before being weighed.

The final weight of the sample was measured to be 2.13 grams. The initial weight of the sample before treatment was 1.45 grams. The percent of grafted polymer in the final product was calculated as follows: (2.13-1.45)/2.13.times.100=31.9%. Some disruption of the fiber packing of the mesh was observed, and this resulted in a “fluffier” texture for the treated material.

Preparations of additional samples were performed according to similar procedures using substrates, antimicrobials and reaction conditions. The reaction conditions and percent data for each sample are summarized in Table 1.

### Table 1

Table 1 reports on the ceric ion initiated grafting of gauze substrates [Monomer] Sample# Substrate Monomer (mol/L) [Ce+](mM) T (.degree. C.) Total Vol. % Grafting 1 #4 TMMC 1 11 75 80 mL 12% 2 #1 TMMC 1.2 14 75 80 mL 34% 3 #1 (.times.2) TMMC 1.2 14 75 80 mL 32% 4 #1 TMMC 1.2 9 75 80 mL 32% 5#1 (.times.2) TMMC 1.2 9 75 80 mL 20% 6 #1 TMMC 0.7 14 75 80 mL 28% 7 #1 (.times.2) TMMC 0.7 14 75 80 mL 27% 8 #1 TMMC 1 11 75 80 mL 37% 9 #1 TMMC 1 11 75 80 mL 37% 10 #1 TMAC 1.2 11 75 80 mL 25% 11 #1 TMAPMC 1.2 10 75 90 mL<1% 12 #1 TMAS 0.9 11 75 80 mL 20% 13 #1 DADMAC 1.4 10 75 90 mL 6% 14 #4 (.times.2) TMMC 1.3 15 90 60 mL degraded 15 #4 (.times.2) TMMC 0.5 11 90 85 mL 5% 16 #4 (.times.2) TMMC 0.7 15 90 60 mL 13% 17 #4 TMMC 0.7 15 90 60 mL 9% 18 #1 TMMC 1.3 15 90 60 mL degraded 19 #1 TMMC 0.7 15 90 60 mL 23% 20 #1 TMMC 0.4 15 90 60 mL 17% 21 #4 TMMC 1.3 15 90 60 mL 26% 22 #4 TMMC 0.7 8 75 60 mL 7% 23 #1 TMMC 2 20 75 60 mL 30% 24 #1 TMMC 2 5 75 60 mL<1% 25 #1 TMMC 0.7 20 75 60 mL 25% 26 #1 TMMC 0.7 7 75 60 mL 15% 27 #1 TMAS 0.4 7 60 200 mL 14% 28 #1 TMAS 0.2 2 60 200 mL 11% 29 #1 TMAS 0.8 10 60 200 mL 19% 30 #1 TMMC 1 11 50 80 mL 44% 31 #5 TMMC 1 11 50 80 mL 48% 32 #5 TMMC 1 11 50 80 mL 48% 33 #5 VBTAC 0.7 78 60 35 mL 15% 34 #5 DADMAC 2 60 60 60 mL 7% 35 #5 VBTAC 0.4 50 60 37 mL 20% 36 DIA TMMC 0.8 11 50 150 mL 12% 37 WC TMMC 1 18 65 200 mL 22% 38 MAG TMMC 1 18 65 100 mL 39% 39 CKS TMMC 0.8 11 60 150 mL 11% 40 TS TMMC 1 15 50 150 17% 41 #5 TMMC/0.7 15 60 122 mL 64% SR344 2.00% 42 #5 TMMC/0.4 15 60 224 mL 79% SR344 2.00% 43 #5 TMMC 0.9 10 75 85 mL 18% 30 min. 44 #5 TMMC 0.9 10 80 85 mL 21% 15 min. 45 #5(.times.2) TMMC 0.9 10 55 170 mL 32% 2 hours NOTES for Table 1: TMMC=[2-(Methacryloyloxy)ethyl]trimethylammonium chloride (75% solution in water) Aldrich Chemical #40, 810-7 TMAS=[2-(Acryloyloxy)ethyl]trimethylammonium methyl sulfate (80% solution in water) Aldrich Chemical #40, 811-5 TMAC=[2-(Acryloyloxy)ethyl]trimethylammonium chloride (80% solution in water) Aldrich Chemical #49, 614-6 TMAPMC=[3-(Methacryloylamino)propyl]trimethylammonium chloride (50% solution in water) Aldrich Chemical #28, 065-8 VBTAC=vinylbenzyltrimethylammonium chloride Acros Chemical #42256 DADMAC=diallyldimethylammonium chloride (65% solution in water) Aldrich Chemical #34, 827-9 SR344=poly(ethylene glycol)diacrylate Sartomer Company # SR344

All procedures were performed in 500 mL or 250 mL screw-cap glass jars overnight (approximately 18 hours), except for samples #43-45 which were reacted for indicated times.

The samples prepared, as shown in Table 1, indicated that high-yield grafting of vinyl monomers containing quaternary ammonium groups onto various textile substrate materials can be achieved under rather mild conditions. The appearance of the prepared biocidal absorbent dressings generally was identical to that of the starting material. Parameters such as mechanical strength, color, softness, and texture were found to be sufficient and acceptable for use in the various applications mentioned above. For instance, the materials based on medical dressings were soft, white, odorless, and absorbent. Storage of these materials for several months yielded no observable physical changes. The same holds true for heat treatments of 75.degree. C. for several hours (this is not meant to be a limiting condition).

It should be noted that although these examples demonstrate modification of textile fabrics already in finished form, the present invention can achieve the grafting modification at the raw materials stage. Threads, yams, filaments, lints, pulps, as well as other raw forms may be modified and then fabricated into useful materials or fabrics (woven or nonwoven) by weaving, knitting, spinning, or other forming methods such as, spun-bonding, melt blowing, laminations thereof, hydroentanglement, wet or dry forming and bonding, and the like.

Grafting yields were found to be reproducible with constant formulation and reaction conditions. Samples were thoroughly washed to remove any residues such as unreacted monomer or homopolymer. Degree of grafting was calculated based on the weight of the starting material and the final dried weight of the grafted material. The calculated values of percent grafting are subject to a certain degree of error based upon the fact that the materials appear to contain a small amount of adsorbed water due to exposure to the laboratory atmosphere. This is true even for the untreated starting materials which were generally found to show a reversible weight loss of approximately 5 to 7% after being dried in a 60.degree. C. oven for 30 minutes. Another potential source of error is the possibility of the presence of other counterions besides chloride (bromide, or nitrate, for instance).

Experiments were conducted to correlate the weight of treated samples after washing with excess salt solutions of various composition. Related to this is the well-known observation that quaternary ammonium compounds strongly bind sodium fluorescein dye to form a colored complex. Various samples from Table 1 were tested by immersing them in a concentrated (5%) solution of sodium flourescein, followed by drying, and then thorough washing in water. Untreated fabrics did not retain any color after this treatment. However, all treated materials showed a pronounced color which ranged from light orange to dark brown, depending on the quaternary ammonium content. In one case (a sample identical to that of Sample #31), the fluorescein treated sample showed a weight gain of 27%.

Further analysis on this sample for % nitrogen and % chloride was conducted by an independent laboratory (Galbraith Laboratories, Inc., Knoxyille, Term.). The results (2.62% N and 6.83% CI) indicate a slightly lower level than as calculated gravimetrically. This is likely due to the reasons described above. An exact control of % grafting is not a requirement of this invention. As described in the testing presented below, the antimicrobial activity of these materials is functional over a wide range of compositions.

The materials described by Samples #1 through #40 are graft copolymers in which the quaternary ammonium polymeric grafts have a linear structure. These highly charged linear chains would be water-soluble if they were not tethered at one end to a cellulose substrate. Thus, the materials are capable of absorbing and holding water. Selected materials were tested for their ability to absorb and retain water. For instance, a 2.22 gram sample of the material of Sample #2 was found to retain 12.68 times its own weight of water when placed in a funnel and completely saturated.

Samples #41 and #42 were found to retain water at 38 and 66 times their own weight, respectively. These two samples were prepared using a combination of monofunctional quaternary monomer, and a difunctional non-quaternary cross linking agent. The cross linking agent causes the grafted polymer chains to become branched, and also allows individual chains to form chemical bonds with each other that result in network formation. Once swollen with water, the polymer network becomes a slippery gel material. The absorbent biocidal materials produced with and without cross linking agent have similar chemical and antimicrobial properties. Although the materials prepared using cross linking agents have extremely high absorbing capacity, they do tend to become rather slippery when wet.

This slippery property may be undesirable in some applications, particularly where this is the exposed surface. However, the two different variations may be utilized in conjunction with each other. For instance, the material of Sample #35 may be used as a shell or barrier material around the material of Sample #42. This would result in a bandage material having a superabsorbent compound interiorly to provide absorptive capacity, having inherent antimicrobial properties throughout, and having superior antimicrobial properties on the exterior (where a polymer having antimicrobial properties that are demonstrated superior to a polymer with superabsorptive capacity is employed in the outer location).

### Example 2

### Testing of Antimicrobial Activity

All biological testing was performed by an independent testing laboratory (Biological Consulting Services of North Florida, Incorporated, Gainesville, Fla.). The first set of antimicrobial activity tests was performed using the absorbent antimicrobial material of Sample #21. The grafting yield for this sample was 26%. An untreated, unwashed sample of as-received sub#1 was used as a control. A sample of sub#1 treated with a siloxane based quaternary formulation (TMS, or 3-(trimethoxysilyl)-propyloctadecyldimethyl ammonium chloride) was also tested (sample #1122F). This sample contained approximately 9% quaternary siloxane which was applied from methanol solution. Based on a series of experiments with this quaternary siloxane, this is the maximum level which could be successfully applied to the substrate material. It was later found that the applied siloxane quaternary treatment was unstable, as evidenced by significant weight loss after washing the treated material after 30 days storage. This level is also higher than is typically achieved in antimicrobial treatments of similar substrates using commercial TMS products. It should also be noted that there were difficulties during the testing due to the hydrophobic (water-repellent) nature of the siloxane-treated material. Such properties are not desirable in a product designed specifically to be highly absorbent.

In a modification of the AATCC-100 antimicrobial test protocol, gauze material from these three samples was aseptically cut into squares weighing 0.1.+−.0.05 grams. This corresponds to a 1′.times.1″ four-layer section. Each square was then individually placed in a sterile 15-mm petri dish and covered. One-milliliter tryptic soy broth suspension containing 10⁶-cfu/ml mid-log phase E. coli (ATCC 15597) or S. aureus (ATCC 12600) was added to each gauze section. The plates were then incubated overnight at 37.degree. C. Following incubation, the material was aseptically placed into 50-mL conical centrifuge tubes. Twenty-five milliliters of sterile phosphate buffered saline was then added to each tube. The tubes were shaken on a rotary shaker (Red Rotor PR70/75, Hoofer Scientific, CA) for 30 minutes. The eluant was then diluted accordingly and enumerated by aseptically spread plating onto Tryptic Soy Agar (TSA) plates. The plates were incubated overnight at 37.degree. C. All gauze samples were processed in triplicates. The results of this testing are summarized in Table 2.

### Table 2

Table 2 presents the results of antimicrobial activity testing. cfu/mL Sample Staphylococcus aureus Escherichia coli Sub#4 (control) 1.3.times.10⁶ 6.1.times.10⁶ 4.6.times.10⁵ 2.4.times.10⁶ 8.0.times.10⁵ 1.5.times.10⁶ Material of Sample #21<10<10<10<10<10<10 TMS siloxane Material<10 1.4.times.10⁴ 20 2.3.times.10⁴ 170 4.3.times.10⁴

The results indicate that the material of Sample #21 was able to kill greater than 99.999% of both organisms. The siloxane-based quaternary ammonium sample (DC5700) was fairly effective on S. aureus, but only slightly effective on E. coli.

Further testing was carried out using the materials of Sample #9. A freshly-prepared sample of sub#1 treated with TMS siloxane quaternary ammonium (8%) was also tested, along with a washed untreated sub#1 control. Freshly-prepared bacterial cultures containing additional TSB growth medium were used. The samples were treated as before. In addition, a second set of samples was reinoculated with additional bacterial culture after the first day of incubation, and allowed to incubate for an additional day. Data from these experiments is presented in Tables 3 and 4.

### Table 3

Table 3 reports on the colony forming units (cfu) of 4 layer gauze strips cut into one inch' sections following inoculation with bacteria and overnight incubation. cfu/mL Sample Staphylococcus aureus Escherichia coli (Control) 5.2.times.10⁷ 8.7.times.10⁷ (Sub#1 washed) 2.1.times.10⁷ 4.6.times.10⁷ 9.4.times.10⁷ 5.4.times.10⁷ TMS siloxane quat 1.2.times.10⁶ 8.8.times.10⁶ (8% on Sub#1) 9.1.times.10⁶ 1.3.times.10⁷ 5.9.times.10⁶ 7.0.times.10⁶ Material of Sample #9) 8.9.times.10¹ 6.6.times.10¹ (37% TMMC on sub#1) 3.7.times.10¹ 3.6.times.10¹ 3.3.times.10¹ 9.0.times.10⁰

### Table 4

Table 4 reports on the colony forming units (cfu) of 0.1-gram gauze strips following inoculation with the indicated bacteria, overnight incubation, re-inoculation, and overnight incubation. cfu/mL Sample Staphylococcus aureus Escherichia coli (Control) 5.6.times.10⁸ 3.9.times.10⁸ (Sub#1 washed) 2.6.times.10⁸ 3.8.times.10⁸ 4.2.times.10⁸ 1.9.times.10⁸ TMS siloxane quat 2.1.times.10⁶ 2.2.times.10⁸ (8% on Sub#1) 1.8.times.10⁶ 1.8.times.10⁸ 8.0.times.10⁵ 2.7.times.10⁸ Material of Sample #9 3.4.times.10¹ 6.7.times.10² (37% TMMC on sub#1) 3.8.times.10² 7.2.times.10¹ 9.1.times.10¹ 5.9.times.10¹

The siloxane-based quaternary ammonium did not show significant antibacterial activity, whereas the TMMC-grafted material did.

In another experiment, the antimicrobial effectiveness of several materials was tested in the presence of a high concentration of bodily fluids, as expected to occur in a heavily draining wound, for instance. The procedure was similar to that described above, except that the bacterial levels were higher (10⁸ cfu/mL), and the inoculation mixture contained 50/50 newborn calf serum and TSB. The samples tested in this experiment were those of Samples #30 and 31. In addition, a sample of siloxane quaternary ammonium-treated knitted cotton material was obtained from a commercial supplier (Aegis). The results are presented in Table 5.

### Table 5

Table 5 reports the testing of biocidal absorbent materials in presence of 50% calf blood serum cfu/mL Sample Staphylococcus aureus Escherichia coli Control 5.9.times.10⁷ 2.7.times.10⁷ “Sub#5” 6.3.times.10⁷ 1.9.times.10⁷ J&J gauze 7.1.times.10⁷ 9.8.times.10⁶ Siloxane quat on 1.8.times.10⁷ 1.2.times.10⁶ Cotton fabric 3.5.times.10⁷ 9.5.times.10⁵ 1.5.times.10⁷ 7.0.times.10⁶ Material of Sample 30 1.0.times.10⁴<1.0.times.10⁰ TMMC quat 1.2.times.10⁴ 5.0.times.10⁰.about.44% graft 9.7.times.10³<1.0.times.10⁰ Material of Sample 31 2.4.times.10⁴ 3.9.times.10² TMMC quat 3.2.times.10⁴ 6.0.times.10⁰.about.48% graft 1.2.times.10⁵ 1.0.times.10⁰

As can be seen from the data in Table 5, the siloxane based quaternary treated material showed almost zero effectiveness. The TMMC-grafted material was extremely effective against e-coli, even in the presence of high concentrations of bodily fluids. The high serum protein concentration appeared to mask the effectiveness of the TMMC-grafted material to some extent; however, the levels of serum which were used in this experiment were quite challenging. Generally, in these types of experiments much lower serum levels are used (10 to 20%).

In one embodiment the present invention provides an absorbent antimicrobial material which does not leach or elute any soluble antimicrobial agent. In order to verify this, material of sample #31 (Table 1) was extraction tested under a range of pH conditions, and also in the presence of blood serum. In addition, a commercially available antimicrobial dressing was also tested under identical conditions. The commercially available antimicrobial dressing is “Kerlix-A.M.D. Antimicrobial Super Sponges”, manufactured by Kendall Tyco Healthcare Group (active ingredient 0.2% Polyhexamethylene Biguanide).

The following procedure was used: Approximately, a one square inch section of each bandage material was placed in a 50-mL sterile polypropylene tube. Twenty-five milliliters of phosphate buffered saline at pH 5.0, pH 7.0, pH 7.0 supplemented with 10% fetal bovine serum (FBS), or pH 9.0 was added to each tube. Each sample was processed in triplicates to assure reproducibility. pH values were adjusted using 0.1 N NaOH or HCl. The tubes ware then placed on a rotary shaker (Red Rotor PR70/75, Hoofer Scientific, CA) for and agitated mildly (40 rotations/min) for 16 hours. Tryptic Soy Agar (TSA) (Difco Laboratory, Detroit, Mich.) petri dishes were inoculated with a continuous lawn of either E. coli (ATCC 15597) or S. aureus (ATCC 12600) and the plates were divided into four sections. Twenty microliters of the soaked gauze aqueous extract was then placed onto the labeled sections of the bacteria inoculated plates. The plates were then covered and incubated at 37.degree. C. for 18 hours. The plates were then visibly inspected for growth suppression at areas of inoculation. The results are presented in Table 6.

### Table 6

Table 6 reports the anti-microbial release test of supplied gauze material after soaking in Phosphate buffered saline (PBS) for 16 hours at various pH values Effect of Gauze Extract on Bacterial Growth Sample Staphylococcus aureus Escherichia coli pH 5.0 No Inhibition No Inhibition Material of Sample #31 No Inhibition No Inhibition No Inhibition No Inhibition pH 7.0 No Inhibition No Inhibition Material of Sample #31 No Inhibition No Inhibition No Inhibition No Inhibition PH 7.0 No Inhibition No Inhibition Material of Sample #31 No Inhibition No Inhibition with 10% FBS No Inhibition No Inhibition PH 9.0 No Inhibition No Inhibition Material of Sample #31 No Inhibition No Inhibition No Inhibition No Inhibition PH 5.0 Inhibition No Inhibition (Kerlix AMD) Inhibition No Inhibition No Inhibition PH 7.0 Inhibition No Inhibition (Kerlix AMD) Inhibition No Inhibition No Inhibition PH 7.0 Inhibition No Inhibition With 10% FBS Inhibition No Inhibition (Kerlix AMD) Inhibition No Inhibition PH 9.0 Inhibition No Inhibition (Kerlix AMD) Inhibition No Inhibition No Inhibition.

As seen from the results listed in Table 6, the material of sample #31 did not leach or release any antimicrobial agent under any of the conditions tested; however, the commercial antimicrobial dressing, Kerlix AMD, was found to release antimicrobial agent toxic to S. aureus under all testing conditions. Such leaching of active agent may have an undesirable effect on wound healing, and also cause decreased antimicrobial effectiveness of the dressing.

Further antimicrobial testing was performed in the presence of 10% blood serum using additional organisms as described below. These included a number of common pathogenic bacteria, as well as at least one fungal species. The material of Sample #32 was tested, and untreated sub#5 was used as a control. The gauze material was aseptically cut into approximately one inch square sections. Sub#5 gauze sample consisted of material in four layers and the material of Sample #32 consisted of two layers. Both types of samples weighed approximately 0.1 gram.

Each sample section was individually placed in a sterile 100.times.15-mm petri dish and covered. Escherichia coli (ATCC 15597), Staphylococcus aureus (ATCC 12600), Klebsiella pneumoniae (ATCC 13883), Pseudomonas aeruginosa (ATCC 51447), Proteus vulgaris (ATCC 13115), Serratia marcescens (ATCC13880), Enterococcus faecalis (ATCC 19433), and Enterobacter aerogenes (ATCC 13048) were grown in twenty five milliliters of tryptic soy broth (TSB) (Difco Laboratory, Detroit, Mich.) for 16 hours at 37.degree. C. Each bacterial culture was then diluted in Fresh TSB or PBS containing 10% Fetal Bovine Serum (Sigma, St. Louis, Mo.) to a final concentration of approximately 10⁶-cfu/mL. One milliliter of each bacterial suspension was added to each gauze section. Each section was inoculated with only one bacterial species.

All gauze samples were inoculated in triplicates. The petri dish containing the inoculated sample was then incubated for 18 hours at 37.degree. C. in 95% humidity. Following incubation, the gauze material was aseptically placed into 50-mL conical centrifuge tubes. Twenty-five milliliters of sterile phosphate buffered saline (PBS) was then added to each tube. The tubes were shaken on a rotary shaker (Red Rotor PR70/75, Hoofer Scientific, CA) for 30 minutes. The eluant was then serially diluted. Tenfold dilutions were performed by the addition of 0.3-ML of sample to 2.7-mL of sterile PBS. Aliquots of each dilution or of the original undiluted sample were then aseptically spread plated onto Tryptic Soy Agar (TSA) (Difco Laboratory, Detroit, Mich.) plates. The plates were incubated for 18 hours at 37.degree. C.

The colonies on the respective plates were counted and concentrations were determined. The fungus Candida albicans was used in the same procedure outlined above, except incubation times were doubled and Sabouraud Dextrose Broth and agar (Difco Laboratory, Detroit, Mich.) were used instead of TSB and TSA, respectively. The results are summarized in Table 7. The reported bacterial levels are diluted by a factor of 25.times. versus the level present in the actual gauze samples.

### Table 7

Table 7 reports on the antimicrobial activity results for various organisms. Sample Organism Sub 5*(control) Material of Sample 32 S. aureus 5.9.times.10⁶<2.0.times.10⁰ S. aureus 6.3.times.10⁷<2.0.times.10⁰ S. aureus 7.1.times.10⁷<2.0.times, 10⁰ E. coli 1.7.times.10⁶<2.0.times.10⁰ E. coli 1.9.times.10⁶<2.0.times.10⁰ E. coli 2.4.times.10⁶<2.0.times.10⁰ K. pneumoniae 1.8.times.10⁶<2.0.times.10⁰ K. pneumoniae 1.4.times.10⁶<2.0.times.10⁰ K. pneumoniae 3.7.times.10⁶<2.0.times.10⁰ P. aeruginosa 2.1.times.10⁷<2.0.times.10⁰ P. aeruginosa 3.9.times.10⁷<2.0.times.10⁰ P. aeruginosa 4.3.times.10⁷<2.0.times.10⁰ P. vulgaris 2.8.times.10⁶<2.0.times.10⁰ P. vulgaris 1.1.times.10⁷<2.0.times.10⁰ P. vulgaris 3.7.times.10⁶<2.0.times.10⁰ S. marcescens 6.7.times.10⁷<2.0.times.10⁰ S. marcescens 7.3.times.10⁷<2.0.times.10⁰ S. marcescens 8.7.times.10⁷<2.0.times.10⁰ E. faecalis 3.8.times.10⁶<2.0.times.10⁰ E. faecalis 1.7.times.10⁶<2.0.times.10⁰ E. faecalis 2.9.times.10⁶<2.0.times.10⁰ E. aerogenes 1.1.times.10⁷<2.0.times.10⁰ E. aerogenes 3.3.times.10⁷<2.0.times.10⁰ E. aerogenes 2.9.times.10⁷<2.0.times.10⁰ C. albicans 5.9.times.10⁵ 2.0.times.10⁰ C. albicans 7.2.times.10⁵ 4.0.times.10⁰ C. albicans 1.2.times.10⁶ 5.0.times.10⁰*values represent cfu/mL of the 25-mL PBS solution used to elute the microorganisms from the gauze sections.

The results presented in Table 7 indicate significant antimicrobial activity for the TMMC-grafted material against a variety of organisms. Further testing of this material was conducted using several bacteriophages. Bacteriophages are viral organisms which infect a particular bacterial host. In this method, the antimicrobial material is inoculated with the viral agent and then allowed to incubate for a specified period. The amount of viable viral organism is then determined on the basis of remaining ability to infect the host bacteria. Samples were aseptically cut into approximately one inch² square sections. Sub#5 gauze sample consisted of material in four layers and the material of Sample #32 consisted of material in two layers.

Each sample weighed approximately 0.1 g. Each sample section was individually placed in a sterile 100.times.15-mm petri dish and covered. Stocks of the following bacteriophages, MS2 (ATCC 15597-B1), .phi.X-174 (ATCC 13706-B1), and PRD-1 were added to 10 mL of TSB or PBS containing 10% Fetal Bovine Serum (Sigma, St. Louis, Mo.) to a final concentration of approximately 10⁶-cfu/mL. One milliliter of each bacterial suspension was added to each gauze section. All gauze samples were inoculated in triplicates. The petri dish containing the inoculated sample was then incubated for 18 hours at 37.degree. C. in 100% humidity. Following incubation, the gauze material was aseptically placed into 50-mL conical centrifuge tubes. Twenty-five milliliters of sterile phosphate buffered saline (PBS) was then added to each tube. The tubes were shaken on a rotary shaker (Red Rotor PR70/75, Hoofer Scientific, CA) for 30 minutes. The eluant was then serially diluted. Tenfold dilutions were performed by the addition of 0.3-ML of sample to 2.7-mL of sterile PBS. Phages were assayed as plaque-forming units (pfu) using their respective hosts (MS2 (ATCC 15597-B1), Escherichia coli C-3000 (ATCC 15597); .phi.X-174 (ATCC 13706-B1), E. coli (ATCC 13706); and PRD-1, Salmonella typhimurium (ATCC 19585)). The soft-agar overlay method (Snustad, S. A. and D. S. Dean, 1971, “Genetic Experiments with Bacterial Viruses”. W. H. Freeman and Co., San Francisco) was used for enumerating the phages. The results are presented in Table 8.

### Table 8

Table 8 reports on the testing of absorbent antimicrobial material against viral agents. Sample Bacteriophage Sub #5 (control)*Material of Sample #32 MS-2 3.3.times.10⁴<2.0.times.10⁰ MS-2 4.1.times.10⁴<2.0.times.10⁰ MS-2 2.3.times.10⁴<2.0.times.10⁰ PRD1 1.7.times.10⁵ 1.2.times.10² PRD1 7.9.times.10⁴ 1.5.times.10² PRD1 8.8.times.10⁴ 1.7.times.10².phi.X-174 8.7.times.10³ 2.4.times.10³.phi.X-174 1.2.times.10⁴ 1.1.times.10³.phi.X-174 9.0.times.10³ 1.7.times.10³*values represent pfu/mL of the 25-mL PBS solution used to elute the microorganisms from the gauze sections.

As seen from the results in Table 8, the absorbent antimicrobial material has significant effectiveness against viral pathogens, as evidenced by reduction or loss of bacteriophage activity in the treated sample #32. These results, in combination with the results regarding bacterial and fungal organisms, indicate a relatively broad antimicrobial potential for compositions of the invention.

In additional testing, several absorbent antimicrobial dressing materials not based on acrylate materials were studied. These tests included the materials of Samples #33, with VBTAC, and #34, with DADMAC. The material was aseptically cut into two layer square sections of approximately one inch². Each square was individually placed in a sterile 100.times.15-mm petri dish and covered. E. coli (ATCC 15597) and S. aureus (ATCC 12600) were grown in twenty five milliliters of tryptic soy broth (TSB) (Difco Laboratory, Detroit, Mich.) for 16 hours at 37.degree. C. Each bacterial culture was then diluted in Fresh TSB or PBS containing 10% Fetal Bovine Serum (Sigma, St. Louis, Mo.) to a final concentration of approximately 10⁵-cfu/mL. One milliliter of each bacterial suspension was added to each gauze section.

Each section was inoculated with only one bacterial species. All gauze samples were inoculated in triplicates. The petri dish containing the inoculated sample was then incubated for 16 hours at 37.degree. C. in 95% humidity. Following incubation, the gauze material was aseptically placed into 50-mL conical centrifuge tubes. Twenty-five milliliters of sterile phosphate buffered saline (PBS) was then added to each tube. The tubes were shaken on a rotary shaker (Red Rotor PR70/75, Hoofer Scientific, CA) for 30 minutes. The eluant was then serially diluted. Tenfold dilutions were performed by the addition of 0.3-ML of sample to 2.7-mL of sterile PBS. Aliquots of each dilution or of the original undiluted sample were then aseptically spread plated onto Tryptic Soy Agar (TSA) (Difco Laboratory, Detroit, Mich.) plates. The plates were incubated for 18 hours at 37.degree. C. The colonies on the respective plates were counted and concentrations were determined. The results are summarized in Table 9.

### Table 9

Table 9 reports on the colony forming units (cfu) present in the PBS eluant (25-mL) of the indicated gauze sections (1-inch²) following their inoculation with bacteria and overnight incubation: cfu/mL of the PBS eluant Sample Staphylococcus aureus Escherichia coli SUB 5 7.6.times.10⁶ 1.6.times.10⁷ (CONTROL) 6.9.times.10⁶ 2.9.times.10⁷ 5.8.times.10⁶ 1.3.times.10⁷ Material of Sample #33<1.0.times.10⁰<1.0.times.10⁰ 15% VBTAC graft<1.0.times.10⁰<1.0.times.10⁰<1.0.times.10⁰<1.0.times.10⁰ Material of Sample #34 3.0.times.10⁰<1.0.times.10⁰ 7% DADMAC graft 4.0.times.10⁰<1.0.times.10⁰<1.0.times.10⁰<1.0.times.10⁰

As shown in the table, the material with grafted quaternary ammonium polymer showed significant antimicrobial activity, even in the presence of 10% blood serum. Additional verification of the nonleaching nature of the subject materials was obtained by Kirby-Bauer zone of inhibition tests. Sample #32 was used in this experiment, along with a control of substrate #5. The following procedure was used: Material was aseptically cut into: 0.5.times.0.5 cm square sections, 0.2.times.2.0 cm strips, and 1.0.times.6.0 strips. All material was used in one-layer sections. Escherichia coli (ATCC 15597), and Staphylococcus aureus (ATCC 12600) were grown in five milliliters of tryptic soy broth (TSB) (Difco Laboratory, Detroit, Mich.) for 5 hours at 37.degree. C. 0.5-mL of either bacterial culture was then added to molten (45.degree. C.) sterile Tryptic Soy Agar (TSA) (Difco Laboratory, Detroit, Mich.). The mixture was then swirled and poured into a 15.times.100-mm petri dish. The gauze material was then aseptically placed onto the surface of the agar and the agar was allowed to solidify. The petri dish containing the sample was then incubated for 18 hours at 37.degree. C. in 95% humidity. Zones of bacterial growth inhibition were then measured. Results are shown in Table 10.

### Table 10

Table 10 reports the results of zone of inhibition testing of Sample #32 Zone of inhibition around sample (mm) Sample/section size S. aureus E. coli SUB 5/1.5.times.1.5<0.1<0.1 SUB 5/2.0.times.2.0<0.1<0.1 SUB 5/1.0.times.5.0<0.1<0.1 Sample #32/1.5.times.1.5<0.1<0.1 Sample #32/2.0.times.2.0<0.1<0.1 Sample #32/1.0.times.5.0<0.1<0.1

As shown in Table 10, no measurable zone of inhibition was observed around either the control or treated samples.

A study was conducted to determine the speed of antimicrobial action for the subject materials. Material similar in composition to sample #33 (code #0712A) was used in this study, along with an untreated control (substrate #5). The following procedure was employed. Material was aseptically cut into approximately one inch square sections. 0712A gauze sample consisted of material in two layers, and SUB-5 samples were in 3 layers. Each sample section was individually placed in a sterile 100.times.15-mm petri dish and covered. Staphylococcus aureus (ATCC 12600) was grown in twenty-five milliliters of tryptic soy broth (TSB) (Difco Laboratory, Detroit, Mich.) for 6 hours at 37.degree. C. The bacterial culture was then diluted in Fresh 1% TSB or 1.times.PBS containing 10% Fetal Bovine Serum (Sigma, St. Louis, Mo.) to a final concentration of approximately 10⁶-cfu/mL. One half (0.5) milliliter of the bacterial suspension was added to each gauze section. All gauze samples were inoculated in duplicates. The petri dish containing the inoculated sample was then incubated for the indicated time points at 37.degree. C. in 95% humidity.

Following incubation, the gauze material was aseptically placed into 50-mL conical centrifuge tubes. Twenty-five milliliters of sterile phosphate buffered saline (PBS) was then added to each tube. The tubes were shaken on a rotary shaker (Red Rotor PR70/75, Hoofer Scientific, CA) for 10 minutes. The eluant was then serially diluted. Tenfold dilutions were performed by the addition of 0.3-ML of sample to 2.7-mL of sterile PBS. Aliquots of each dilution or of the original undiluted sample were then aseptically spread plated in duplicates onto Tryptic Soy Agar (TSA) (Difco Laboratory, Detroit, Mich.) plates. The plates were incubated for 18 hours at 37.degree. C. The colonies on the respective plates were counted and concentrations were determined. Results of this rate study are presented in Table 11.

### Table 11

Table 11 reports the effect of 0712A and Sub 5 gauze material on the inactivation of Staphylococcus aureus at different exposure times. Sample (and respective bacterial count at specified times) Time Sub 5 0712A 1 minute 1.5.times.10⁵ 3.0.times.10² 1.9.times.10⁵ 3.1.times.10² 10 minutes 1.3.times.10⁵ 2.0.times.10² 2.5.times.10⁵ 8.0.times.10¹ 20 minutes 1.5.times.10⁵ 8.0.times.10¹ 2.3.times.10⁵ 1.2.times.10² 30 minutes 1.6.times.10⁵ 1.1.times.10¹ 2.8.times.10⁵ 2.1.times.10¹ 60 minutes 1.9.times.10⁵ 1.2.times.10¹ 2.1.times.10⁵ 1.9.times.10¹ 4 hours 3.3.times.10⁵ 3.times.10⁰ 2.5.times.10⁵ 1.2.times.10¹ 8 hours 4.0.times.10⁶<2.0.times.10⁰ 4.8.times.10⁶ 4.0.times.10⁰ 12 hours 2.3.times.10⁷ 6.0.times.10⁰ 1 values represent cfu/mL of the 25-mL PBS solution used to elute the microorganisms from the gauze sections.

The data clearly indicates that significant antimicrobial activity is manifested very quickly. Approximately 99.8% of S. aureus is destroyed in as little as one minute.

Samples similar in composition to that of sample #31 in Table 1 were subjected to sterilization by several methods including: autoclaving, ethylene oxide exposure, gamma irradiation (2.5 Mrad), and electron beam irradiation (2.5 Mrad). No observable degradation of physical properties or loss of antimicrobial activity was observed.

Samples #43, #44 and #45 (see Table 1) were reacted for significantly shorter periods of time than the other samples listed; however, relatively high grafting yields were still obtained. This demonstrates that the process can be achieved quickly, which will have economic advantages for large-scale industrial application of this invention. It is likely that sufficiently high grafting yields can be obtained in 5 minutes or less under appropriate conditions.

The present data demonstrates the superior effectiveness of compositions of the present invention compared with siloxane-based polymers such as taught by Blank et al. in U.S. Pat. No. 5,045,322. The '322 patent teaches attachment of monomeric siloxane-based quaternary compounds to super absorptive polymers. The siloxane-based compounds are sensitive to hydrolysis, as noted in the parent application. These siloxane compounds are expected to be more easily hydrolyzed than the acrylate polymers used in the present application. Furthermore, other polymers used in the present invention (such as those based on DADMAC or trialkyl(p-vinylbenzyl) ammonium chloride) are substantially more stable to hydrolysis than the bonds taught in the '322 patent.

In the case of siloxane-based antimicrobial agents, the chemical bonds which are susceptible towards hydrolysis are part of the backbone structure of the polymer. Hydrolysis of even a single siloxane linkage can result in the cleavage of several quaternary units (although the siloxane polymers in such systems are generally only a few units in length). In contrast, in the case of grafted acrylate polymers of the present invention, the grafted chains may be hundreds of units long. The ester linkages which attach the quaternary groups to the polymer backbone are inherently more stable than the linkages in the bulky siloxane quaternary units. Even so, it is possible that the acrylates can be hydrolyzed under extreme conditions. However, since the hydrolyzable group of the acrylate is not in the main chain of the polymer, this will not result in chain cleavage, so the loss under such unlikely, extreme conditions would be limited to a single quaternary unit per hydrolysis event.

Further, the antimicrobial effectiveness of a bulky molecule like the TMS siloxane used by Blank et al. is reduced somewhat by its steric hindrance. Since it can and does fold on itself, the number of such molecules that can be bonded to a given surface is limited as compared to smaller molecules. Further, the fact that the nitrogen atom can be blocked by other atoms in the molecule limits its positive charge density as well. The consequence of this is that the antimicrobial is less effective than one that can be attached to the same surface in greater numbers or density per unit area. Since the net positive charge on the nitrogen atom is related to the effectiveness of the antimicrobial, one that has more exposed positive atoms would theoretically be more effective. This can be shown by comparing the effectiveness of the Blank et al. compounds to any other quaternary compounds that have less steric hindrance. This is demonstrated in the results above, in Tables 2-5. Another consequence is that in the presence of proteinaceous matter such as blood, urine, and tissue cells, the '322 compounds can be blocked more easily than quaternary polymers having a greater concentration of unhindered net positive charges. (See the parent application, PCT/US99/29091, and Table 5.)

A further shortcoming of the siloxane quaternary material disclosed according to Blank et al. is that it only provides a monolayer coverage of the surface. That is, the siloxane backbone molecules are not long-chain polymers. It is well known that siloxane chains more than a few units in length are particularly susceptible to hydrolysis, particularly those with bulky substituents such as the TMS monomer utilized in the '322 patent. This hydrolysis results in chain cleavage and loss of soluble antimicrobial. Such reactions occur as a result of cyclization or “back-biting” reactions (see: J. Semlyen, “Cyclic Polymers” Chapter 3, Elsevier, New York, 1986).

By contrast, the surface according to the present invention is covered with polymeric chains composed of non-hydrolyzable carbon-carbon bonds, to which are bonded quaternary materials. Polymeric antimicrobials used according to the present invention are more effective than the monomeric antimicrobials described by Blank et al. (see Chen, Z. C., et al., “Quaternary Ammonium Functionalized Poly(propylene imine) Dendrimers as Effective Antimicrobials: Structure-Activity Studies”, Biomacromolecules 1, p 473-480 (2000); Ikeda, T., “Antibacterial Activity of Polycationic Biocides”, Chapter 42, page 743 in: High Performance Biomaterials, M. Szycher, ed., Technomic, Lancaster Pa., (1991); Donaruma, L. G., et al., “Anionic Polymeric Drugs”, John Wiley & Son, New York, (1978)). Thus, in order to obtain a high antimicrobial activity, a high surface area base material must be used with the siloxane quaternary materials. The Blank et al. patent describes placing this monolayer antimicrobial treatment onto powders, which are then used to make superabsorbent polymer gels. The powder has a very high surface area, and hence the gels contain a lot of antimicrobial. However, the Blank et al. gels have almost zero mechanical strength, (and must be contained inside some type of matrix in order to form a useable device). In contrast, the modified cellulose fibers of the present invention have inherent mechanical properties which allow them to be directly used as structural devices such as bandages.

A common understanding in the art is that an “enhanced surface area” would not apply to monolayer treatments such as the siloxane system described by Blank et al. That is, an enhanced surface area substrate is needed to achieve high quaternary content. According to the present invention, however, a high quaternary content may be achieved even on low surface area fibers such as cotton because the quaternary materials of the present invention are polymeric. An analogy may be made to the “fuzzy” structure of a pipe-cleaner to describe a single substrate fiber modified by the currently-described method—that is, each “hair” of the pipe cleaner represents a polymer chain which has an antimicrobial group on substantially each monomer that makes up the polymer. The present applicants have actually attempted use of a Dow Corning product (TMS—the same compound described by Blank et al.) to treat fabrics, and have found that a significantly lower amount of quaternary antimicrobial groups could be applied. The bactericidal activity of the TMS treated fabrics was several orders of magnitude lower than the fabrics treated with polymeric quaternary materials of this invention.

The present invention also provide for TMS-treated samples that are water-repellent. This effect was reported by Blank et al. (see U.S. Pat. No. 5,035,892; column 12, line 57). This impairment of absorbency is undesirable in a product intended for use as an absorbent. Furthermore, the siloxane monomer has a higher MW than the monomers of the present invention. As a result, the effective quaternary material content (number of positively-charged sites per gram of material) is further reduced as compared to that of the present invention. Finally, the present application further discloses use of neutral or negatively charged antimicrobial polymers, which is neither disclosed nor suggested according to Blank et al.

It should also be noted that the mechanism of action of quaternary compounds is directed towards the cell membrane of the target organism. This process has been described as a mechanical “stabbing” (on a molecular level) which causes rupture of the cell membrane. Thus, it is not possible for pathogenic organisms to develop resistance as observed for most antibiotics. The following examples demonstrate the use of the various initiators described above for the formation of graft copolymers between cellulose and quaternary-containing vinyl monomers:

### Example 3

This example demonstrates the grafting of quaternary ammonium polymers onto cellulose fabric. A solution of 0.4 gram SPS, 65 mL distilled water, and 20 mL of Ageflex FM1Q75MC ([2-(methacroyloxy)ethyl]trimethylammonium chloride, 75 wt % solution in water, Ciba Specialty Chemicals Corporation) was placed into a 250 mL screw-top glass jar, and then sparged with argon gas to remove dissolved oxygen. One sheet of rayon non-woven gauze fabric (Sof-Wick, manufactured by J&J) was dried, weighed (2.00 grams total), and placed into the above solution. The jar was flushed with nitrogen, capped, and placed into a 60.degree. C. oven overnight. The fabric sample was then removed, thoroughly washed with tap water, and then dried. The final weight of the samples was 2.49. This represents a grafting yield of 19.4%. The sample was bright white in color, and showed no degradation or discoloration. Testing with a 1% solution of fluorescein dye, followed by thorough rinsing left a bright orange color which indicates the presence of quaternary ammonium groups grafted to the fabric surface. The sample was aseptically cut into approximately one inch² square sections.

Each sample section was placed in a sterile 100.times.15-mm petri dish and covered. Escherichia coli (ATCC 15597) were grown in twenty five milliliters of tryptic soy broth (TSB) (Difco Laboratory, Detroit, Mich.) for 16 hours at 37.degree. C. Each bacterial culture was then diluted a hundred-fold in Fresh phosphate buffered saline (PBS) containing 10% Fetal Bovine Serum (FBS, Sigma, St. Louis, Mo.) to a final concentration of 7.2.times.10⁷-cfu/mL coli. One-half milliliter of the bacterial suspension was added to each material section. All samples were inoculated in triplicates. The petri dish containing the inoculated sample was then covered and incubated for 18 hours at 36.degree. C. in 100% humidity. Following incubation, the gauze material was aseptically placed into 50-mL conical centrifuge tubes. Twenty-five milliliters of sterile PBS was then added to each tube. The tubes were gently shaken on a rotary shaker (Red Rotor PR70/75, Hoofer Scientific, CA) for 30 minutes. The eluant of samples were then serially diluted thousand and ten thousand-fold by the addition of 1.0 or 0.1-mL of sample to 100-mL of sterile PBS. 0.1-mL aliquots of the diluted samples were then aseptically spread plated onto Tryptic Soy Agar (TSA) (Difco Laboratory, Detroit, Mich.) plates. Additionally, 0.1-mL and 0.33-mL aliquots of the undiluted PBS samples containing the gauze were also aseptically spread plated onto TSA. The plates were incubated for 18 hours at 37.degree. C. The colonies on the respective plates were counted and concentrations were determined. It was found that a greater than 6-log reduction of bacteria was obtained (versus untreated rayon gauze control).

### Example 4

The method of Example #3 was used to prepare quaternary-grafted rayon samples. In this experiment, samples were not heated, but instead left at room temperature (25.degree. C.) for various lengths of time. The following results (% grafting vs. reaction time) were obtained: (2 hours—5.5%; 4 hours—13.4%; 69 hours—17.4%).

### Example 5

The method of Example #3 was used to prepared quaternary-grafted rayon samples. In this experiment, samples were heated for shorter lengths of time before being removed from the oven and washed. The following results (% grafting vs. reaction time) were obtained: (30 minutes—9.5%; 60 minutes—14.4%; 4 hours—15.4%).

### Example 6

The method of Example #3 was used, except the rayon gauze substrate was replaced with bulk cotton (7.08 grams). The following solution was used: 1.5 grams SPS, 210 mL distilled water, and 45 mL Ageflex FM1Q75MC. The sample was heated at 60.degree. C. overnight. The grafting yield was 4.8%. The sample was tested against E. coli bacteria as described in Example #3. A greater than 6-log reduction of viable bacteria was observed.

### Example 7

The method of Example #3 was repeated using a 2 hour reaction time at 60.degree. C. In this experiment the step of sparging with argon gas was omitted. The grafting yield was 10.3%.

### Example 8

The method of Example #3 was repeated except that 5.05 grams of woven cotton bedsheet material was used as a substrate (1 gram SPS, 70 mL distilled water, and 30 mL Ageflex FM1Q75MC). The grafting yield was found to be 2.8%. The grafted material was tested against E. coli bacteria as described in Example #3. A greater than 6-log reduction of viable bacteria was observed.

### Example 9

The method of Example #3 was repeated except that a solution of 3% aqueous hydrogen peroxide (5 mL) was used in place of SPS. The grafting yield was found to be 15.8%.

### Example 10

The method of Example #3 was repeated except that 0.50 gram VA-057 (2,2′-Azobis[N-(2-carboxyethyl)-2-methylpropionamidine]tetrahydrate, available from Wako Specialty Chemicals) was used in place of SPS. A 9.5% grafting yield was obtained.

### Example 11

The method of Example #3 was repeated, except that a solution of 3% aqueous hydrogen peroxide (3 mL) was used in addition to SPS. A 24.5% grafting yield was obtained.

### Example 12

This example illustrates the preparation of a superabsorbent polymer network (SAP). The method of Example #3 was used, except that 0.5 gram of difunctional acrylate crosslinking agent (SR344, polyethylene glycol diacrylate, Sartomer Chemical Co.) was also used. The sample was heated for 2 hours at 60.degree. C., and a solid gel was formed. Excess gel was scraped away from the substrate which was then washed by soaking it in water for greater than 24 hours. The sample was then dried in air. The resulting white fabric sheet was found to be capable of absorbing 25 times its own weight of water.

### Example 13

Two grams of mica particles (<38.mu.m particle size) were placed into a solution of 0.1 g AMBP, 10 g of 65% DADMAC, and 10 g of water, then sparged with argon gas. The mixture was sealed in a jar under argon atmosphere and heated for 90 minutes at 80.degree. C. The mixture was suspended in water (4 L), allowed to settle for several hours, then resuspended in fresh water. After settling overnight, the mica powder wash washed several times in distilled water (50 mL aliquots), and washed by repeated shaking and centrifugation. The powder was then dried in a vacuum oven. Testing of the treated mica with a 1% solution of bromthymol blue dye produced a dark blue coloration after washing. Untreated mica powder tested in a similar manner showed no dye absorption. The powder was tested for antimicrobial activity against E. coli according to the method in the above example. Antimicrobial activity was high, (six log reduction) and no viable bacteria were observed.

The following examples provide detailed written description and enablement for various aspects of the present invention whereby polyionic substrates are created and charged with ionic biologically or chemically active compounds for adherence and sustained release:

### Example 14

In this example, a microbicidal utility substrate is made of a nonwoven rayon gauze material graft polymerized with diallyldimethylammonium chloride (DADAMC), and containing approximately 10 weight % poly(DADMAC)), and SofWick, a commercially available rayon gauze material manufactured by Johnson & Johnson were used as substrates. The material was prepared via modification of the SofWick substrate. Each substrate measured approximately 40 square inches. Substrates were dried at 60.degree. C. for 30 minutes and then weighed. Both samples were trimmed to weigh exactly 1.00 grams each. A 0.5 weight % solution of Cefazolin Sodium USP (Geneva Pharmaceuticals) was prepared. Each sample was placed in a 50 mL screw-cap polypropylene centrifuge tube, along with 30 mL of the Cefazolin solution and the tubes were placed on a rotating agitator for 3 hours. The samples were removed from the solutions, then squeezed to remove excess solution, dried at 60.degree. C. for 2 hours, then weighed. The sample weighed 1.05 grams, whereas the SofWick sample weighed 1.00 grams. The gravimetric analysis indicated that substantially more drug was absorbed by the sample, compared to the untreated rayon substrate. The extraction liquid was saved for analysis.

The dried samples were placed in separate 50 mL centrifuge tubes containing 25 mL of distilled water, then placed in the rotating agitator overnight at room temperature. The samples were then removed, squeezed to remove excess solution, dried at 60.degree. C. for 2 hours, then weighed. The sample weighed 1.03 grams, and the SofWick sample weighed 0.98 grams. Gravimetric analysis indicated that only a portion of the bonded drug had been released from the sample. The extraction liquid was saved for analysis This extraction procedure was repeated four additional times to yield two series of six extraction liquids.

The extract solutions were tested for antimicrobial activity by placing single 20 microliter drops of the solutions at marked locations on an agar culture plate spread with .about.3.times.10³ CFU (continuous lawn) of E. coli bacteria. Plates were incubated overnight at 37.degree. C., and the diameter of the “zone of inhibition”, or “ZOI” was measured. The size of this zone corresponds to the antibacterial activity of the extract solutions. Results are listed below: Solutions E-1 and F-1 were discarded without analysis, since they were likely to contain non-bonded drug. Solution F-3 showed no inhibition of bacterial growth, indicating that all of the drug had been removed in 3 or less washings, thus further samples in this series were not analyzed.

12 Sample: ZOI diameter (mm) Cefazolin 1% 40 Cefazolin 0.1% 18 Cefazolin 0.01% 0 E-2 23 E-3 22 E-4 23 E-5 18 E-6 16 F-2 (SofWick) 21 F-3 0

The superior binding, and controlled-release properties of the microbicidal utility substrate for the Cefazolin drug versus untreated SofWick are clearly demonstrated.

### Example 15

This example is similar to Example 14 (above), except that Penicillin G Potassium (PG) (Squibb-Marsam) was used as the drug, and antibacterial efficacy was tested against Staph. aureus instead of E. coli. The samples were soaked in 25 mL of 5% PG solution for 2 hours, then squeezed to remove excess solution, dried and weighed. Samples were then washed with 25 mL of distilled water for one hour, then dried and weighed. These wash solutions (G-1 and H-1) were saved for analysis. The samples were then subjected to two additional washings with 25 mL distilled water, without drying in between washings (G-2, G-3, and H-2, H-3). Samples were then dried and weighed. Extract solutions were tested for antimicrobial activity, and the results are shown below. Extract H-3 was found to have zero antimicrobial activity, and thus further extractions were not performed on sample H. Sample G was then subjected to ten additional extractions with 25 mL of distilled water, and only dried and weighed between extractions G8 and G9, and after G13. All extracts were tested for antimicrobial activity, and results are reported below.

Sample H (SofWick) Sample G (a microbicidal utility substrate) Initial sample weight: 0.971 g 1.053 g After drug loading: 1.058 1.269 g After washing lx: 0.979 g 1.177 g After washing 3×: 0.973 g 1.147 g After washing 8×n.d. 1.120 g After washing 13×: n.d. 1.090 g.

Solution ZOI diameter (mm) Penicillin G (1.0%) 56 Penicillin G (0.1%) 44 Penicillin G (0.01%) 0 G-1 (microbicidal utility substrate) 56 G-2 48 G-3 46 G-4 46 G-5 46 G-6 46 G-7 46 G-8 46 G-9 46 G-10 46 G-11 46 G-12 46 G-13 46 H-1 (untreated SofWick) 56 H-2 48 H-3 0

The sample clearly absorbs more penicillin than the untreated rayon substrate, and binds and releases aliquots of the drug, even after thirteen extractions with distilled water.

### Example 16

A repeat of the method of Example 15 was used, except that the extraction solvent used was phosphate buffered saline (“PBS”, pH=7.4, Fisher Scientific), and samples were not dried and weighed between extractions. Samples of a microbicidal utility substrate (Sample I, initial weight=1.024 g) and SofWick (Sample J, initial weight=1.011 g) were each soaked in 20 Ml of .about.4% penicillin G solution overnight, and excess solution was removed by squeezing. Samples were then washed with 25 mL distilled water for one hour with agitation, squeezed to remove excess liquid, and then subjected to five sequential extractions using 25 mL of PBS for one hour at room temperature. Samples were squeezed to remove excess solution between extractions. Extracts were tested for antibacterial activity against S. aureus according to the procedure outlined above. The results are summarized below.

The microbicidal utility substrate was: ZOI SofWick: ZOI # of extractions diameter (mm) diameter (mm) 1 55 45 2 50 34 3 40 11 4 30 0 5 10 0

Again, the results clearly show higher initial drug concentration, and prolonged release from the microbicidal utility substrate material. Use of saline as the extractant accelerated release of the drug from the substrate; however, the binding effect is still readily apparent.

### Example 17

This example demonstrates the stabilization of pyrithione by a cationic cellulose surface. The method of Example 15 was used, except that sodium pyrithione (“SP”, Acros Chemical) was used instead of penicillin. One gram samples of the microbicidal utility substrate (sample K), and untreated SofWick (sample L) were each soaked overnight in 25 ml of 0.5% SP solution. Samples were removed and squeezed to remove excess liquid. Samples were then washed in 25 mL of distilled water for one hour with agitation, then squeezed to remove excess liquid. Each sample was subjected to four sequential extractions using 25 mL of distilled water for one hour at room temperature with agitation. Samples were squeezed to remove excess solution between extraction cycles. The extracts were tested for antibacterial activity against S. aureus using the procedure described above. Results are shown below:

The microbicidal utility substrate was: ZOI Sofwick: ZOI # of extractions diameter (mm) diameter (mm) 1 12 0 2 11 0 3 14 0 4 12 0.

SP control solutions exhibited the following ZIO (0.1% SP: 26 am; 0.01% SP: 12 mm). This example clearly shows the binding and stabilization of SP by the cationic cellulose substrate.

Expected variations or differences in the results are contemplated in accordance with the objects and practices of the present invention. It is intended, therefore, that the invention be defined by the scope of the claims which follow and that such claims be interpreted as broadly as is reasonable.

What is claimed is:

1. A medical product, comprising:
a medical product selected from the group of, nasal cannulas, oxygen masks, wound dressings, bandages, band aids, catheters, endotrachial tubes, condoms, surgical and other gloves, sheaths for endoscopy probes, and medical products that physically touch the body; and
a coating that includes at least one of, a non-antibiotic, antimicrobial and/or antiviral substance that prevents further local, non-systemic, colonization of infections.

2. The product of claim 1, wherein the infection is including but not limited to Methacillin-Resistant Staphylococcus Auereus (MRSA).

3. The product of claim 1, wherein the coating is an intrinsically antimicrobial material that includes: an absorbent polymeric matrix having an enhanced surface area; wherein the enhanced surface area further comprises a polymer of antimicrobial monomeric moieties attached to the matrix via non-siloxane covalent chemical bonds so as to result in a structure which is less prone to degradation by acids or bases produced during bacterial growth and consequent detachment of the polymer of antimicrobial monomeric moieties from the matrix, whereby the material remains antimicrobial after exposure of the material to skin or aqueous biological fluids.

4. The product of claim 3, wherein the aqueous biological fluids are bodily fluids, sweat, tears, mucus, urine, menses, blood, wound exudates, or mixtures thereof.

5. The product of claim 3, wherein molecules of the polymer are attached to the matrix via one or more covalent carbon-oxygen-carbon bonds, or carbon-carbon bonds, or carbon-nitrogen bonds, or combinations thereof.

6. The product of claim 3, wherein the antimicrobial monomeric moieties are allyl- or vinyl-containing monomers.

7. The product of claim 3, wherein the antimicrobial monomeric moieties comprise at least one quaternary ammonium compound.

8. The product of claim 4, wherein the quaternary ammonium compound is dimethyldiallyl ammonium chloride, or a trialkyl(p-vinylbenzyl)ammonium chloride, or a p-trialkylaminoethyl styrene monomer.

9. The product of claim 3, wherein the matrix comprises cellulose.

10. The product of claim 3, wherein the matrix comprises a polyethylene oxide, a polyvinyl alcohol, or a polyacrylate.

11. The product of claim 3, wherein the matrix consists essentially of hydrophilic fibers or filaments having a superabsorbent capacity for aqueous biological fluids as evidenced by being capable of absorbing at least about thirty times its own weight of water.

12. A medical product, comprising:
a medical product selected from the group of, nasal cannulas, oxygen masks, wound dressings, bandages, band aids, catheters, endotrachial tubes, condoms, surgical and other gloves, sheaths for endoscopy probes, and medical products that physically touch the body; and
a coating including a polymer having the formula R(LE)ₓ wherein R is a polymeric core having a number average molecular weight of from 5000 to 7,000,000 daltons and having x endgroups, x being an integer .gtoreq.1, E is an endgroup covalently linked to polymeric core R by linkage L, L is a divalent oligomeric chain, having at least 5 identical repeat units, capable of self-assembly with L chains on adjacent molecules of the polymer, and the moieties (LE)ₓ in the polymer may be the same as or different from one another, wherein E is at least one of a non-antibiotic, antimicrobial and/or antiviral agent.

13. The product of claim 12, wherein all of the moieties (LEₓ in the polymer are the same as one another.

14. The product of claim 12, wherein L comprises a divalent alkane, polyol, polyamine, polysiloxane, or fluorocarbon of from 8 to 24 units in length.

15. The product of claim 12, wherein E is an endgroup that is positively charged, negatively charged, or that contains both positively charged and negatively charged moieties.

16. The product of claim 12, wherein E is an endgroup that is hydrophilic, hydrophobic, or that contains both hydrophilic and hydrophobic moieties.

17. The product of claim 12, wherein E is a biologically active endgroup, such as heparin.

18. The product of claim 17, wherein E is heparin binding endgroup such as PDAMA or the like that is linked to the polymer backbone via a self assembling polyalkylene spacer of different chain lengths, typically between 8 and 24 units.

19. The product of claim 12, the antimicrobial moiety is selected from at least one of, a quaternary ammonium molecule, and an oligermeric compounds including but not limited to a poly quat derivatized from an ethylenically unsaturated diamine and an ethylenically unsaturated dihalo compound.

20. The product of claim 19, wherein the antimicrobial moiety is an organic biocidal compound that prevents the formation of a biological microorganism, and has fungicidal, algicidal, or bactericidal activity and low toxicity to humans and animals, e.g., a quaternary ammonium salt that bears additional reactive functional group capable of attaching to the polymer main chain, such as compounds having the following formula: wherein R₁, R₂, and R₃ are radicals of straight or branched or cyclic alkyl groups having one to eighteen carbon atoms or aryl groups and R₄ is an amino-, hydroxyl-, isocyanato-, vinyl-, carboxyl-, or other reactive group-terminated alkyl chain capable of covalently bonding to the base polymer, wherein, due to the permanent nature of the immobilized organic biocide, the polymer thus prepared does not release low molecular weight biocide to the environment and has long lasting antimicrobial activity.

21. The product of claim 12, wherein E is an amino group, an isocyanate group, a hydroxyl group, a carboxyl group, a carboxaldehyde group, or an alkoxycarbonyl group.

22. The product of claim 21, wherein E is a protected amino group linked to the polymer backbone via a self assembling polyalkylene spacer of different chain lengths, typically between 8 and 24 units.

23. The product of claim 12, wherein E is selected from the group consisting of hydroxyl, carboxyl, amino, mercapto, azido, vinyl, bromo, acrylate, methacrylate, —O(CH₂CH₂O)₃H, —(CH₂CH₂O)₄H, —O(CH₂CH₂O)₆H, —O(CH₂CH₂O)₆CH₂COOH, —O(CH₂CH₂O)₃CH₃, —(CH₂CmH₂O)4CH₃, —O(CH₂CH₂O)₆CH₃, trifluoroacetamido, trifluoroacetoxy, 2′,2′,2′-trifluorethoxy, and methyl.

24. The product of claim 12, wherein R has a number average molecular weight of from 100,000 to 1,000,000 daltons.

25. The product of claim 12, wherein R is biodegradable and/or bioresorbable.

26. The product of claim 24, wherein R is a linear base polymer, x is 2, E is a surface active endgroup, and L is a polymethylene chain of the formula —(CH₂)ₙ— wherein n is an integer of from 8 to 24.

27. The product of claim 26, wherein the linear base polymer is a polyurethane and wherein the endgroup is selected from the group consisting of monofunctional aliphatic polyols, aliphatic or aromatic amines, and mixtures thereof.

28. The product of claim 12, wherein the polymer has a molecular weight of up to 5,000,000 daltons.

29. The product of claim 12, wherein at least some of the moieties (LE)ₓ in the polymer differ from other of the moieties (LE)ₓ in the polymer.

30. The product of claim 29, wherein the polymer is a polyurethane or polyurea polymer in which about half of the moieties (LE)ₓ in the polymer have E groups derived from a polyethylene oxide having a molecular weight of about 2000 and the reactive monomer that forms the endgroup has the formula HO(CH₂)₁₇(CH₂CH₂O)₄₅CH₃, and about half of the moieties (LE)ₓ in the polymer have E groups that are derived from a polyethylene oxide having a molecular weight of about 5000 and the reactive monomer that forms the endgroup has the formula HO(CH₂)₁₇(CH₂CH₂O)₁₁₄—CH₃.

31. A medical product, comprising:
a medical product selected from the group of, nasal cannulas, oxygen masks, wound dressings, bandages, band aids, catheters, endotrachial tubes, condoms, surgical and other gloves, sheaths for endoscopy probes, and medical products that physically touch the body; and
a material coupled to the medical product, the material including one or more non-hydrolyzable, non-leachable polymer chains covalently bonded by non-siloxane bonds to the substrate; wherein the non-hydrolyzable, non-leachable polymer chains comprise a multitude of antimicrobial groups attached to the non-hydrolyzable, non-leachable polymer chains by covalent bonds; and wherein a sufficient number of the non-hydrolyzable, non-leachable polymer chains are covalently bonded to sites of the substrate to render the material antimicrobial, or receptive to avid binding of negatively charged dye molecules, when exposed to aqueous fluids, menses, bodily fluids, skin, cosmetic compositions, or wound exudates, wherein the material has associated therewith a plurality of anionically charged biologically or chemically active compounds.

32. The product of claim 31, wherein the antimicrobial groups comprise at least one quaternary ammonium structure.

33. The product of claim 31, wherein the antimicrobial groups comprise at least one non-ionic structure.

34. The product of claim 33, wherein the at least one non-ionic structure comprises a biguanide.

35. The product of claim 31, wherein the non-hydrolyzable, non-leaching polymer chains have an average degree of polymerization selected from about 5 to 1000, 10 to 500, and 10 to 100.

36. The product of claim 31, wherein the material comprises all or part of a wound dressing, sanitary pad, a tampon, an intrinsically antimicrobial absorbent dressing, a diaper, toilet paper, a sponge, a sanitary wipe, isolation and surgical gowns, gloves, surgical scrubs, sutures, sterile packaging, floor mats, lamp handle covers, burn dressings, gauze rolls, blood transfer tubing or storage container, mattress cover, bedding, sheet, towel, underwear, socks, cotton swabs, applicators, exam table covers, head covers, cast liners, splint, paddings, lab coats, air filters for autos, planes or HVAC systems, military protective garments, face masks, devices for protection against biohazards and biological warfare agents, lumber, meat or fish packaging material, apparel for food handling, paper currency, powder, and other surfaces required to exhibit a non-leaching antimicrobial property and to release over time portions of the biologically or chemically active compound.

37. The product of claim 31, wherein the substrate is comprised, in whole or in part, of cellulose, or other naturally-derived polymers.

38. The product of claim 31 wherein the substrate is comprised, in whole or in part, of synthetic polymers including, but not limited to: polyethylene, polypropylene, nylon, polyester, polyurethane, or silicone.

39. The product of claim 31, wherein the attachment of the non-hydrolyzable, non-leachable polymer to the substrate is via a carbon-oxygen-carbon bond, also known as an ether linkage, a carbon-carbon bond, and mixtures thereof.

40. The product of claim 39, wherein a cerium-containing catalyst, a peroxide containing catalyst, an Azo catalyst, a redox initiator, a thermolabile or photolabile catalyst catalyzes formation of the ether linkage or the carbon-carbon bond.

41. The product of claim 31 wherein the non-hydrolyzable, non-leachable polymer chains are formed by polymerization of allyl- or vinyl-containing monomers.

42. The product of claim 41 wherein the allyl- or vinyl-monomers are selected from the group consisting of: styrene derivatives, allyl amines, and ammonium salts.

43. The product of claim 41 wherein the allyl- or vinyl-monomers are selected from the group consisting of: acrylates, methacrylates, acrylamides, and methacrylamides.

44. The product of claim 43 wherein the or vinyl-containing monomers are selected from the group consisting of: compounds of the structure CH₂.dbd.CR—(C.dbd.O)—X—(CH₂)ₙ—N+R′R″R′″—//Y⁻; wherein, R is hydrogen or methyl, n equals 2 or 3, X is either O, S, or NH. R′, R″, and R′″ are independently selected from the group consisting of H, C1 to C16 alkyl, aryl, arylamine, alkaryl, and aralkyl, and Y− is an acceptable anionic counterion to the positive charge of the quaternary nitrogen; diallyldimethylammonium salts; vinyl pyridine and salts thereof; and vinylbenzyltrimethylammonium salts.

45. The product of claim 44 where the allyl- or vinyl-containing monomers are selected from the group consisting of: dimethylaminoethyl methacrylate:methyl chloride quaternary; and dimethylaminoethyl methacrylate:benzyl chloride quaternary.

46. The product of claim 36 wherein the powder is mica.

47. A medical product, comprising:
a medical product selected from the group of, nasal cannulas, oxygen masks, wound dressings, bandages, band aids, catheters, endotrachial tubes, condoms, surgical and other gloves, sheaths for endoscopy probes, and medical products that physically touch the body; and
a superabsorbent material for absorbing biological fluids coupled to the medical product, the superabsorbent material including one or more non-hydrolyzable, non-leachable polymer chains covalently bonded by non-siloxane bonds to the substrate; wherein the non-hydrolyzable, non-leachable polymer chains comprise a multitude of antimicrobial groups attached to the non-hydrolyzable, non-leachable polymer chains by covalent bonds; and wherein a sufficient number of the non-hydrolyzable, non-leachable polymer chains are covalently bonded to sites of the flexible substrate to render the material antimicrobial when exposed to aqueous fluids, menses, bodily fluids, or wound exudates; wherein the superabsorbent material is capable of absorbing about 30 or more times its own weight of water or other fluids in a single instance; and wherein the absorbing capacity is the result of branching or crosslinking of the non-hydrolyzable, non-leachable polymer chains, wherein the material has associated therewith a plurality of anionically charged biologically or chemically active compounds.

48. The product of claim 47, wherein the antimicrobial groups comprise at least one quaternary ammonium structure.

49. The product of claim 47, wherein the antimicrobial groups comprise at least one non-ionic structure.

50. The product of claim 49, wherein the at least one non-ionic structure comprises a biguanide.

51. The product of claim 47, wherein the material comprises all or part of a wound dressing, sanitary pad, a tampon, an intrinsically antimicrobial absorbent dressing, a diaper, toilet paper, a sponge, a sanitary wipe, food preparation surfaces, gowns, gloves, surgical scrubs, sutures, needles, sterile packings, floor mats, lamp handle covers, burn dressings, gauze rolls, blood transfer tubing or storage container, mattress cover, bedding, sheet, towel, underwear, socks, cotton swabs, applicators, exam table covers, head covers, cast liners, splint, paddings, lab coats, air filters for autos planes or HVAC systems, military protective garments, face masks, devices for protection against biohazards and biological warfare agents, lumber, meat packaging material, paper currency, powders, and other surfaces required to exhibit a non-leaching antimicrobial or enhanced dye binding properties, and to release over time portions of the biologically or chemically active compound.

52. The product of claim 47, wherein the substrate is comprised, in whole or in part, of cellulose, or other naturally-derived polymers.

53. The product of claim 47 wherein the substrate is comprised, in whole or in part, of synthetic polymers including, but not limited to: polyethylene, polypropylene, nylon, polyester, polyurethane, or silicone.

54. The product of claim 47, wherein the attachment of the non-hydrolyzable, non-leachable polymer to the substrate is via a carbon-oxygen-carbon bond, also known as an ether linkage, a carbon-carbon bond, or mixtures thereof.

55. The product of claim 54, wherein a cerium-containing catalyst, a peroxide containing catalyst, an Azo catalyst, a thermolabile or photolabile catalyst catalyzes formation of the ether linkage or the carbon-carbon linkage, or mixtures thereof.

56. The product of claim 47 wherein the non-hydrolyzable, non-leachable polymer chains are formed by polymerization of allyl- or vinyl-containing monomers.

57. The product of claim 56 wherein the allyl- or vinyl-monomers are selected from the group consisting of: styrene derivatives; and allyl amines or ammonium salts.

58. The product of claim 56 wherein the allyl- or vinyl-monomers are selected from the group consisting of: acrylates, methacrylates, acrylamides, and methacrylamides.

59. The product of claim 58 wherein the allyl- or vinyl-containing monomers are selected from the group consisting of: compounds of the structure CH₂.dbd.CR—(C.dbd.O)—X—(CH₂)ₙ—N⁺R′R″R″—//Y⁻; wherein, R is hydrogen or methyl, n equals 2 or 3, X is either O, S, or NH, R′, R″, and R′″ are independently selected from the group consisting of H, C1 to C16 alkyl, aryl, arylamine, alkaryl, and aralkyl, and Y− is an acceptable anionic counterion to the positive charge of the quaternary nitrogen; diallyldimethylammonium salts; vinyl pyridine and salts thereof; and vinylbenzyltrimethylammonium salts.

60. The product of claim 59 where the allyl- or vinyl-containing monomers are selected from the group consisting of: dimethylaminoethyl methacrylate:methyl chloride quaternary; and dimethylaminoethyl methacrylate:benzyl chloride quaternary.

61. A medical product, comprising:
a medical product selected from the group of, nasal cannulas, oxygen masks, wound dressings, bandages, band aids, catheters, endotrachial tubes, condoms, surgical and other gloves, sheaths for endoscopy probes, and medical products that physically touch the body; and
an antimicrobial composition coupled to the medical product including a plurality of polymeric molecules of variable lengths bearing antimicrobial groups, wherein the polymeric molecules are covalently, non-leachably bound to the substrate, and wherein the coating, layer, or enhanced surface area exhibits antimicrobial activity due to the presence of the antimicrobial groups; and c. ionically associated biologically or chemically active compounds which are released from the substrate and coating layer over a period of time.

62. The product of claim 61, wherein the antimicrobial groups comprise at least one quaternary ammonium structure.

63. The product of claim 61, wherein the antimicrobial groups comprise at least one non-ionic structure.

64. The product of claim 63, wherein the at least one non-ionic structure comprises a biguanide.

65. The product of claim 61, wherein the material comprises all or part of a wound dressing, sanitary pad, a tampon, an intrinsically antimicrobial absorbent dressing, a diaper, toilet paper, a sponge, a sanitary wipe, food preparation surfaces, gowns, gloves, surgical scrubs, sutures, needles, sterile packings, floor mats, lamp handle covers, burn dressings, gauze rolls, blood transfer tubing or storage container, mattress cover, bedding, sheet, towel, underwear, socks, cotton swabs, applicators, exam table coves, head covers, cast liners, splint, paddings, lab coats, air filters for autos, planes or HVAC systems, military protective garments, face masks, devices for protection against biohazards and biological warfare agents, lumber, meat packaging material, paper currency, powders, and other surfaces required to exhibit a non-leaching antimicrobial or enhanced dye binding properties, and to release over time portions of the biologically or chemically active compound.

66. The product of claim 61, wherein the substrate is comprised, in whole or in part, of cellulose, or other naturally-derived polymers.

67. The product of claim 61 wherein the substrate is comprised, in whole or in part, of synthetic polymers including, but not limited to: polyethylene, polypropylene, nylon, polyester, polyurethane, or silicone.

68. The product of claim 61, wherein the attachment of the non-hydrolyzable, non-leachable polymer to the substrate is via a carbon-oxygen-carbon bond, also known as an ether linkage, via a carbon-carbon bond, or mixtures thereof.

69. The product of claim 68, wherein a cerium-containing catalyst, a peroxide containing catalyst, an Azo catalyst, a thermolabile or photolabile catalyst catalyzes formation of the ether linkage or the carbon-carbon linkage, or mixtures thereof.

70. The product of claim 61 wherein the non-hydrolyzable, non-leachable polymer chains are formed by polymerization of allyl- or vinyl-containing monomers.

71. The product of claim 70 wherein the allyl- or vinyl-monomers are selected from a group consisting of: styrene derivatives; allyl amines and ammonium salts.

72. The product of claim 70 wherein the allyl- or vinyl-monomers are selected from the group consisting of: acrylates, methacrylates, acrylamides, and methacrylamides.

73. The product of claim 72 wherein the allyl- or vinyl-containing monomers are selected from the group consisting of: compounds of the structure CH₂.dbd.CR—(C.dbd.O)—X—(CH₂)ₙ—N⁺R′R″R″—//Y⁻; wherein, R is hydrogen or methyl, n equals 2 or 3, X is either O, S, or NH, R′, R″, and R′ are independently selected from the group consisting of H, C1 to C16 alkyl, aryl, arylamine, alkaryl, and aralkyl, and Y− is an acceptable anionic counterion to the positive charge of the quaternary nitrogen; diallyldimethylammonium salts; vinyl pyridine and salts thereof; and vinylbenzyltrimethylammonium salts.

74. The product of claim 73 where the allyl- or vinyl-containing monomers are selected from the group consisting of: dimethylaminoethyl methacrylate:methyl chloride quaternary; and dimethylaminoethyl methacrylate:benzyl chloride quaternary.

75. The product of claim 74, wherein the substrate is selected from the group consisting of: woven or nonwoven flexible matrices, wherein the composition is formed into the shape of a wound dressing and a powder.

76. The product of claim 74, wherein the coating absorbs aqueous liquids.

77. The product of claim 74, wherein the substrate is wood, lumber, or an extract or a derivative of wood fiber.

78. A medical product, comprising:
a medical product selected from the group of, nasal cannulas, oxygen masks, wound dressings, bandages, band aids, catheters, endotrachial tubes, condoms, surgical and other gloves, sheaths for endoscopy probes, and medical products that physically touch the body; and
an antimicrobial-coated composition coupled to the medical product and including an effective amount of polymeric molecules having a multiplicity of quaternary ammonium groups, wherein the polymeric molecules are non-leachably and covalently bonded to surface sites of the substrate, wherein the polymers do not form using siloxane bonds, and wherein the coating is absorbent of aqueous liquids, and c. associated anionic biologically active or chemically active compound; whereby the multiplicity of quaternary ammonium groups act to destroy microbes coming in contact with the groups as well as to bind and release the anionic biologically active or chemically active compound.
